(19) United States
(12) Patent Application Publication
(10) Pub. No.: US 2025/0198319 A1
(43) Pub. Date: Jun. 19, 2025

(54) Turbine Dosing System for Dosing into Regions of Desirable Flow Properties

(71) Applicants: Cummins Ltd, London (GB); Cummins Emission Solutions, Inc., Columbus, IN (US)

(72) Inventors: Samuel Johnson, Columbus, IN (US); Chetan Kishorrao Chawane, Pune (IN); Ameya Navnath Warang, Pune (IN); Mohemmedtayab A. Mujawar, Pune (IN); Sagar Shekhar Andhari, Pune (IN); Nikhil Digambar Giri, Pune (IN); Abdul Rasheed M S, Pune (IN); Matthew Robert Brookes, West Yorkshire (GB); Atif Mahmood, West Yorkshire (GB)

(21) Appl. No.: 18/846,260

(22) PCT Filed: Mar. 16, 2023
(86) PCT No.: PCT/GB2023/050639

§ 371 Date: Sep. 12, 2024

(30) Foreign Application Priority Data
Mar. 17, 2022 (GB) 2203717.0

(51) Int. Cl. F01N 3/28; F01N 13/00; F02B 39/00

(52) U.S. Cl. CPC F01N 3/2882; F01N 13/00; F02B 39/00

(57) ABSTRACT

There is disclosed a turbine dosing system for a turbocharger. The turbine dosing system comprises a turbine inlet passage, a turbine wheel chamber, a turbine outlet passage and a plurality of dosing modules. The turbine inlet passage is configured to receive exhaust gas from an internal combustion engine. The turbine wheel chamber configured to receive exhaust gas from the turbine inlet passage. The turbine wheel chamber contains a turbine wheel supported for rotation about a turbine wheel axis. The turbine wheel comprises an exducer which defines an exducer diameter. The turbine outlet passage is downstream of the turbine wheel chamber and is configured to receive exhaust gas from the turbine wheel chamber. The turbine outlet passage defines a flow axis which extends from a downstream end of the turbine wheel. The plurality of dosing modules are configured to inject aftertreatment fluid into exhaust gas in the turbine outlet passage.

The present invention relates to: a turbine housing element; a wastegate turbine dosing system; a turbine dosing system; a connection adapter; a diffuser; a conduit; a turbocharger and an engine arrangement, and associated methods of operation.

Turbochargers are used within internal combustion engine systems to increase the pressure of the intake air entering the internal combustion engine to a pressure above atmospheric pressure. This is known as a “boost pressure”. By increasing the pressure of the intake air entering the internal combustion engine, more oxygen is available within the internal combustion engine to support the combustion of a larger amount of fuel, and therefore increases the amount of power produced by the engine.

Turbochargers comprise a compressor and a turbine. The compressor comprises a compressor wheel configured to impart energy to an incident fluid stream, and the turbine comprises a turbine wheel configured to extract energy from an incident fluid stream. The compressor wheel and the turbine wheel are attached to opposite ends of a turbocharger shaft, such that the two rotate in unison. The compressor receives intake air from the atmosphere and delivers the intake air to an intake manifold of the internal combustion engine. The turbine receives exhaust gas from an exhaust manifold of the internal combustion engine and delivers the exhaust gas to an aftertreatment system. During use, exhaust gas leaving the internal combustion engine passes through the turbine, causing the turbine wheel to rotate. The rotation of the turbine wheel drives the compressor wheel, which acts to compress the intake air as it is delivered to the intake manifold.

Exhaust gases from internal combustion engines contain substances that are harmful to the environment. Most countries have vehicle emission standards which limit the amount of such substances that an internal combustion engine system is permitted to emit. Consequently, modern internal combustion engine systems comprise exhaust gas aftertreatment systems designed to remove harmful substances from the exhaust gas.

Typically, an exhaust gas aftertreatment system will comprise a particulate filter and one or more catalytic reducers. The particulate filter removes heavy combustion products, e.g. soot, from the exhaust gas. The catalytic reducers remove harmful substances such as Nitrogen Oxides (NOx) from the exhaust gas. Catalytic reducers generally comprise a large number of narrow channels made from a material selected to support a chemical reaction that removes NOx from the exhaust gas. The narrow channels provide a large surface area for the catalytic reaction to take place. Several kinds of catalytic reducers are available on the market, such as two-way catalytic reducers, three-way catalytic reducers, diesel oxidation catalytic reducers (DOCs), and selective catalytic reducers (SCRs). DOCs and SCRs are typically employed in diesel engine systems. For the SCRs specifically, in order for the SCR reaction to work, it is necessary to mix an exhaust gas aftertreatment fluid with the exhaust gas before it enters the catalytic reducer. The exhaust gas aftertreatment fluid is usually a mixture of around 30% to 35% by volume urea (CO(NH₂)₂) to about 65% to 70% by volume deionised water (H₂O). The exhaust gas aftertreatment fluid is often referred to as Diesel Exhaust Fluid (DEF) and is commonly available under the registered trademark AdBlue.

Conventionally, the DEF is mixed with the exhaust gas in a decomposition chamber. The DEF is injected into the decomposition chamber using a dosing module. In the decomposition chamber, heat is exchanged from the exhaust gas to the DEF which causes the water within the DEF to evaporate and the urea to thermally decompose into the reductants ammonia (NH₃) and Isocyanic Acid (HNCO) which are required to support the SCR reaction.

A typical decomposition chamber comprises a relatively large cross-sectional area in comparison to the width of standard exhaust gas ducting. Exhaust gas entering the decomposition chamber expands, causing the velocity of the exhaust gas to reduce and the pressure of the exhaust gas to increase. This rapid expansion of the exhaust gas causes the formation of turbulent vortices. DEF is then injected into the decomposition chamber, whereupon the turbulent vortices encourage mixing of the DEF with the exhaust gas. The heat exchange between the exhaust gas and the DEF causes the urea in the DEF to decompose into the reductants, and the mixture of reductants and exhaust gas is then passed to the SCR.

If the exhaust gas and DEF are not mixed well enough, the heat exchange between the DEF and the exhaust gas will not be sufficient to decompose the DEF into the required reductants. Furthermore, poor mixing means that the reductants are not evenly distributed within the flow, and therefore some channels of the catalytic reducer will not receive enough reductant to support the SCR reaction. To ensure adequate mixing, it is common for the decomposition chamber to comprise a mixing plate configured to generate additional turbulence. However, the additional turbulence caused by the mixing plate and the fluidic friction exerted by the mixing plate on the exhaust gas creates a back-pressure on the exhaust gas in the decomposition chamber. This back pressure is passed upstream and acts to increase the pumping work required by the internal combustion engine, and accordingly reduces the overall efficiency of the engine system. Accordingly there is need for improvement in this technical area.

There exists a need to provide alternative systems which overcome one or more of the disadvantages of known systems, whether mentioned in this document or otherwise.

According to a first aspect of the invention there is provided a turbine housing element for a wastegate turbine dosing system, the turbine housing element comprising:
a turbine outlet passage which defines a flow axis that extends through the turbine outlet passage, the turbine outlet passage being configured to receive a turbine bulk flow of exhaust gas; and
at least part of a wastegate passage, configured to receive a bypass flow of exhaust gas, provided in fluid communication with the turbine outlet passage via a wastegate passage outlet;
wherein the turbine housing element further comprises a dosing module mount, configured to receive a dosing module, the dosing module mount defining an opening in fluid communication with the turbine outlet passage; and
wherein the opening of the dosing module mount is disposed within around 3 turbine outlet passage diameters, along the flow axis, of the wastegate passage outlet.

Wastegate turbine dosing system refers to a turbine dosing system which incorporates a wastegate. The wastegate may be a flap valve-style wastegate (e.g. having a pivotable valve member and a valve seat). Alternatively, the wastegate may be a rotary valve. Wastegate is intended to encompass any arrangement whereby exhaust gas can be selectively diverted around the turbine, without being expanded across the turbine. The wastegate may be referred to as a selective bypass arrangement, or flowpath.

The turbine housing element may be a turbine housing (e.g. a monoblock turbine housing or a turbine housing forming part of a turbine housing assembly) or a connection adapter. The turbine housing element may form part of a turbocharger. The turbine housing element may be configured to engage a bearing housing.

The turbine dosing system may form part of a turbocharger dosing system. The turbocharger, specifically a turbine thereof, may be a fixed geometry turbine or a variable geometry turbine. The turbine dosing system may form part of a turbo-compound system (e.g. a system in which a turbine delivers mechanical work to a crankshaft of an engine, either instead of, or in addition to, a compressor).

The term “passage” refers to a volume, defined or bound by a surrounding structure, through which fluid can flow.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The term “flow axis” refers to an axis about which the exhaust gas in the turbine outlet passage generally rotates as it flows through the turbine outlet passage (along the flow axis). The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with a turbine wheel axis. The flow axis May extend from a turbine wheel axis.

The turbine bulk flow of exhaust gas may otherwise be described as a core flow of exhaust gas or a bulk exhaust gas flow.

The at least part of a wastegate passage may comprise an entire wastegate passage (i.e. a single passage defining both an inlet and an outlet of the wastegate passage). Alternatively, the at least part of a wastegate passage may define only part of an entire, or overall, wastegate passage. The wastegate may be defined by a wastegate channel. The turbine housing element may comprise one or more location features configured to receive a wastegate valve (which may form part of a valve assembly). The wastegate valve may sealingly engage a corresponding seat so as to selectively open or close the wastegate passage.

The bypass flow of exhaust gas may otherwise be described as an auxiliary exhaust gas flow, or a wastegate passage exhaust flow. The at least part of a wastegate passage defines at least part of a fluid pathway around a turbine wheel chamber in operation.

The wastegate passage outlet may otherwise be described as an opening or aperture in the turbine housing element. Specifically, the wastegate passage outlet may be described as an opening or aperture through a surface, or structure, which defines the turbine outlet passage. The wastegate passage being provided in fluid communication with the turbine outlet passage via a wastegate passage outlet at a downstream end of the wastegate passage is intended to mean that the wastegate passage outlet is provided in fluid communication with both the turbine outlet passage and the wastegate passage. The turbine bulk flow of exhaust gas and the bypass flow of exhaust gas may thus merge via the wastegate passage outlet. The wastegate passage outlet may be defined at a downstream end of the wastegate passage. The wastegate passage outlet may be defined partway along the wastegate passage.

The term “dosing module mount” encompasses a structure which is configured to align, and support, a dosing module. The dosing module mount may be integrally formed with the turbine housing element or may be attached to the turbine housing element by a joining process such as, for example, welding or brazing.

As used herein, the term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be Diesel Exhaust Fluid (DEF) for use in an SCR process. The aftertreatment fluid may comprise reductant (i.e. a reducing agent, such as urea). The dosing module being configured to inject aftertreatment fluid into the exhaust gas in the turbine outlet passage is intended to mean that the dosing module injects aftertreatment fluid directly into at least a turbine bulk flow (e.g. core exhaust flow). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

An outlet of the dosing module may be substantially flush with an interior surface of the turbine housing element (e.g. which at least partly defines the turbine outlet passage).

The outlet being substantially flush with an interior surface of the structure is intended to mean that the dosing module does not project into the turbine outlet passage by more than an assembly tolerance (e.g. around ±2 mm).

The term “opening” encompasses a hole, aperture, or orifice. The opening may be considered to provide a fluid pathway between the turbine outlet passage and a region external to the turbine outlet passage. Put another way, the opening may provide fluid communication across the structure defining the turbine outlet passage. The opening may be provided downstream of a turbine wheel chamber and/or turbine wheel.

The turbine outlet passage diameters, in connection with the location of the opening of the dosing module mount with respect to the wastegate passage outlet, refers to the diameter of the turbine outlet passage at the axial position, along the flow axis, that the opening of the dosing module mount is provided. Where the turbine outlet passage has an irregular cross section (e.g. is not circular) the turbine outlet passage diameter may otherwise be described as a major dimension (i.e. a greatest distance from one internal surface to an opposing internal surface, across the flow axis, at the axial position of the opening of the dosing module mount.

The position of the opening of the dosing module mount with respect to the wastegate passage outlet may otherwise be described as an axial separation between the planes, normal to the flow axis, at which both the opening and, separately, the wastegate passage outlet are located. The position of the opening of the dosing module mount with respect to the wastegate passage outlet may be defined by the centroids of the opening and the outlet respectively. That is to say, an axial separation between the centroid of the opening of the dosing module mount and the centroid of the wastegate passage outlet is preferably less than around 3 turbine outlet passage diameters along the flow axis.

The separation may be considered from proximate edges of the respective opening and the wastegate passage outlet. For example, where both the opening and the wastegate passage outlet are circular in geometry, and are offset by an axial distance X, that axial distance X is intended to refer to the distance between points on a circumference of the opening and the wastegate passage outlet which are located closest to one another. Put another way, the location, or axial offset, may be described as a minimum distance between the opening of the dosing module mount and the wastegate passage outlet. It will be appreciated that many other geometries, of opening, wastegate passage outlet and dosing module outlet, are possible, and that, in particular, the wastegate passage outlet may not be circular. Other suitable geometries include (generally) elliptical outlets, (generally) square outlets, and elongate geometries such as (generally) rectangular.

The opening of the dosing module mount may be disposed within around 1 turbine outlet passage diameter, along the flow axis, of the wastegate passage outlet. The opening of the dosing module mount may be disposed within around 3 exducer diameters, of a turbine wheel, along the flow axis, of the wastegate passage outlet. The opening of the dosing module mount may be disposed within around 1 exducer diameter, of a turbine wheel, along the flow axis, of the wastegate passage outlet.

The dosing module may be located at least around 1 exducer diameter downstream of the downstream end of the turbine wheel. The dosing module is preferably located between around 1 exducer diameter, and around 3 exducer diameters, downstream of the downstream end of the turbine wheel.

Given that the dosing module mount is configured to receive a dosing module, it will be appreciated that the position of the dosing module mount, e.g. the opening thereof, is indicative of the position of the dosing module once received therein. The opening position therefore defines the location of the aftertreatment fluid injection (e.g. a primary impingement zone as defined by a spray cone of the dosing module) in the assembled dosing system.

Conventionally, aftertreatment fluid is mixed with the exhaust gas in a decomposition chamber and the aftertreatment fluid is injected into the decomposition chamber using a dosing module. Known decomposition chambers are located near a vehicle exhaust pipe (e.g. at a significant distance downstream of the engine). In the decomposition chamber, heat is exchanged from the exhaust gas to the DEF which causes the water within the DEF to evaporate and the urea to thermally decompose into the reductants ammonia (NH₃) and Isocyanic Acid (HNCO) which are required to support the SCR reaction.

A typical decomposition chamber comprises a relatively large cross-sectional area in comparison to the width of standard exhaust gas ducting. Exhaust gas entering the decomposition chamber expands, causing the velocity of the exhaust gas to reduce and the pressure of the exhaust gas to increase. This rapid expansion of the exhaust gas causes the formation of turbulent vortices. DEF is then injected into the decomposition chamber, whereupon the turbulent vortices encourage mixing of the DEF with the exhaust gas. The heat exchange between the exhaust gas and the DEF causes the urea in the DEF to decompose into the reductants, and the mixture of reductants and exhaust gas is then passed to the SCR.

Exhaust gas in the turbine outlet passage has a higher temperature than exhaust gas downstream of the turbine outlet passage, which will lose energy due to transient thermal dissipation, pipe friction and the like. When aftertreatment fluid is injected into the turbine outlet passage, the higher temperature of the exhaust gas in the turbine outlet passage encourages the aftertreatment fluid to decompose faster, and more completely, compared to DEF injection into a downstream decomposition chamber. As such, in many cases the need for a mixing plate and/or a decomposition chamber can be eliminated.

Providing the dosing module in the turbine outlet passage is also advantageous for reasons of packaging (i.e. in that components which may otherwise be required can be omitted from the system). Providing the dosing module mount in relative proximity to the engine also means that the lengths of electrical and coolant lines can be reduced, providing cost benefits. The turbine outlet passage is also a region in which the exhaust gas, having been expanded through the turbine wheel, has a relatively high swirl. The high swirl creates regions of high turbulent kinetic energy (TKE) in the flow, which is beneficial in thoroughly mixing the reductant fluid with, and distributing the reductant fluid within, the exhaust gas flow.

Because the opening of the dosing module mount is disposed within around 3 turbine outlet passage diameters, along the flow axis, of the wastegate passage outlet, the location at which aftertreatment fluid is injected into the turbine outlet passage is positioned relatively close to the wastegate passage outlet. The aftertreatment fluid is thus injected into relatively high-energy exhaust gas flow, which has not been expanded across the turbine wheel. The aftertreatment fluid is also injected into a zone in which two high velocity gas streams (e.g. a turbine bulk flow and a bypass flow) merge. A high level of mixing is thus realised, the level of mixing being influenced by the momentum exchange of the two gas flows. By injecting the aftertreatment fluid near the wastegate passage outlet, the increased levels of mixing, in the aforementioned zone, facilitate the dispersal of aftertreatment fluid (specifically the reductant thereof) throughout the exhaust gas flow. The aftertreatment fluid is also subjected to high levels of relative velocities (i.e. gas velocity vs reductant droplet velocity), which increases the convective heat transfer to the droplet, in turn increasing decomposition. As a droplet traverses a high-mixing zone, it is exposed to many different local velocities which push, pull, & shear the droplet in different directions. This chaotic flow field (as can be indicated by a turbulent kinetic energy (TKE) metric) facilitates the mixing.

Advantageously, locating the outlet of the dosing module mount as specified effectively means that the high-mixing zone, owing to merging of the bulk turbine and bypass flows, can be harnessed to aid the dispersal of aftertreatment fluid (and reductant therein).

The dosing module mount may be provided in a diverging portion of the turbine outlet passage.

A centroid of the opening of the dosing module mount may be located within around 3 turbine outlet passage diameters, along the flow axis, of a centroid of the wastegate passage outlet.

A centroid of the opening refers to the geometric centre of the opening. That is to say, where the opening is a circular, the centroid would be a point from which the constant radius extends. In other geometries the centroid simply refers to a midpoint as defined by the combination of all of the constituent edges of the opening geometry. The centroid of the opening of the dosing module mount may be located within around 1 turbine outlet passage diameter, along the flow axis, of the centroid of the wastegate passage outlet.

The opening may be downstream of the wastegate passage outlet.

The opening being downstream of the wastegate passage outlet is intended to mean that at least a centroid of the opening is downstream of the centroid of the wastegate passage outlet. In some embodiments, an entire geometry of the opening may be downstream of an entire geometry of the wastegate passage outlet (i.e. such that there is no overlap of the opening and the wastegate passage outlet).

Alternatively, the opening may be upstream of the wastegate passage outlet.

Advantageously, it has been found that locating the opening downstream of the wastegate passage may provide the opening proximate a region of highest turbulent kinetic energy. This may be at least in part due to the fact that the turbulent kinetic energy is greater once the two exhaust gas streams (i.e. the turbine bulk flow and the bypass flow) have merged and have travelled at least some distance downstream of the wastegate passage outlet. It has been found that locating the opening downstream of the wastegate passage may provide the opening proximate a region of highest shear stress. This is advantageous for reasons of reduced wall film/deposit formation/build-up.

For the reasons described previously, it is desirable to inject the aftertreatment fluid, and so the reductant thereof, into a zone of high turbulent kinetic energy to facilitate dispersal of the reductant throughout the bulk exhaust gas flow and to facilitate decomposition.

A further advantage is that the risk of aftertreatment fluid impinging upon a turbine wheel, in an overall turbine dosing system, is reduced. Further, the risk of aftertreatment fluid impinging upon the wastegate valve is also reduced.

Where an entire geometry of the opening is downstream of an entire geometry of the wastegate passage outlet, the opening may be downstream of the wastegate passage outlet to such an extent that a primary impingement zone is clear of the wastegate passage outlet (e.g. no overlap). This is desirable for reducing the risk that aftertreatment fluid be sprayed into the wastegate passage (via the wastegate passage outlet).

The opening may at least partially overlap the wastegate passage outlet along the flow axis.

The centroid of the opening of the dosing module mount may be disposed at an axial position, along the flow axis, within an axial extent of the wastegate passage outlet along the flow axis.

The centroid of the opening being disposed at an axial position within an axial extent of the wastegate passage outlet may otherwise be described as the centroid of the opening being provided within an axial length of the wastegate passage outlet. Put another way, the centroid of the opening is bound by axially upstream and axially downstream ends of the wastegate passage outlet.

Advantageously, aftertreatment fluid injected through the opening is injected directly into the bypass flow from the wastegate passage outlet. Put another way, aftertreatment fluid is injected directly into the path of the bypass flow as it merges with the turbine bulk flow of exhaust gas. Accordingly, the merging of the two streams, or flows, gives rise to a region of high energy and high mixing, and associated high turbulent kinetic energy, which is desirable for reasons of improving aftertreatment fluid, and so reductant, dispersal in the exhaust stream.

The centroid of the opening of the dosing module mount may be substantially axially aligned with the centroid of the wastegate passage outlet.

A centroid of the opening being substantially axially aligned with the centroid of the wastegate passage outlet is intended to mean that the centroids of the opening and wastegate passage outlet are only offset by a maximum of a major dimension (e.g. a diameter) of the opening. Furthermore, substantially axially aligned is intended to encompass the centroid of the dosing module mount and the centroid of the wastegate passage outlet occupying the same axial position along the flow axis (e.g. both centroids lying in the same plane normal to the flow axis).

Advantageously, aftertreatment fluid is thus injected into a high energy and high mixing zone having a high turbulent kinetic energy.

The dosing module mount may be angled towards the flow axis such that the opening of the dosing module mount points in a downstream direction.

Described another way, the dosing module mount is positioned such that aftertreatment fluid, expelled from a dosing module mounted to the dosing module mount, is injected with a flow of exhaust gas (as opposed to, for example, against the flow). The dosing module mount may be said to be angled away from a turbine wheel. The dosing module mount may be said to be angled towards an outlet of the turbine housing element.

Advantageously, having the dosing module mount point in a downstream direction results in a more predictable spray placement which improves robustness across a range of different engine operating conditions. Shear stresses are also high in the primary impingement zone, reducing the risk of wall film formation/deposit build-up.

The turbine housing element may be a monoblock turbine housing, the turbine housing comprising:
a turbine inlet passage configured to receive exhaust gas from an internal combustion engine;
a turbine wheel chamber configured to receive exhaust gas from the turbine inlet passage;
wherein the turbine outlet passage is configured to receive exhaust gas from the turbine wheel chamber;
wherein the flow axis extends from a downstream end of the turbine wheel chamber; and
wherein the at least part of a wastegate passage comprises an entire wastegate passage which extends between the turbine inlet passage and the turbine outlet passage, the wastegate passage bypassing the turbine wheel chamber.

Monoblock turbine housing is intended to refer to a turbine housing which is a single, unitary component. For example, there is no separate connection adapter. A monoblock turbine housing may otherwise be described as having a unitary structure.

The monoblock turbine housing may comprise a volute, wheel chamber and diffuser. The monoblock turbine housing may be cast as a single, monolithic structure. The monoblock turbine housing may be described as a wastegate monoblock turbine housing, owing to the presence of the wastegate passage.

Owing to the monoblock turbine housing defining the turbine outlet passage, the dosing module mount is also incorporated in the turbine housing. Put another way, the turbine housing comprises the dosing module mount.

A monoblock turbine housing is advantageous because the number of joints, in which the aftertreatment fluid and/or resulting deposits can settle and risk corrosion to the turbine housing, is reduced or eliminated altogether.

The turbine inlet passage may be defined by a volute. The turbine wheel chamber may be described as receiving, or being configured to receive, a turbine wheel. The flow axis may be described as extending from the downstream end of the turbine wheel chamber and/or a downstream end of the turbine wheel.

The entire wastegate passage refers to a complete wastegate passage which extends from a wastegate passage inlet, providing fluid communication between the wastegate passage and the turbine inlet passage, and an outlet (the wastegate passage outlet) providing fluid communication between the wastegate passage and the turbine outlet passage. The wastegate passage bypassing the turbine wheel chamber is intended to mean that exhaust gas which passes through the wastegate passage has been diverted around the turbine wheel chamber. Put another way, of a full proportion of exhaust gas which is received in the turbine inlet passage, a portion of the total exhaust gas flow may flow to the turbine wheel chamber and out via the turbine outlet passage, whilst a portion of the flow (a bypass flow) flows through the wastegate passage. The bypass flow does not flow through the wheel chamber. The bypass flow then merges with the turbine outlet passage via the wastegate passage outlet. The wastegate passage may be closed (e.g. the valve member in a closed configuration) for low flowrate conditions through the turbine.

The monoblock turbine housing may comprise a diffuser, the diffuser being at least a diverging portion of the turbine outlet passage.

According to a second aspect of the invention there is provided a wastegate turbine dosing system for a turbocharger, the turbine dosing system comprising:
the turbine housing element as defined above, the turbine wheel chamber containing a turbine wheel supported for rotation about a turbine wheel axis, the turbine wheel comprising an exducer defining an exducer diameter;
the flow axis extending from a downstream end of the turbine wheel; and
a dosing module mounted to the dosing module mount and configured to inject aftertreatment fluid, via the opening of the dosing module mount, into exhaust gas in the turbine outlet passage.

The turbine dosing system may comprise a radial turbine. The turbine dosing system may comprise an axial turbine. The turbine dosing system may form part of a turbocharger dosing system. The turbocharger, specifically a turbine thereof, may be a fixed geometry turbine or a variable geometry turbine. The turbine dosing system may form part of a turbo-compound system (e.g. a system in which a turbine delivers mechanical work to a crankshaft of an engine, either instead of, or in addition to, a compressor).

The turbine inlet passage may be defined by a volute. The volute defines a generally spiralling geometry which varies in cross-section along its extent.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “exducer” refers to the portion of the turbine wheel which discharges exhaust gas. Described another way, the term “exducer” encompasses the part of the turbine wheel which functions as the outlet of the turbine wheel (i.e. the distal end of the turbine wheel from the perspective of the turbine bulk flow travelling therethrough). The exducer diameter refers to a diameter of the turbine wheel at a downstream-most point of the blades. Described another way, the term “exducer diameter” encompasses the diameter of the exducer, at the most distal part of the turbine wheel from the perspective of the turbine bulk flow. The turbine wheel may further comprise an inducer, through which exhaust gas enters the turbine wheel.

The turbine wheel may be a radial turbine wheel comprising an inducer and an exducer. A radial turbine wheel may be configured to receive incident exhaust gas (at the inducer thereof) in a radial direction in relation to the turbine wheel axis. The “exducer” is not intended to refer to features of the turbine wheel which do not act to discharge exhaust gas into the turbine outlet passage (e.g. wheel nuts, aftertreatment dosing cups or the like). The turbine wheel may be a cupless turbine wheel (e.g. not having a dosing cup, into which aftertreatment fluid is injected, which atomises the aftertreatment fluid before it is dispersed into the exhaust gas).

The turbine wheel may be secured to a shaft by a turbine wheel nut. The wheel nut may be coaxial with the turbine wheel axis, and be configured to rotate about the turbine wheel axis. The turbine wheel nut may define an effective end face, or a downstream-most end, of the turbine wheel.

The dosing module may inject aftertreatment fluid in a conical manner. That is to say, the dosing module may inject the aftertreatment fluid as a spray, the spray having a generally triangular cross section. Aftertreatment fluid may be injected, or expelled, from the dosing module via an outlet of the dosing module. In use, the spray cone of aftertreatment fluid produced by the dosing module is also preferably aligned to be disposed in proximity to the wastegate passage outlet. The spray cone may at least partially overlap the wastegate passage outlet along the flow axis. The spray cone may entirely contain the wastegate passage outlet along the flow axis.

The opening of the dosing module mount may be disposed within around 3 exducer diameters, along the flow axis, of the wastegate passage outlet.

Locating the opening of the dosing module mount within 3 exducer diameters of the wastegate passage outlet has been found to advantageously locate the opening of the dosing module mount in a high mixing, and high energy, region of the exhaust gas flow. Dispersal of the aftertreatment fluid, and so reductant, and decomposition of the same, in the exhaust gas flow is therefore improved as a result of locating the opening of the dosing module mount at the aforementioned range of positions. The opening of the dosing module mount may be disposed within around 1 exducer diameter, along the flow axis, of the wastegate passage outlet.

The turbine housing element may be a connection adapter, the connection adapter comprising:
a first connection portion, at a first end of the connection adapter, configured to engage a turbine housing;
a second connection portion, at a second end of the connection adapter, configured to engage a downstream conduit; and
a structure which extends between the first and second ends of the connection adapter and defines at least part of the turbine outlet passage, the at least part of the turbine outlet passage defining at least part of the flow axis, the structure further defining the at least part of a wastegate passage.

The structure may be a wall.

The term “connection adapter” refers to a component which is provided between a turbine housing and a downstream conduit. The connection adapter may, for example, interpose a turbine housing and an exhaust manifold or pipe. The connection adapter may engage a turbine housing at one end. The connection adapter may be referred to as a dosing connection adapter, or a reductant dosing connection adapter, owing to incorporation of the dosing module mount therein.

The connection adapter may define an entirety, or a majority, of the turbine outlet passage. The turbine housing may be said to define at least part of the turbine outlet passage. The turbine housing may not define any of the turbine outlet passage (e.g. the connection adapter may extend from a downstream end of the turbine wheel).

The connection adapter is advantageous because a single design of turbine housing can be used for a range of different applications. That is to say, the connection adapter can be more readily modified for connection to a downstream conduit as dictated by application requirements. As such, rather than providing a range of different turbine housings, which are a complicated geometry to design and manufacture, the connection adapter can be modified depending upon application requirements. A customer can therefore attach their preferred conduit to a downstream end of the connection adapter, whilst using a single design of turbine housing for the turbine. This is also advantageous because the dosing module mount, which may be a customer specific requirement, can be incorporated in the connection adapter, relatively close to the turbine wheel. Furthermore, the connection adapter can be readily attached to the turbine housing, and to a conduit, such that the installation is straightforward.

Where a connection adapter is present, a combination of the connection adapter and the turbine housing may be referred to as a turbine housing assembly (e.g. a multi-part turbine housing).

The first and second connection portions may be, for example, flanges. first and second connection portions may be configured to receive a clamp e.g. a V-band clamp.

The connection adapter, specifically the structure thereof, may define an entire turbine outlet passage, or may only define part thereof (e.g. a downstream portion of the turbine outlet passage). For example, where the turbine outlet passage, as defined by the connection adapter, extends directly from a downstream end of a turbine wheel and/or wheel chamber, the connection adapter may define an entirety of the turbine outlet passage. Alternatively, where a turbine housing defines part of the turbine outlet passage (e.g. where there is an axial offset between the first end of the connection adapter with respect to the downstream end of the turbine wheel and/or wheel chamber) then the connection adapter may define a second portion, or downstream portion, of the turbine outlet passage.

The connection adapter may define an entire wastegate passage. Alternatively, in most embodiments the connection adapter may only define part of the turbine outlet passage (e.g. only part of the wastegate passage that extends between a turbine inlet passage and the wastegate passage outlet). The at least part of the wastegate passage may be said to be defined by a wastegate channel.

According to a third aspect of the invention there is provided a wastegate turbine dosing system for a turbocharger, the turbine dosing system comprising:
a turbine housing;
the turbine housing element as defined above; and
a dosing module;
wherein the turbine housing comprises:
   a turbine inlet passage configured to receive exhaust gas from an internal combustion engine;
   a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
wherein the turbine housing element is coupled to the turbine housing, the turbine outlet passage being provided downstream of the turbine wheel chamber and configured to receive exhaust gas from the turbine wheel chamber;
wherein the dosing module is mounted to the dosing module mount and configured to inject aftertreatment fluid, via the opening of the dosing module mount, into exhaust gas in the turbine outlet passage.

Owing to the presence of the turbine housing and the connection adapter coupled thereto, the turbine dosing system may be said to comprise a turbine housing assembly (e.g. a multi-part turbine housing).

The turbine housing element (or connection adapter more specifically) may be directly, or indirectly, coupled to the turbine housing (e.g. there may be an interposing gasket).

The at least part of the wastegate passage, as defined by the structure of the connection adapter, may extend at least partway between the turbine inlet passage and the wastegate passage outlet. Where the turbine housing element is coupled to the turbine housing (e.g. where the turbine housing element is a connection adapter), the at least part of a wastegate passage may define part of a fluid pathway which extends from the turbine inlet passage to the wastegate passage outlet. An entire wastegate passage may be defined by the at least part of the wastegate passage and one or more further portions of the wastegate passage (which may, for example, be defined by the turbine housing).

The opening of the dosing module mount may be disposed within around 3 exducer diameters, along the flow axis, of the wastegate passage outlet.

According to a fourth aspect of the invention there is provided a wastegate turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage defining a flow axis which extends from a downstream end of the turbine wheel;
a wastegate passage, configured to receive a bypass flow of exhaust gas, which extends between the turbine inlet passage and the turbine outlet passage, around the turbine wheel chamber, the wastegate passage provided in fluid communication with the turbine outlet passage via a wastegate passage outlet; and
a dosing module configured to inject aftertreatment fluid, via an outlet of the dosing module, into exhaust gas in the turbine outlet passage;
wherein the dosing module is disposed within around 3 exducer diameters, along the flow axis, of the wastegate passage outlet.

The term “outlet” refers to the part of the dosing module from which the aftertreatment fluid leaves the dosing module (e.g. an aperture). That is to say, the part of the dosing module from which aftertreatment fluid emanates. The outlet may be defined in a nozzle of the dosing module.

It may be an outlet of the dosing module which is disposed within around 3 exducer diameters, along the flow axis, of the wastegate passage outlet. The centroid of the outlet of the dosing module may be located within around 3 exducer diameters, along the flow axis, of a centroid of the wastegate passage outlet. The dosing module may be disposed downstream of the wastegate passage outlet. The dosing module, optionally an outlet thereof, may at least partially overlap the wastegate passage outlet along the flow axis. A centroid of the dosing module outlet may be disposed at an axial position, along the flow axis, which lies within an axial extent of the wastegate passage outlet. The centroids of the dosing module outlet and the wastegate passage outlet may be substantially axially aligned with one another.

The dosing module may be disposed within around 1 exducer diameter, along the flow axis, of the wastegate passage outlet

The dosing module may be mounted to, or coupled to, a monoblock turbine housing, a connection adapter (of a turbine housing assembly) or a downstream conduit. The turbine outlet passage may be at least partly defined by one or more of a monoblock turbine housing, a turbine housing, a connection adapter and/or a downstream conduit.

The dosing module may be mounted to the same component which incorporates, or defines, the wastegate passage outlet. For example, the dosing module may be mounted to a monoblock turbine housing, the monoblock turbine housing also defining the wastegate passage outlet. Alternatively, the dosing module may be mounted to a different component to that which incorporates the wastegate passage outlet. For example, the wastegate passage outlet may be provided at a downstream end of a connection adapter, and a dosing module may be located within 3 exducer diameters of the wastegate passage outlet, the dosing module being mounted to a downstream conduit which is connected to the connection adapter. Accordingly, it will be appreciated that the dosing module and wastegate passage outlet may be mounted to/incorporated in different specific components whilst still obtaining the same advantages as if they were mounted to/incorporated in the same component.

Advantageously, locating the dosing module within around 3 exducer diameters, along the flow axis, of the wastegate passage outlet, effectively means that a high-mixing zone, owing to merging of the bulk turbine and bypass flows, can be harnessed to aid the dispersal of aftertreatment fluid (and reductant therein) throughout the exhaust gas flow.

The wastegate passage outlet may be defined at a downstream end of the wastegate passage. The wastegate passage outlet may be defined partway along the wastegate passage.

The dosing module may be angled towards the flow axis such that an outlet of the dosing module mount points in a downstream direction (e.g. away from the turbine wheel).

Advantageously, having the dosing module point in a downstream direction results in a more predictable spray placement which improves robustness across a range of different engine operating conditions.

The turbine dosing system may comprise an exhaust gas sensor. The exhaust gas sensor may be a NOx sensor.

Wastegate turbine dosing system refers to a turbine dosing system which incorporates a wastegate. The wastegate may be a flap valve-style wastegate (e.g. having a pivotable valve member and a valve seat). Alternatively, the wastegate may be a rotary valve. Wastegate is intended to encompass any arrangement whereby exhaust gas can be selectively diverted around the turbine, without being expanded across the turbine. The wastegate may be referred to as a selective bypass arrangement, or flowpath.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “exducer” refers to the portion of the turbine wheel which discharges exhaust gas. Described another way, the term “exducer” encompasses the part of the turbine wheel which functions as the outlet of the turbine wheel (i.e. the distal end of the turbine wheel from the perspective of the turbine bulk flow travelling therethrough). The exducer diameter refers to a diameter of the turbine wheel at a downstream-most point of the blades. Described another way, the term “exducer diameter” encompasses the diameter of the exducer, at the most distal part of the turbine wheel from the perspective of the turbine bulk flow. The turbine wheel may further comprise an inducer, through which exhaust gas enters the turbine wheel.

The turbine wheel may be a radial turbine wheel comprising an inducer and an exducer. A radial turbine wheel may be configured to receive incident exhaust gas (at the inducer thereof) in a radial direction in relation to the turbine wheel axis. The “exducer” is not intended to refer to features of the turbine wheel which do not act to discharge exhaust gas into the turbine outlet passage (e.g. wheel nuts, aftertreatment dosing cups or the like). The turbine wheel may be a cupless turbine wheel (e.g. where the wheel hub does not having a dosing cup, into which aftertreatment fluid is injected, which atomises the aftertreatment fluid before it is dispersed into the exhaust gas). A turbine wheel incorporating such a cup may be referred to as a radial slinging atomiser, a radial atomiser, a centrifugal atomiser or a rotating atomiser.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with the turbine wheel axis. The flow axis may extend from the turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The turbine wheel may be secured to a shaft by a turbine wheel nut. The wheel nut may be coaxial with the turbine wheel axis, and be configured to rotate about the turbine wheel axis. The turbine wheel nut may define an effective end face, or a downstream-most end, of the turbine wheel. The dosing module mount may be provided within around 7 exducer diameters along the flow axis from the end face of the turbine wheel nut.

As used herein, the term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process.

The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

According to a fifth aspect of the invention there is provided a method of operating a turbine housing element for a wastegate turbine dosing system, comprising:
receiving a turbine bulk flow of exhaust gas into a turbine outlet passage, the turbine outlet passage defining a flow axis that extends through the turbine outlet passage; and
receiving a bypass flow of exhaust gas into at least part of a wastegate passage, the at least part of a wastegate passage being in fluid communication with the turbine outlet passage via a wastegate passage outlet;
wherein the turbine housing element further comprises a dosing module mount, configured to receive a dosing module, the dosing module mount defining an opening in fluid communication with the turbine outlet passage; and
wherein the opening of the dosing module mount is disposed within around 3 turbine outlet passage diameters, along the flow axis, of the wastegate passage outlet.

A centroid of the opening of the dosing module mount may be located within around 3 turbine outlet passage diameters, along the flow axis, of a centroid of the wastegate passage outlet. The opening may be positioned downstream of the wastegate passage outlet. The opening may at least partially overlap the wastegate passage outlet along the flow axis. The centroid of the opening of the dosing module mount may be disposed at an axial position, along the flow axis, within an axial extent of the wastegate passage outlet along the flow axis. The centroid of the opening of the dosing module mount may be substantially axially aligned with the centroid of the wastegate passage outlet. The dosing module mount may be angled towards the flow axis such that the opening of the dosing module mount points in a downstream direction.

The turbine housing element may be a monoblock turbine housing, the method comprising:
receiving exhaust gas from an internal combustion engine into a turbine inlet passage of the monoblock turbine housing;
receiving exhaust gas from the turbine inlet passage into a turbine wheel chamber;
receiving exhaust gas from the turbine wheel chamber into the turbine outlet passage;
wherein the flow axis extends from a downstream end of the turbine wheel chamber; and
wherein the at least part of a wastegate passage comprises an entire wastegate passage which extends between the turbine inlet passage and the turbine outlet passage, the wastegate passage bypassing the turbine wheel chamber.

According to a sixth aspect of the invention, there is provided a method of operating a wastegate turbine dosing system for a turbocharger, comprising:
the method as defined above, the turbine wheel chamber containing a turbine wheel supported for rotation about a turbine wheel axis, the turbine wheel comprising an exducer defining an exducer diameter, the flow axis extending from a downstream end of the turbine wheel; and
injecting aftertreatment fluid, via the opening of the dosing module mount, into exhaust gas in the turbine outlet passage using a dosing module mounted to the dosing module mount.

The opening of the dosing module mount may be disposed within around 3 exducer diameters, along the flow axis, of the wastegate passage outlet.

The turbine housing element may be a connection adapter, the connection adapter comprising:
a first connection portion, at a first end of the connection adapter, configured to engage a turbine housing;
a second connection portion, at a second end of the connection adapter, configured to engage a downstream conduit; and
a structure which extends between the first and second ends of the connection adapter and defines at least part of the turbine outlet passage, the at least part of the turbine outlet passage defining at least part of the flow axis, the structure further defining the at least part of a wastegate passage.

According to a seventh aspect of the invention there is provided a method of operating a wastegate turbine dosing system for a turbocharger, comprising:
receiving exhaust gas from an internal combustion engine into a turbine inlet passage of a turbine housing;
receiving exhaust gas from the turbine inlet passage into a turbine wheel chamber of the turbine housing, the turbine wheel chamber containing a turbine wheel supported for rotation about a turbine wheel axis, the turbine wheel comprising an exducer defining an exducer diameter;
receiving exhaust gas from the turbine wheel chamber into the turbine outlet passage recited in the method defined above, the turbine housing element being coupled to the turbine housing; and
injecting aftertreatment fluid, via the opening of the dosing module mount, into exhaust gas in the turbine outlet passage using a dosing module mounted to the dosing module mount.

The opening of the dosing module mount may be disposed within around 3 exducer diameters, along the flow axis, of the wastegate passage outlet.

According to an eighth aspect of the invention there is provided a method of operating a wastegate turbine dosing system for a turbocharger, the method comprising:
receiving exhaust gas from an internal combustion engine into a turbine inlet passage;
receiving exhaust gas from the turbine inlet passage into a turbine wheel chamber configured to, the turbine wheel chamber containing a turbine wheel supported for rotation about a turbine wheel axis, the turbine wheel comprising an exducer defining an exducer diameter;
receive exhaust gas from the turbine wheel chamber into a turbine outlet passage downstream of the turbine wheel chamber, the turbine outlet passage defining a flow axis which extends from a downstream end of the turbine wheel;
receiving a bypass flow of exhaust gas into a wastegate passage, which extends between the turbine inlet passage and the turbine outlet passage, around the turbine wheel chamber, the wastegate passage provided in fluid communication with the turbine outlet passage via a wastegate passage outlet; and
injecting aftertreatment fluid using a dosing module, via an outlet of the dosing module, into exhaust gas in the turbine outlet passage;
wherein the dosing module is disposed within around 3 exducer diameters, along the flow axis, of the wastegate passage outlet.

According to a ninth aspect of the invention there is provided a turbine dosing system for turbine a turbocharger, the dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 5 exducer diameters, along the flow axis, downstream of the downstream end of the turbine wheel.

Given that the dosing module mount is configured to receive a dosing module, it will be appreciated that the position of the dosing module mount, e.g. the opening thereof, is indicative of the position of the dosing module once received therein. The dosing module mount position therefore defines the location of the dosing module and the aftertreatment fluid injection (e.g. a primary impingement zone as defined by a spray cone of the dosing module) in the assembled dosing system.

The structure may be a wall. The structure may be part of a turbine housing (e.g. monoblock turbine housing), connection adapter or conduit. A turbine housing (e.g. monoblock turbine housing) may thus comprise the dosing module mount. A connection adapter may comprise the dosing module mount. Alternatively, a conduit may comprise the dosing module mount. The dosing module may thus be mounted to a turbine housing (e.g. monoblock turbine housing), connection adapter or conduit. The structure may be described as a single skin (e.g. single wall) arrangement (i.e. where no secondary wall, or diffuser insert, is present).

The dosing module being located within around 5 exducer diameters, along the flow axis, downstream of the downstream end of the turbine wheel encompasses a centroid of an outlet of the dosing module being located within around 5 exducer diameters, along the flow axis, downstream of the downstream end of the turbine wheel. The position of the dosing module is intended to be taken at a point, along the flow axis, where a minimum distance exists between the dosing module and the flow axis. For example, the position may refer to the position of a plane, normal to the flow axis, in which the dosing module (e.g. a centroid of an outlet thereof) lies.

A primary impingement zone (i.e. a zone which is contacted by the aftertreatment fluid spray expelled by the dosing module) may at least partially overlap a point, along the flow axis, around 5 exducer diameters downstream of the downstream end of the turbine wheel. Put another way, at least part of the primary impingement zone may be defined within around 5 exducer diameters downstream of the downstream end of the turbine wheel. A majority, or entirety, of a primary impingement zone may be defined within around 5 exducer diameters downstream of the downstream end of the turbine wheel.

Advantageously, providing the dosing module within around 5 exducer diameters of the downstream end of the turbine wheel facilities the injection of aftertreatment fluid into a high turbulent kinetic energy (TKE) zone of the exhaust gas flow. That is to say, where exhaust gas is expanded across the turbine wheel, the downstream gas flow creates a highly dynamic flow field. This may be at least in part due to expansion of the exhaust gas flow from the turbine exit, which may be owing to the presence of a diverging portion (e.g. a diffuser) of the turbine outlet passage. The TKE may be described as a level of gaseous mixing in a volume, fundamentally referring to a disordered ‘jumble’ of flow vectors of varied directions and magnitude. By injecting the aftertreatment fluid into exhaust gas in the high TKE zone, the two phase mixing of reductant (in the aftertreatment fluid) and exhaust gas is improved. Decomposition is improved and the uniformity index is also improved as a result. These improvements are attributable, at least in part, due to an increase in convective heat transfer due to increased relative velocities of the droplets (of aftertreatment fluid) and exhaust gas, and increased ‘natural’ mixing of the flow as the reductant decomposes. The droplets decompose faster, and the resulting NH₃ and HNCO gases are effectively mixed with fresh gas. Uniformity index refers to a spatial measurement of reductant to NOx in the gaseous volume. A uniformity index of 1.0 indicates that the reductant is equally spread across a whole catalyst face, facilitating the greatest possible NOx conversion. The uniformity index can be measured in terms of an ANR ratio (ammonia to NOx) or NH₃ only.

By way of a further advantage, by locating the dosing module within around 5 exducer diameters downstream of the downstream end of the turbine wheel, aftertreatment fluid can be injected into a high velocity peripheral layer (HVPL) of the exhaust gas flow. As exhaust gas flow is expanded across the turbine wheel, and exits the turbine wheel via the exducer, the exhaust gas is an expanding flow with a high internal energy (thermal and kinetic [(both axial and rotational].

As the exhaust gas flow exits the turbine wheel, angular momentum and expansion urge the exhaust gas flow to ‘hug’ the walls which define the turbine outlet passage. Described another way, a region of high velocity exhaust gas exists at the periphery of the turbine outlet passage. These high velocity zones result in high levels of shear stress in these regions (i.e. at the walls) and so high relative velocities between the exhaust gas and the injected aftertreatment fluid. The high relative velocities give rise to two benefits: i) the potential to shear large aftertreatment fluid droplets into smaller diameter droplets (assisting with decomposition speed); and (ii) increases convective heat transfer to the droplets (also increasing decomposition speed). Both of these advantages assist with reducing the package size of the aftertreatment system because, for example, associated catalysts can be placed closer to the engine. NOx levels are also reduced at lower temperature operating conditions, which is desirable for reasons of reducing any efficiency lag following (cold) engine startup. Problems associated with poor decomposition due to droplet breakup, slow decomposition, low temperatures and large package size can therefore be overcome. For at least these reasons, it is therefore desirable to inject aftertreatment fluid into these high velocity zones.

Based upon the above, it will be appreciated that locating the dosing module within around 5 exducer diameters, along the flow axis, downstream of the downstream end of the turbine wheel means that injected aftertreatment fluid benefits twofold from both a high TKE zone and a HVPL, each having their own associated advantages.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “exducer” refers to the portion of the turbine wheel which discharges exhaust gas. Described another way, the term “exducer” encompasses the part of the turbine wheel which functions as the outlet of the turbine wheel (i.e. the distal end of the turbine wheel from the perspective of the turbine bulk flow travelling therethrough). The exducer diameter refers to a diameter of the turbine wheel at a downstream-most point of the blades. Described another way, the term “exducer diameter” encompasses the diameter of the exducer, at the most distal part of the turbine wheel from the perspective of the turbine bulk flow. The turbine wheel may further comprise an inducer, through which exhaust gas enters the turbine wheel.

The turbine wheel may be a radial turbine wheel comprising an inducer and an exducer. A radial turbine wheel may be configured to receive incident exhaust gas (at the inducer thereof) in a radial direction in relation to the turbine wheel axis. The “exducer” is not intended to refer to features of the turbine wheel which do not act to discharge exhaust gas into the turbine outlet passage (e.g. wheel nuts, aftertreatment dosing cups or the like). The turbine wheel may be a cupless turbine wheel (e.g. where the wheel hub does not having a dosing cup, into which aftertreatment fluid is injected, which atomises the aftertreatment fluid before it is dispersed into the exhaust gas). A turbine wheel incorporating such a cup may be referred to as a radial slinging atomiser, a radial atomiser, a centrifugal atomiser or a rotating atomiser.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with the turbine wheel axis. The flow axis may extend from the turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The turbine wheel may be secured to a shaft by a turbine wheel nut. The wheel nut may be coaxial with the turbine wheel axis, and be configured to rotate about the turbine wheel axis. The turbine wheel nut may define an effective end face, or a downstream-most end, of the turbine wheel. The dosing module mount may be provided within around 7 exducer diameters along the flow axis from the end face of the turbine wheel nut.

As used herein, the term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The aftertreatment fluid may be a urea solution. The dosing module may be provided in fluid communication with a tank, or reservoir, in which a supply (e.g. volume) of aftertreatment fluid is stored. The tank, or reservoir, is preferably a separate tank to that of a fuel tank. Put another way, the overall system may comprise a fuel tank and a reductant tank, and only the reductant tank may be provided in fluid communication with the dosing module. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel. The dosing module may be described as an externally accessible module. The dosing module may be described as being externally attachable, or mountable.

The dosing module mount may comprise an opening defined in the structure. The opening may be a through-bore. The opening may extend through the structure (e.g. providing fluid communication between the turbine outlet passage and an exterior of the structure). The dosing module may extend at least partway across the structure via the opening. The opening may extend through the single wall of a single wall structure. The turbine dosing system may further comprise a dosing module configured to inject aftertreatment fluid into exhaust gas in the turbine outlet passage.

The dosing module mount may be located between around 0.5 and around 5 exducer diameters, along the flow axis, downstream of the downstream end of the turbine wheel.

It may be the case that exhaust gas has a relatively low TKE up until a distance of around 0.5 exducer diameters, along the flow axis, from the downstream end of the turbine wheel. It is therefore advantageous to position the dosing module between around 0.5 exducer diameters and around 5 exducer diameters downstream of the downstream end of the turbine wheel to benefit from a zone of highest TKE.

The dosing module mount may be located between around 1 and around 3 exducer diameters, along the flow axis, downstream of the downstream end of the turbine wheel.

In a similar vein to the advantages described above, providing the dosing module within around 1 and around 3 exducer diameters, along the flow axis, downstream of the downstream end of the turbine wheel means that the dosing module is located in a comparatively highest TKE zone. That is to say, it is typically between around 1 and around 3 exducer diameters downstream of the turbine wheel that the TKE of the exhaust gas flow is at its highest.

The dosing module mount may be located within around 3 exducer diameters, along the flow axis, downstream of the downstream end of the turbine wheel.

Providing the dosing module within around 3 exducer diameters of the downstream end of the turbine wheel advantageously facilitates injection of aftertreatment fluid into a high velocity peripheral layer (HVPL) of exhaust gas. In particular, the HVPL may be positioned between around 2 and around 3 exducer diameters downstream of the downstream end of the turbine wheel. As previously described, injecting aftertreatment fluid into the HVPL is advantageous for reasons of higher shear and improved decomposition of the aftertreatment fluid.

A primary impingement zone defined by the dosing module may at least partially overlap a point, around 3 exducer diameters of the downstream end of the turbine wheel, on the flow axis.

The dosing module mount may be located upstream of a first bend of the turbine outlet passage.

A first bend refers to the first point at which the turbine outlet passage changes direction. It may be the case the level of TKE within the flow reduces significantly downstream of a bend in the turbine outlet passage. As such, advantageously the dosing module is located upstream of a first bend of the turbine outlet passage such that the TKE level remains relatively high.

Put another way, the dosing module may be described as being located within a linear extent of the flow axis downstream of the turbine wheel.

The dosing module may be configured to inject aftertreatment fluid into exhaust gas in a diverging portion of the turbine outlet passage.

Diverging portion of the turbine outlet passage is intended to mean that the turbine outlet passage is increasing in cross sectional area in that region. The diverging portion of the turbine outlet passage may otherwise be described as a diffuser or a diffusing portion. The dosing module and/or dosing module mount may be described as being provided adjacent a diverging portion of the turbine outlet passage.

Owing to the presence of the diverging portion, the TKE is relatively high (owing to the expansion) and the HVPL present.

According to a tenth aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage defining a flow axis which extends from a downstream end of the turbine wheel; and
a dosing module configured to inject aftertreatment fluid into exhaust gas in the turbine outlet passage;
wherein the dosing module is located within around 5 exducer diameters, along the flow axis, downstream of the downstream end of the turbine wheel.

The dosing module being located within around 5 exducer diameters, along the flow axis, downstream of the downstream end of the turbine wheel encompasses a centroid of an outlet of the dosing module being located within around 5 exducer diameters, along the flow axis, downstream of the downstream end of the turbine wheel. The position of the dosing module is intended to be taken at a point, along the flow axis, where a minimum distance exists between the dosing module and the flow axis. For example, the position may refer to the position of a plane, normal to the flow axis, in which the dosing module (e.g. a centroid of an outlet thereof) lies.

A primary impingement zone (i.e. a zone which is contacted by the aftertreatment fluid spray expelled by the dosing module) may at least partially overlap a point, along the flow axis, around 5 exducer diameters downstream of the downstream end of the turbine wheel. Put another way, at least part of the primary impingement zone may be defined within around 5 exducer diameters downstream of the downstream end of the turbine wheel. A majority, or entirety, of a primary impingement zone may be defined within around 5 exducer diameters downstream of the downstream end of the turbine wheel.

According to an eleventh aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation about a turbine wheel axis, the turbine wheel comprising an exducer defining an exducer diameter;
receive exhaust gas from the turbine wheel chamber into a turbine outlet passage downstream of the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 5 exducer diameters, along the flow axis, downstream of the downstream end of the turbine wheel.

The method may further comprise injecting aftertreatment fluid into exhaust gas in the turbine outlet passage using a dosing module. The dosing module mount may be located between around 0.5 and around 5 exducer diameters, along the flow axis, downstream of the downstream end of the turbine wheel. The dosing module mount may be located between around 1 and around 3 exducer diameters, along the flow axis, downstream of the downstream end of the turbine wheel. The dosing module mount may be located within around 3 exducer diameters, along the flow axis, downstream of the downstream end of the turbine wheel. The dosing module mount may be located upstream of a first bend of the turbine outlet passage. The dosing module may inject aftertreatment fluid into exhaust gas in a diverging portion of the turbine outlet passage.

According to a twelfth aspect of the invention there is provided a connection adapter for an aftertreatment fluid dosing turbine housing assembly, the connection adapter comprising:
a first connection portion, at a first end of the connection adapter, configured to engage a turbine housing;
a second connection portion, at a second end of the connection adapter, configured to engage a downstream conduit; and
a structure which extends between the first and second ends of the connection adapter and defines a connection adapter passage configured to receive exhaust gas from a turbine housing, the connection adapter passage defining a flow axis;
wherein the structure comprises a dosing module mount configured to receive a dosing module; and
wherein the dosing module mount is angled towards the flow axis such that an opening of the dosing module mount points in a downstream direction.

The term “connection adapter” refers to a component which is provided between a turbine housing and a downstream conduit. The connection adapter may, for example, interpose a turbine housing and an exhaust manifold or pipe. The connection adapter may be referred to as a dosing connection adapter, or a reductant dosing connection adapter, owing to incorporation of the dosing module mount.

The connection adapter may be a generally frustoconical body. In other arrangements, the connection adapter may be a generally tubular body. The connection adapter may define a diffuser of a turbine housing assembly. The connection adapter may define at least part of a turbine diffuser. The turbine housing assembly defined by the combination of a turbine housing and the connection adapter may define a diverging portion of a turbine outlet passage. The diverging portion of the turbine outlet passage may be linearly extending (e.g. straight).

The term “dosing module mount” encompasses a structure which is configured to align, and support, a dosing module. The dosing module mount may be integrally formed with the structure, which defines a connection adapter passage, or may be attached to the structure by a joining process such as, for example, welding or brazing. Given that the dosing module mount is configured to receive a dosing module, it will be appreciated that the position of the dosing module mount, e.g. the opening thereof, is indicative of the position of the dosing module once received therein. The dosing module mount position therefore defines the location of the dosing module and the aftertreatment fluid injection (e.g. a primary impingement zone as defined by a spray cone of the dosing module) in the assembled dosing system.

The dosing module mount may define an opening in the connection adapter. Aftertreatment fluid may be injectable through the opening into the exhaust passage. The opening, and dosing module mount more generally, may provide fluid communication between an interior and an exterior of the connection adapter (e.g. across a wall thereof). The opening is preferably provided in an otherwise continuous wall, or surface. For example, the interior surface of the connection adapter may be generally tapered (e.g. in a linear manner), and the opening be provided through the wall so as to not interrupt the taper. Put another way, the opening is preferably not provided in a projecting ledge, or other feature, which otherwise interrupts (or influences) the bulk geometry of exhaust passage defined by the interior surface of the connection adapter.

The dosing module mount pointing in a downstream direction may otherwise be described as the dosing module mount being angled towards the second end of the connection adapter. Aftertreatment fluid, injected by a dosing module mounted to the dosing module mount, is thus injected in a downstream direction (e.g. away from a turbine wheel, and towards the second end of the connection adapter). Described another way, the dosing module injects aftertreatment fluid in a direction which is at least partly with, and optionally entirely with [e.g. parallel to]), a direction of the turbine bulk flow (e.g. in a flow direction). The dosing module mount may be positioned such that the dosing module injects aftertreatment fluid generally across the passage. The dosing module mount, specifically an opening thereof, may make an angle of at least around 5° off perpendicular, in the downstream direction, with respect to the flow axis.

Having the dosing module inject aftertreatment fluid in a downstream direction is advantageous in overcoming issues associated with: deposit build-up at the outlet of the dosing module; and aftertreatment fluid impingement on the turbine wheel and other internal turbine components).

The term “flow axis” refers to an axis about which the exhaust gas in the connection adapter passage generally rotates as it flows through the connection adapter passage (along the flow axis). The flow axis may be at least partly arcuate. The flow axis may be described as an imaginary line drawn along, and through, the connection adapter passage, the line being positioned at the geometric centre of the connection adapter passage. The flow axis may vary depending upon the geometry of the connection adapter. By way of example, if the connection adapter passage comprises a bend, the flow axis may also comprise a bend (e.g. be at least partly arcuate) as the direction of the exhaust gas flow in the connection adapter passage would be forced to change due to the bend in the connection adapter passage. The flow axis may be said to define a fluid flowpath which is generally followed by the turbine bulk flow once it has travelled downstream of the downstream end of the turbine wheel. For at least a portion of an extent of the flow axis, the flow axis may be coincident with a turbine wheel axis. The flow axis may extend from a turbine wheel axis.

The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

An outlet of the dosing module may be substantially flush with an interior surface of the connection adapter (e.g. which at least partly defines part of the turbine outlet passage). The outlet being substantially flush with an interior surface of the structure is intended to mean that the dosing module does not project into the turbine outlet passage by more than an assembly tolerance (e.g. around ±2 mm).

The connection adapter may comprise at least part of a wastegate arrangement. For example, the connection adapter may comprise at least part of a wastegate passage. The connection adapter may comprise a wastegate passage outlet (e.g. an opening through which the wastegate passage connects to the connection adapter passage or turbine outlet passage).

One or more of the first and second connection portions may be flanges. The flanges may be configured to receive a clamp (e.g. a V-band clamp).

According to a thirteenth aspect of the invention there is provided a method of operating a connection adapter for an aftertreatment fluid dosing turbine housing assembly, the connection adapter comprising:
a first connection portion, at a first end of the connection adapter, configured to engage a turbine housing;
a second connection portion, at a second end of the connection adapter, configured to engage a downstream conduit; and
a structure which extends between the first and second ends of the connection adapter and defines a connection adapter passage, the connection adapter passage defining a flow axis;
wherein the structure comprises a dosing module mount configured to receive a dosing module; and
wherein the dosing module mount is angled towards the flow axis such that an opening of the dosing module mount points in a downstream direction;
the method comprising receiving exhaust gas from a turbine housing into the connection adapter passage.

According to a fourteenth aspect of the invention there is provided a turbine dosing system for turbocharger, turbine a the dosing system comprising:
a turbine inlet passage configured to receive exhaust gas from an internal combustion engine;
a turbine wheel chamber configured to receive exhaust gas from the turbine inlet passage, the turbine wheel chamber configured to contain a turbine wheel;
a turbine outlet passage downstream of the turbine wheel chamber and configured to receive exhaust gas from the turbine wheel chamber, the turbine outlet passage defining a flow axis which extends from a downstream end of the turbine wheel chamber; and
a lance dosing module comprising a conduit which projects into the turbine outlet passage and is configured to inject aftertreatment fluid, via an outlet, into exhaust gas in a diverging portion of the turbine outlet passage.

The lance dosing module refers to a dosing module which projects at least partly into the turbine outlet passage. Specifically, the conduit of the dosing module projects at least partly into the turbine outlet passage. The conduit may be described as an elongate channel, or pipe-like. The conduit may be at least partly arcuate. The conduit may incorporate at least one change of direction (e.g. be a non-linear conduit). The outlet (of the conduit) may also be described as an outlet of the lance dosing module generally. The outlet is preferably provided at an end of the conduit. The outlet may comprise one or more orifices. A spray cone may be said to be defined by the lance dosing module in use, with the spray cone extending from the outlet.

The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The lance dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

Injecting aftertreatment fluid into exhaust gas in a diverging portion of the turbine outlet passage is intended to mean that at least the outlet of the conduit is located within a diverging portion of the turbine outlet passage. In some embodiments, an entirety of the conduit may be located within the diverging portion. The diverging portion may otherwise be described as a diffusing portion or a diffuser.

“Injecting aftertreatment fluid” is intended to encompass the aftertreatment fluid being atomised as it is expelled from the conduit via the outlet. “Injecting aftertreatment fluid” is intended to mean that the lance dosing module injects aftertreatment fluid directly into at least a turbine bulk flow (e.g. core exhaust flow).

The turbine wheel chamber may contain a turbine wheel. The turbine wheel may be supported for rotation about a turbine wheel axis. The turbine wheel may comprise an exducer defining an exducer diameter. The flow axis preferably extends from a downstream end of the turbine wheel.

Advantageously, by injecting aftertreatment fluid into exhaust gas in a diverging portion of the turbine outlet passage, the aftertreatment fluid is injected into a region of high turbulence. This is at least in part due to the diffuser creating a recirculation zone within the turbine outlet passage.

The conduit projecting into the turbine outlet passage advantageously means that the aftertreatment fluid is injected closer to the flow axis. Given that the flow axis defines a region of zone of highest recirculation (and so highest turbulence), it is desirable that the aftertreatment fluid be injected into this zone.

By injecting aftertreatment fluid through a conduit which projects into the turbine outlet passage, into exhaust gas in a diverging portion, advantageously aftertreatment fluid is injected into a high recirculation zone. The high recirculation zone defines a region where the flow is of particularly high turbulence, which is advantageous for reasons of providing sufficient time for the aftertreatment fluid to mix with exhaust gas, and providing a high decomposition rate and reduced risk of deposition/deposit build-up.

The turbine inlet passage may be defined by a volute. The volute defines a generally spiralling geometry which varies in cross-section along its extent. The term “passage” refers to a volume, defined or bound by a surrounding structure, through which fluid can flow.

The term “flow axis” refers to an axis about which the exhaust gas in the turbine outlet passage generally rotates as it flows through the turbine outlet passage (along the flow axis). The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with a turbine wheel axis. The flow axis may extend from a turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis).

The turbine outlet passage may be described as being at least partly defined by a structure. The structure may comprise a turbine housing, connection adapter or conduit.

The lance dosing module may be configured to inject aftertreatment fluid in a generally downstream direction with respect to the flow axis.

The lance dosing module injecting aftertreatment fluid in a generally downstream direction encompasses aftertreatment fluid being injected coaxially with the flow axis.

The generally downstream direction also includes a direction which is slightly offset from a purely coaxial direction, for example, within ±10° of the flow axis.

Advantageously, injecting aftertreatment fluid in a generally downstream direction facilitates the expulsion of aftertreatment fluid from the conduit outlet by the surrounding exhaust gas flow. Furthermore, there is a reduced risk of aftertreatment fluid blocking the conduit. The risk of any debris (e.g. soot) being urged into the outlet, or impinging upon an orifice plate, is also reduced. The risk of aftertreatment fluid being sprayed into the turbine assembly is also reduced.

The conduit may extend at least partway along the flow axis.

The conduit extending at least partway along the flow axis is intended to mean that at least part of the conduit is provided in a plane normal to the flow axis. Put another way, part of the conduit extends in the same direction as the flow axis (but is not necessarily coaxial with the flow axis). In preferred embodiments, at least a downstream portion of the conduit extends along the flow axis. It will also be appreciated that, by virtue of the conduit projecting into the turbine outlet passage, where the conduit extends at least partway along the flow axis, the conduit extends between a structure which defines the relevant portion of the turbine outlet passage, and the flow axis.

Advantageously, the conduit extending at least partway along the flow axis means that aftertreatment fluid is injected into a zone of high recirculation (which is typically located proximate the flow axis). This is where the highest decomposition rates are likely to be obtained, along with associated lower deposition rates.

The outlet of the lance dosing module is coaxial with the flow axis.

The outlet of the lance dosing module being coaxial with the flow axis is intended to mean that the outlet points in a downstream direction. By locating the outlet of the lance dosing module coaxially with the flow axis, aftertreatment fluid is injected into a region of highest recirculation, with resulting high decomposition rates and low deposition rates.

The turbine dosing system may further comprise a turbine wheel, contained by the turbine wheel chamber, the turbine wheel being supported for rotation about a turbine wheel axis, the turbine wheel comprising an exducer defining an exducer diameter; and wherein
the outlet of the lance dosing module is located within around 5 exducer diameters, along the flow axis, downstream of the downstream end of the turbine wheel.

Advantageously, by locating the outlet of the dosing module within around 5 exducer diameters of the downstream end of the turbine wheel, the turbulent effects resulting from the turbine wheel are still present in the exhaust gas flow. The aftertreatment fluid is thus injected into a highly turbulent flow field, providing high decomposition and low deposition rates.

According to a fifteenth aspect of the invention, a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber configured to contain a turbine wheel;
receiving exhaust gas from the turbine wheel chamber into a turbine outlet passage downstream of the turbine wheel chamber, the turbine outlet passage defining a flow axis which extends from a downstream end of the turbine wheel chamber; and
injecting aftertreatment fluid into exhaust gas in a diverging portion of the turbine outlet passage using a lance dosing module, the lance dosing module comprising a conduit which projects into the turbine outlet passage.

The lance dosing module may inject aftertreatment fluid in a generally downstream direction with respect to the flow axis. The conduit may extend at least partway along the flow axis. The outlet of the lance dosing module may be coaxial with the flow axis. The turbine dosing system may further comprise a turbine wheel, contained by the turbine wheel chamber, the turbine wheel being supported for rotation about a turbine wheel axis, the turbine wheel comprising an exducer defining an exducer diameter; and wherein
the outlet of the lance dosing module may be located within around 5 exducer diameters, along the flow axis, downstream of the downstream end of the turbine wheel.

According to a sixteenth aspect of the invention there is provided a diffuser for a turbine dosing system, the diffuser comprising:
an inlet configured to receive a turbine bulk flow of exhaust gas from a turbine wheel chamber, the inlet defining an inlet axis which extends normal to a geometric centre of the inlet; and
an outlet in fluid communication with the inlet, the outlet being located downstream of the inlet and having a larger cross-sectional area than the inlet, the outlet defining an outlet axis which extends normal to a geometric centre of the outlet; and
a structure which extends between the inlet and the outlet and defines at least part of a turbine outlet passage, the structure comprising a dosing module mount configured to receive a dosing module, the dosing module mount defining an opening in fluid communication with the at least part of the turbine outlet passage, the dosing module mount further defining a dosing module mount axis; and
wherein the inlet axis and the outlet axis are offset from one another.

The diffuser refers to a component, or part of a component, which incorporates a diverging portion (i.e. a region in which the cross sectional area increases from one part to another). The diffuser may be a standalone component, or may form part of another component. For example, the diffuser may be formed as part of a monoblock turbine housing or a connection adapter. Alternatively, the diffuser may form part of a downstream conduit.

The inlet may be a circular inlet. Alternatively, the inlet may have a different geometry. A cross sectional area defined by the inlet is provided in a plane through which the inlet axis extends.

The outlet may be a circular outlet. Alternatively, the outlet may have another geometry. The outlet may be defined at a point in the diffuser where the cross sectional area ceases to increase and instead becomes constant. This may be at an outer end of the component which defines the diffuser, or may be part way along said component (e.g. where the component also incorporates a constant cross sectional area section [to name one example]).

The structure may comprise a wall. The structure may form part of a turbine housing, connection adapter or downstream conduit. The structure may define an entirety of a turbine outlet passage (e.g. extend from a downstream end of a turbine wheel chamber). Alternatively, the structure may only define part of a turbine outlet passage (e.g. the turbine outlet passage may extend upstream and/or downstream of the at least a part of a turbine outlet passage defined by the structure). The at least part of the turbine outlet passage may have a cross sectional area which increases continuously between the inlet and the outlet. For example, a cross sectional area may increase linearly (e.g. in the case of a conical diffuser) or non-linearly (e.g. where an outer geometry of the turbine outlet passage is at least partly arcuate). Alternatively, a portion of the at least part of a turbine outlet passage may have a constant cross sectional area (e.g. may not increase in cross sectional area).

In preferred embodiments, the dosing module mount is located in portion of the structure which is offset from the inlet. The dosing module mount is preferably located in a pocket, defined by the structure, whereby a change of direction and/or offset of the turbine outlet passage, relative to the inlet, defines the pocket.

The inlet axis and outlet axis being offset from one another is intended to mean that the inlet axis and the outlet axis are not coaxial with one another. For example, the inlet axis and the outlet axis may be offset from one another and parallel to one another where the inlet and outlet are concentrically offset. Alternatively, or in combination, the inlet axis and the outlet axis may be offset by an angle, or said to be angularly offset, where the diffuser incorporates a change of direction.

Advantageously, providing the offset inlet axis and outlet axis defines a pocket in the structure in which the dosing module mount can be located. This advantageously reduces the package size of a turbine dosing system which incorporates the diffuser, by allowing the dosing module mount to be placed closer to an inlet and/or outlet of the diffuser. Furthermore, because of the nature of the diffuser, whereby a turbine bulk flow of exhaust gas is slowing down and is urged towards the outside of the turbine outlet passage, the turbine bulk flow also provides an injector tip cleaning functionality for a dosing module received in the dosing module mount. There is also a reduced risk of deposit build-up, from aftertreatment fluid injected by the dosing module, because of the offset nature of the inlet and outlet axis.

The term “turbine outlet passage” encompasses any flowpath configured to receive exhaust gas that has passed through a turbine wheel at a position downstream, preferably immediately downstream, of a turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis).

The term “dosing module mount” encompasses a structure which is configured to align, and support, a dosing module. The dosing module mount may be integrally formed with the structure, which at least partly defines the turbine outlet passage, or may be attached to the structure by a joining process such as, for example, welding or brazing. Given that the dosing module mount is configured to receive a dosing module, it will be appreciated that the position of the dosing module mount, e.g. the opening thereof, is indicative of the position of the dosing module once received therein. The dosing module mount position therefore defines the location of the dosing module and the aftertreatment fluid injection (e.g. a primary impingement zone as defined by a spray cone of the dosing module) in the assembled dosing system.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

The inlet axis and the outlet axis may be substantially parallel to one another.

The inlet axis and outlet axis being substantially parallel to one another may otherwise be described as the outlet being concentrically offset from the inlet. This is in contrast to arrangements whereby an angular offset is provided between the inlet axis and outlet axis (i.e. where there is a change of direction of the diffuser).

Advantageously, the inlet axis and outlet axis being substantially parallel to one another (as well as being offset from one another) defines a pocket (i.e. a recessed portion) in which a dosing module may be located. This can reduce the risk of deposit build-up and provides desirable mixing characteristics as the turbine bulk flow expands through the diffuser (and through the pocket).

Where the inlet axis and the outlet axis are substantially parallel to one another, the dosing module mount axis may be substantially parallel to, or coaxial with, the outlet axis. Furthermore, this can be achieved whilst the dosing module mount is provided relatively close to the inlet of the diffuser (promoting a compact turbine dosing system).

An angular offset may be provided between the inlet axis and the outlet axis.

An angular offset provided between the inlet axis and the outlet axis is intended to mean that the inlet axis and the outlet axis are not parallel to one another. Put another way, there is a change of direction of the diffuser. The diffuser may extend in a generally arcuate manner or may instead extend in a generally linear manner (but still incorporating a change of direction i.e. an elbow having an angle of 45°).

Providing an angular offset between the inlet axis and the outlet axis gives rise to greater flexibility for incorporating the diffuser in the turbine dosing system. For example, it may be desirable that the diffuser incorporate a change of direction for reasons packaging/volume considerations.

The dosing module mount axis may be angularly offset from the outlet axis by at least around 35°.

The dosing module mount axis being angularly offset from the outlet axis by at least around 35° is intended to mean that a cone, which extends around the outlet axis at an angle of at least around 35°, is passed through by the dosing module mount axis.

The dosing module mount axis may be substantially coaxial with the outlet axis.

The dosing module mount axis being substantially coaxial with the outlet axis is intended to mean that the dosing module mount axis substantially overlies the outlet axis. Described another way, the outlet (of the diffuser) may be said to extend around the dosing module mount axis. This may otherwise be described as pseudo-centreline dosing in which aftertreatment fluid is injected substantially along the outlet axis. An offset of the diffuser facilitates such an alignment, which may otherwise not be possible in a conventional diffuser (i.e. where the entire diffuser extends around an axis which is coaxial with a turbine wheel axis).

The dosing module mount axis may point in a generally upstream direction (i.e. towards the inlet) or in a generally downstream direction (i.e. towards the outlet). Alternatively, the dosing module mount axis may extend across the diffuser (as opposed to along it).

Advantageously, pseudo-centreline dosing gives rise to a reduced package size of the turbine dosing system. As the turbine bulk flow passes through the diffuser and expands, desirable mixing of aftertreatment fluid in the exhaust gas flow is also promoted. Advantageously, an outlet of the dosing module may also be cleaned as the turbine bulk flow hugs the walls of the diffuser (i.e. as the flow expands). Impingement of the aftertreatment fluid on internal walls of the diffuser is also reduced in this arrangement.

The dosing module mount may be angled in a generally downstream direction.

The dosing module mount being angled in a generally downstream direction may otherwise be described as the dosing module mount pointing towards the outlet of the diffuser. Described another way, the dosing module mount extends in the same direction as the turbine bulk flow travels in.

The dosing module mount being angled in a generally downstream direction has been found to advantageously facilitate the dispersal of aftertreatment fluid in the turbine bulk flow of exhaust gas.

Where the dosing module, and so dosing module mount (and axis), points in a generally downstream direction, the risk of deposit build-up occurring in the diffuser is greatly reduced (owing to the reduced, or eliminated, direct impingement of a spray cone on an internal surface of structure). Fewer, if any, features to deal with ‘wall wetting’ (i.e. the presence of aftertreatment fluid on an internal surface of the structure) are needed. Owing to improved dispersal of the aftertreatment fluid in the turbine bulk flow, the need for further mixing features may be eliminated (reducing the backpressure of the system).

In other embodiments the dosing module mount may extend in a generally upstream direction (i.e. pointing towards the inlet of the diffuser).

The structure may comprise one or more vortex generator fins, which extend into the at least part of the turbine outlet passage, upstream of the dosing module mount.

Vortex generator fins are projections which reduce the risk of flow separation. The vortex generator fins may otherwise be described as vanes. In preferred embodiments, a plurality of vortex generator fins may be provided. The plurality of vortex generator fins preferably form an array of vortex generator fins. In preferred arrangements, at least two, and preferably four, vortex generator fins may be provided.

In preferred arrangements, the one or more vortex generator fins are provided around a circumferential extent of the diffuser which is occupied by the dosing module mount. Put another way, it is desirable that the vortex generator fins extend around the diffuser by at least as far as the dosing module mount does. This reduces the risk of flow separation occurring in a region extending beyond the vortex generator fins, which may otherwise affect the dispersal of the aftertreatment fluid in the turbine bulk flow.

Advantageously, the vortex generator fins reduce the risk of flow separation occurring in the turbine bulk flow owing to the presence of the dosing module mount. Put another way, by providing the vortex generator fins upstream of the dosing module mount the risk of the turbine bulk flow separating proximate the dosing module mount is reduced. Flow separation risks the onset of flow recirculation, which may also lead to the build-up of aftertreatment fluid at an outlet of the dosing module. Incorporation of the one or more vortex generator fins therefore advantageously reduces, or eliminates, the onset of flow separation proximate the dosing module mount, which is desirable because flow recirculation and/or stagnation proximate the dosing module can lead to deposit build-up at the outlet of the dosing module and the build-up of deposits on internal surfaces within the diffuser.

According to a seventeenth aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage defining a flow axis which extends from a downstream end of the turbine wheel; and
a dosing module configured to inject aftertreatment fluid into exhaust gas in the turbine outlet passage;
wherein the turbine outlet passage comprises a diverging portion, the diverging portion comprising an inlet and an outlet, the inlet defining an inlet axis which extends normal to a geometric centre of the inlet, the outlet defining an outlet axis which extends normal to a geometric centre of the outlet; and
wherein the inlet axis and the outlet axis are offset from one another.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “exducer” refers to the portion of the turbine wheel which discharges exhaust gas. Described another way, the term “exducer” encompasses the part of the turbine wheel which functions as the outlet of the turbine wheel (i.e. the distal end of the turbine wheel from the perspective of the turbine bulk flow travelling therethrough). The exducer diameter refers to a diameter of the turbine wheel at a downstream-most point of the blades. Described another way, the term “exducer diameter” encompasses the diameter of the exducer, at the most distal part of the turbine wheel from the perspective of the turbine bulk flow. The turbine wheel may further comprise an inducer, through which exhaust gas enters the turbine wheel.

The turbine wheel may be a radial turbine wheel comprising an inducer and an exducer. A radial turbine wheel may be configured to receive incident exhaust gas (at the inducer thereof) in a radial direction in relation to the turbine wheel axis. The “exducer” is not intended to refer to features of the turbine wheel which do not act to discharge exhaust gas into the turbine outlet passage (e.g. wheel nuts, aftertreatment dosing cups or the like). The turbine wheel may be a cupless turbine wheel (e.g. where the wheel hub does not having a dosing cup, into which aftertreatment fluid is injected, which atomises the aftertreatment fluid before it is dispersed into the exhaust gas). A turbine wheel incorporating such a cup may be referred to as a radial slinging atomiser, a radial atomiser, a centrifugal atomiser or a rotating atomiser.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with the turbine wheel axis. The flow axis may extend from the turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The turbine outlet passage may be described as being at least partly defined by a structure. The structure may comprise a turbine housing, connection adapter or conduit. A turbine housing may thus comprise a dosing module mount. A connection adapter may comprise a dosing module mount. Alternatively, a conduit may comprise a dosing module mount. The dosing module may thus be mounted to a turbine housing, connection adapter or conduit.

The term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

According to an eighteenth aspect of the invention there is provided a conduit for an engine system, the conduit comprising:
an inlet configured to receive a fluid;
an outlet in fluid communication with the inlet, the outlet being located downstream of the inlet; and
a wall which extends between the inlet and the outlet and defines at least part of a fluid passage, the at least part of a fluid passage comprising a recessed portion or a bend;
wherein one or more vortex generator fins, which extend into the at least part of the fluid passage, are provided upstream of the recessed portion or the bend of the at least part of a fluid passage.

The conduit may be a pipe. The conduit may define part of a turbine outlet passage. The engine system may be an engine exhaust system, which may include one or more aftertreatment devices. The engine system may be a turbine dosing system. The conduit may comprise a diffuser. The conduit may define a diffuser of a turbine. The conduit may be elongate. The conduit may be linear.

The fluid which is received by the inlet may be exhaust gas. The fluid received by the inlet may be described as a turbine bulk flow of exhaust gas. The inlet may be provided in fluid communication with a turbine.

The recessed portion of the at least part of a fluid passage may be described as a pocket. The recessed portion may be defined just downstream of a point whereby the at least part of a fluid passage increases in cross section and/or changes direction. Put another way, the recessed portion may be defined by an offset diffuser. The recessed portion may otherwise be described as an undercut (i.e. a volume whereby the fluid passing through the fluid passage expands into). The recessed portion may be broadly described as a region prone to flow separation (e.g. a zone in which flow recirculation may occur). A dosing module mount may be located in the pocket (e.g. recessed portion). Where the fluid passage comprises both a recessed portion and a bend, it may be desirable to provide the one or more fins upstream of the most upstream of the recessed portion and the bend. It may otherwise be desirable to place one or more fins upstream of each of the recessed portion and the bend (i.e. at least one fin upstream of each region prone to flow separation).

Advantageously, the one or more vortex generator fins reduce the risk of fluid separating from the wall (specifically an internal surface thereof) as a result of the recessed portion. Described another way, the presence of the recessed portion increases the risk that flow separation occurs, which can lead to a recirculation zone which is undesirable for a variety of reasons. Incorporation of the one or more vortex generator fins reduces the risk of flow separation occurring, and therefore reduces the risk of a recirculation zone being present because of the recessed portion. The vortex fins assist the flow in remaining attached to the interior surface of the wall.

Whilst the one or more vortex generator fins provides this advantageous functionality in any conduit, they have been found to be particularly advantageous when incorporated as part of a turbine dosing system. In particular, where a dosing module is provided just upstream of, or at, the recessed portion, flow separation may lead to an increased risk of a stagnant volume of fluid (a turbine bulk flow of exhaust gas) within the recessed portion. This may, in turn, lead to a stagnant zone of suspended aftertreatment fluid in the turbine bulk flow which risks the blockage of the dosing module.

Save for the one or more vortex generator fins, the at least part of a fluid passage is preferably substantially unobstructed. That is to say, the at least part of a fluid passage preferably does not comprise any components which project into the passage. For example, there is preferably no mixer or other component which extends across the fluid passage. Instead, the fluid passage is preferably defined by a smooth, substantially continuous wall save for the one or more vortex generator fins which extend therefrom.

The one or more vortex generator fins preferably extend from an internal surface of the wall.

According to a nineteenth aspect of the invention there is provided a method of operating a diffuser for a turbine dosing system, comprising:
receiving a turbine bulk flow of exhaust gas from a turbine wheel chamber into an inlet, the inlet defining an inlet axis extending normal to a geometric centre of the inlet;
receiving the exhaust gas from the inlet into an outlet in fluid communication with the inlet, the outlet being located downstream of the inlet and having a larger cross-sectional area than the inlet, the outlet defining an outlet axis which extends normal to a geometric centre of the outlet; and
a structure which extends between the inlet and the outlet and defines at least part of a turbine outlet passage, the structure comprising a dosing module mount configured to receive a dosing module, the dosing module mount defining an opening in fluid communication with the at least part of the turbine outlet passage, the dosing module mount further defining a dosing module mount axis; and
wherein the inlet axis and the outlet axis are offset from one another.

The inlet axis and the outlet axis may be substantially parallel to one another. An angular offset may be provided between the inlet axis and the outlet axis. The dosing module mount axis may be angularly offset from the outlet axis by at least around 35°. The dosing module mount axis may be substantially coaxial with the outlet axis. The dosing module mount may be angled in a generally downstream direction. The structure may comprise one or more vortex generator fins, which extend into the at least part of the turbine outlet passage, upstream of the dosing module mount.

According to a twentieth aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation about a turbine wheel axis, the turbine wheel comprising an exducer defining an exducer diameter;
receiving exhaust gas from the turbine wheel chamber into a turbine outlet passage downstream of the turbine wheel chamber, the turbine outlet passage defining a flow axis which extends from a downstream end of the turbine wheel; and
injecting aftertreatment fluid into exhaust gas in the turbine outlet passage using a dosing module;
wherein the turbine outlet passage comprises a diverging portion, the diverging portion comprising an inlet and an outlet, the inlet defining an inlet axis which extends normal to a geometric centre of the inlet, the outlet defining an outlet axis which extends normal to a geometric centre of the outlet; and
wherein the inlet axis and the outlet axis are offset from one another.

According to a twenty-first aspect of the invention there is provided a method of using a conduit for an engine system, comprising:
receiving a fluid into an inlet;
receiving the fluid from the inlet into an outlet in fluid communication with the inlet, the outlet being located downstream of the inlet; wherein
a wall which extends between the inlet and the outlet defines at least part of a fluid passage, the at least part of a fluid passage comprising a recessed portion or a bend; and
wherein one or more vortex generator fins, which extend into the at least part of the fluid passage, are provided upstream of the recessed portion or the bend of the at least part of a fluid passage.

According to a twenty-second aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber configured to contain a turbine wheel;
a turbine outlet passage downstream of the turbine wheel chamber and configured to receive exhaust gas from the turbine wheel chamber, the turbine outlet passage defining a flow axis which extends from a downstream end of the turbine wheel chamber; and
a dosing module configured to inject aftertreatment fluid into exhaust gas in the turbine outlet passage, the dosing module defining a dosing module axis;
wherein the dosing module axis is substantially orthogonal to the flow axis.

The dosing module axis being substantially orthogonal to the flow axis is intended to mean that the dosing module axis may be offset by up to around 5° relative to a precisely orthogonal relationship to the flow axis (e.g. it may be inclined in an upstream or downstream direction). Put another way, the dosing module axis may be offset by up to around 5° in any direction.

The turbine wheel chamber may contain a turbine wheel. The turbine wheel may be supported for rotation about a turbine wheel axis. The turbine wheel may comprise an exducer defining an exducer diameter. The flow axis preferably extends from a downstream end of the turbine wheel.

Providing the dosing module axis substantially orthogonal to the flow axis is advantageous because the aftertreatment fluid is injected across a wider range of the turbine outlet passage. Furthermore, this can facilitate the use of high turbulent kinetic energy (TKE) zones, as well as high wall shear/high velocity zones (i.e. aftertreatment fluid can be advantageously injected into these zones). Furthermore, it has been found that incorporation of a dosing module mount (to which the dosing module can be mounted) can be readily carried out.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with a turbine wheel axis. The flow axis may extend from a turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The turbine outlet passage may be described as being at least partly defined by a structure. The structure may comprise a turbine housing, connection adapter or conduit. A turbine housing may thus comprise the dosing module mount. A connection adapter may comprise the dosing module mount. Alternatively, a conduit may comprise the dosing module mount. The dosing module may thus be mounted to a turbine housing, connection adapter or conduit.

The term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

According to a twenty-third aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber configured to contain a turbine wheel;
receiving exhaust gas from the turbine wheel chamber into a turbine outlet passage downstream of the turbine wheel chamber, the turbine outlet passage defining a flow axis which extends from a downstream end of the turbine wheel chamber; and
injecting aftertreatment fluid into exhaust gas in the turbine outlet passage using a dosing module, the dosing module defining a dosing module axis;
wherein the dosing module axis is substantially orthogonal to the flow axis.

According to a twenty-fourth aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation in a first direction about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage defining a flow axis which extends from a downstream end of the turbine wheel; and
a dosing module configured to inject aftertreatment fluid into exhaust gas in the turbine outlet passage, the dosing module defining a dosing module axis;
wherein the dosing module is positioned to inject aftertreatment fluid in, or against, a nominal swirl direction of the exhaust gas, the nominal swirl direction of the exhaust gas being defined by the first direction about which the turbine wheel is rotatable.

The first direction may be described as a clockwise direction, or an anticlockwise direction, when viewing a downstream end of the turbine wheel. The first direction refers to a direction about which the turbine wheel rotates in operation (i.e. a standard operating direction of rotation). Put another way, the first direction is the direction in which the turbine wheel rotates as exhaust gas is expanded thereacross. The turbine wheel comprises a plurality of blades. The blades each comprise a concave side. The concave side of the blades is configured to ‘catch’ the exhaust gas flow as it exits the turbine inlet passage. Gas pressure therefore urges against the concave side of the blades, to drive rotation of the turbine wheel.

The dosing module being positioned to inject aftertreatment into, or against, a nominal swirl direction may otherwise be described as the dosing module being located, or angled, to inject aftertreatment fluid into, or against, the nominal swirl direction. The dosing module being positioned to inject aftertreatment fluid into, or against, a nominal swirl direction of the exhaust gas effectively means that the dosing module axis is not coincident with either of a radius (of the turbine outlet passage) or the flow axis. Put another way, the dosing module is angled off centre and/or positioned off centre from the flow axis.

The nominal swirl direction of exhaust gas refers to a direction in which the exhaust gas generally rotates once it has been expanded across the turbine wheel and has passed downstream of the downstream end of the turbine wheel and into the turbine outlet passage. The nominal swirl direction being defined by the first direction about which the turbine wheel is rotatable may otherwise be described as the nominal swirl direction being the same as the first direction in which the turbine wheel rotates in use.

Where the dosing module injects aftertreatment fluid against a nominal swirl direction of the exhaust gas, the relative velocity between the aftertreatment fluid and the exhaust gas is comparatively higher. Convective heat transfer to aftertreatment fluid droplets is therefore increased, which increases the decomposition of the aftertreatment fluid. The drag on the droplets is also increased, which decreases the spray penetration. The increased convective heat transfer in turn improves the uniformity index of the aftertreatment fluid dispersal within the exhaust gas flow, due to subsequent gas mixing and diffusion (which also occurs with less mechanical work to the flow than mixing a liquid with the gas). The increased drag on droplets aids in the reduction of impingement of the reductant of a structure which defines the turbine outlet passage, and so a reduction in reductant deposits. The deposits are undesirable because they can lead to an increased back pressure of the system and/or require regenerations, which increase fuel consumption of the engine system.

Spray penetration is defined by the distance a droplet moves through a gaseous volume before it changes direction or impinges upon a structure. The maximum penetration distance may be the diameter of the turbine outlet passage at a plane through an outlet of the dosing module (e.g. around 90 mm). Spray penetration is affected by the momentum exchange between the droplet and the exhaust gas. When the spray is against the flow (e.g. against the nominal swirl direction), the drag on the droplet(s) acts as gas momentum in a direction generally opposite to the spray momentum, thus ‘pushing back’ on the spray droplet(s). This decreases the penetration of the spray.

A further benefit of injecting the aftertreatment fluid against the nominal swirl direction of the exhaust gas is that the dosing module is located closer to the turbine wheel which, in turn, means a corresponding catalyst can also be located closer to the turbine wheel (and so closer to the internal combustion engine and dosing module).

When the dosing module is positioned to inject aftertreatment fluid in a nominal swirl direction of exhaust gas, advantageously there is a reduced risk of deposit build-up at an outlet of the dosing module. Furthermore, the aftertreatment fluid is more likely to be imparted into a high flow region towards a radially outer edge of the turbine outlet passage. This reduces the amount of aftertreatment fluid suspended in any potential recirculation zones, at least within the turbine outlet passage.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “exducer” refers to the portion of the turbine wheel which discharges exhaust gas. Described another way, the term “exducer” encompasses the part of the turbine wheel which functions as the outlet of the turbine wheel (i.e. the distal end of the turbine wheel from the perspective of the turbine bulk flow travelling therethrough). The exducer diameter refers to a diameter of the turbine wheel at a downstream-most point of the blades. Described another way, the term “exducer diameter” encompasses the diameter of the exducer, at the most distal part of the turbine wheel from the perspective of the turbine bulk flow. The turbine wheel may further comprise an inducer, through which exhaust gas enters the turbine wheel.

The turbine wheel may be a radial turbine wheel comprising an inducer and an exducer. A radial turbine wheel may be configured to receive incident exhaust gas (at the inducer thereof) in a radial direction in relation to the turbine wheel axis. The “exducer” is not intended to refer to features of the turbine wheel which do not act to discharge exhaust gas into the turbine outlet passage (e.g. wheel nuts, aftertreatment dosing cups or the like). The turbine wheel may be a cupless turbine wheel (e.g. where the wheel hub does not having a dosing cup, into which aftertreatment fluid is injected, which atomises the aftertreatment fluid before it is dispersed into the exhaust gas). A turbine wheel incorporating such a cup may be referred to as a radial slinging atomiser, a radial atomiser, a centrifugal atomiser or a rotating atomiser.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with the turbine wheel axis. The flow axis may extend from the turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The turbine outlet passage may be described as being at least partly defined by a structure. The structure may comprise a turbine housing, connection adapter or conduit. A turbine housing may thus comprise a dosing module mount. A connection adapter may comprise a dosing module mount. Alternatively, a conduit may comprise a dosing module mount. The dosing module may thus be mounted to a turbine housing, connection adapter or conduit.

The term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

The turbine outlet passage is preferably substantially unobstructed at least along a primary impingement zone defined by the dosing module, and preferably along an entirety of the turbine outlet passage. That is to say, the turbine outlet passage preferably does not comprise any components which project into the passage. For example, there is preferably no mixer or other component which extends across the turbine outlet passage. Instead, the turbine outlet passage is preferably defined by a smooth, substantially continuous wall.

The dosing module is preferably located upstream of any aftertreatment components (e.g. SCR, DOC etc.).

The dosing module may be mounted to a dosing module mount. A monoblock turbine housing, turbine housing, connection adapter or conduit may comprise the dosing module mount.

The dosing module may be located within around 10 exducer diameters, around 7 exducer diameters, around 5 exducer diameters, and around 3 exducer diameters downstream of the downstream end of the turbine wheel. The dosing module may be located at least around 1 exducer diameter downstream of the downstream end of the turbine wheel. The dosing module is preferably located between around 1 exducer diameter, and around 3 exducer diameters, downstream of the downstream end of the turbine wheel. The dosing module may be located at a diverging portion of the turbine outlet passage. The diverging portion of the turbine outlet passage may define a diffuser of a turbine.

The dosing module axis may be substantially perpendicular to a radius of the turbine outlet passage.

The dosing module axis being substantially perpendicular to a radius of the turbine outlet passage is intended to mean that the dosing module axis is provided within 30° of perpendicular to a radius of the turbine outlet passage. The 30° angle range may lie in a plane taken normal to the flow axis. Alternatively, or in combination, the 30° angle range may include the dosing module being inclined (i.e. pointed) in an upstream or downstream direction with respect to the flow axis.

As mentioned above, because the dosing module is positioned to inject aftertreatment fluid into, or against, a nominal swirl direction of the exhaust gas, the substantially perpendicular alignment of the dosing module axis to a radius of the turbine outlet passage is still intended to exclude a purely radial alignment of the dosing module axis (i.e. where aftertreatment fluid is injected along a radius and across the flow axis).

Advantageously, by providing the dosing module axis substantially perpendicular to a radius of the turbine outlet passage the aftertreatment fluid can be injected directly into an almost purely tangential flow field. That is to say, the greatest relative velocities between the aftertreatment fluid and the exhaust gas may be experienced.

The dosing module may be positioned within around 10 exducer diameters downstream of a downstream end of the turbine wheel.

The dosing module being positioned within around 10 exducer diameters downstream of a downstream end of the turbine wheel is advantageous because within this range, along the flow axis, the swirl of the exhaust gas has been found to be comparatively high in magnitude. As such, the advantageous effects associated with injecting into, or against, the swirl direction are particularly pronounced when the dosing module is located within around 10 exducer diameters of a downstream end of the turbine wheel.

In preferred embodiments, the dosing module maybe positioned within around 5 exducer diameters, or around 3 exducer diameters, downstream of the downstream end of the turbine wheel. Advantageously, such positions give rise to the swirl being an even greater magnitude, compounding the advantageous effects obtained as a result.

In other embodiments, it may be preferable that the dosing module is positioned within a lesser of within around 10, within around 5, or within around 3 exducer diameters downstream of the downstream end of the turbine wheel, and a first bend, or change of direction, of the turbine outlet passage.

According to a twenty-fifth aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation in a first direction about a turbine wheel axis, the turbine wheel comprising an exducer defining an exducer diameter;
receiving exhaust gas from the turbine wheel chamber into a turbine outlet passage downstream of the turbine wheel chamber, the turbine outlet passage defining a flow axis which extends from a downstream end of the turbine wheel; and
injecting aftertreatment fluid into exhaust gas in the turbine outlet passage using a dosing module, the dosing module defining a dosing module axis;
wherein the dosing module is positioned to inject aftertreatment fluid in, or against, a nominal swirl direction of the exhaust gas, the nominal swirl direction of the exhaust gas being defined by the first direction about which the turbine wheel rotates.

The dosing module axis may be substantially perpendicular to a radius of the turbine outlet passage. The dosing module may be positioned within around 10 exducer diameters downstream of a downstream end of the turbine wheel.

According to a twenty-sixth aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber configured to contain a turbine wheel;
a turbine outlet passage downstream of the turbine wheel chamber and configured to receive exhaust gas from the turbine wheel chamber, the turbine outlet passage defining a flow axis which extends from a downstream end of the turbine wheel chamber, the turbine outlet passage being at least partly defined by a structure which comprises a dosing module mount configured to receive a dosing module, the structure defining an interior surface; and
a dosing module mounted to the dosing module mount and configured to inject aftertreatment fluid into exhaust gas in the turbine outlet passage, the dosing module comprising an outlet defined in an outer end of the dosing module;
wherein the outer end of the dosing module is substantially flush with the surrounding interior surface; and
wherein the interior surface of the structure and the outer end of the dosing module define a substantially uninterrupted passage surface along at least an extent of the flow axis occupied by the dosing module mount.

It may specifically be the interior surface of the structure which defines, or bounds, at least part of the turbine outlet passage. The interior surface may be described as an internal wall surface.

The outlet of the dosing module may be defined in a nozzle of the dosing module. A nozzle of the dosing module may define the outer end of the dosing module in which the outlet is provided.

The outer end of the dosing module being substantially flush with the surrounding interior surface is intended to mean that there is less than around 2 mm offset between the two surfaces. Put another way, the two surfaces are sufficiently closely aligned that it is only a small tolerance offset which separates them. The outer end of the dosing module may project beyond the surrounding interior surface by up to around 2 mm, or may be recessed by up to around 2 mm relative to the surrounding interior surface.

The passage surface refers to a surface defined by a combination of the interior surface of the structure and the outer end of the dosing module. Described another way, the passage surface may refer to a surface which bounds at least part of the turbine outlet passage (at least proximate the dosing module outlet). The passage surface being substantially uninterrupted is intended to mean that the passage surface does not incorporate any features which are liable to give rise to a significant recirculation zone. For example, there is no projecting ledge, or doghouse, to which the dosing module is mounted. Similarly, there are no significant undercut surfaces or other features which could otherwise give rise to recirculation zones.

The substantially uninterrupted passage surface is intended to encompass a completely smooth passage surface. The substantially uninterrupted passage surface is also intended to encompass surfaces which incorporate small interruptions, of the order of within around 2 mm in extent. However, the substantially uninterrupted passage surface is intended to exclude embodiments which, for example, incorporate a significant projecting ledge which defines a recirculation zone.

The substantially uninterrupted passage surface along at least an extent of the flow axis occupied by the dosing module mount may otherwise be described as the passage surface being substantially uninterrupted along at least an axial length of the dosing module mount. Put another way, if the dosing module mount extends along a first extent of the flow axis (i.e. in a length dimension) then the passage surface is substantially uninterrupted for at least that same length. It will be appreciated that the uninterrupted passage surface may extend beyond this length either in upstream and/or downstream directions.

The turbine wheel chamber may contain a turbine wheel. The turbine wheel may be supported for rotation about a turbine wheel axis. The turbine wheel may comprise an exducer defining an exducer diameter. The flow axis preferably extends from a downstream end of the turbine wheel.

Advantageously, by eliminating the projecting ledge feature (as an example), and instead providing a dosing module with an outer end substantially flush with the surrounding interior surface, and defining a substantially uninterrupted passage surface along at least an extent of the dosing module mount, the risk of deposit build-up is reduced. Furthermore, where the exhaust gas flow has a tendency to be relatively fast moving towards the outer edges of the turbine outlet passage, this fast moving flow is also able to pass closely past the outlet of the dosing module, facilitating tip cleaning at the outlet of the dosing module. Recirculation zones, which are associated with features such as a projecting ledge (i.e. doghouse), may otherwise lead to undesirable recirculation zones, near the outlet of the dosing module, which risks blockage at the outlet of the dosing module due to deposit build-up. The elimination, or reduction, of such recirculation zones is therefore desirable.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with the turbine wheel axis. The flow axis may extend from the turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The structure may comprise a turbine housing, connection adapter or conduit. A turbine housing may thus comprise a dosing module mount. A connection adapter may comprise a dosing module mount. Alternatively, a conduit may comprise a dosing module mount. The dosing module may thus be mounted to a turbine housing, connection adapter or conduit.

The term “dosing module mount” encompasses a structure which is configured to align, and support, a dosing module. The dosing module mount may be integrally formed with the structure, which at least partly defines the turbine outlet passage, or may be attached to the structure by a joining process such as, for example, welding or brazing. Given that the dosing module mount is configured to receive a dosing module, it will be appreciated that the position of the dosing module mount, e.g. the opening thereof, is indicative of the position of the dosing module once received therein. The dosing module mount position therefore defines the location of the dosing module and the aftertreatment fluid injection (e.g. a primary impingement zone as defined by a spray cone of the dosing module) in the assembled dosing system. The primary impingement zone is preferably entirely downstream of the turbine wheel chamber. The primary impingement zone is preferably located entirely within the turbine outlet passage.

The term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

The structure may comprise a diffuser, and the dosing module mount may form part of the diffuser.

Advantageously, providing a dosing module mount as part of a diffuser means that the advantages associated with the diffusing exhaust gas, resulting from a diffuser geometry, can still be obtained whilst avoiding the risk of recirculation zones being defined proximate the dosing module mount.

According to a twenty-seventh aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber configured to contain a turbine wheel;
receive exhaust gas from the turbine wheel chamber into a turbine outlet passage downstream of the turbine wheel chamber, the turbine outlet passage defining a flow axis which extends from a downstream end of the turbine wheel chamber, the turbine outlet passage being at least partly defined by a structure which comprises a dosing module mount configured to receive a dosing module, the structure defining an interior surface; and
injecting aftertreatment fluid into exhaust gas in the turbine outlet passage using a dosing module mounted to the dosing module mount, the dosing module comprising an outlet defined in an outer end of the dosing module;
wherein the outer end of the dosing module is substantially flush with the surrounding interior surface; and
wherein the interior surface of the structure and the outer end of the dosing module define a substantially uninterrupted passage surface along at least an extent of the flow axis occupied by the dosing module mount.

The structure may comprise a diffuser, and the dosing module mount may form part of the diffuser.

According to a twenty-eighth aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage defining a flow axis which extends from a downstream end of the turbine wheel; and
a plurality of dosing modules configured to inject aftertreatment fluid into exhaust gas in the turbine outlet passage.

The plurality of dosing modules may comprise a pair of dosing modules. The plurality of dosing modules may consist of a pair of dosing modules. The plurality of dosing modules may be, in use, activated simultaneously to inject aftertreatment fluid into exhaust gas in the turbine outlet passage in two different locations (i.e. one for each dosing module). Alternatively, the dosing modules may be activated individually such that only one dosing module injects aftertreatment fluid into exhaust gas in the turbine outlet passage at any one time. Further alternatively, the plurality of dosing modules may be operable across a combination of simultaneous and individual dosing regimes (e.g. in a hybrid regime). For example, in some operating conditions all of the plurality of dosing modules may be activated, and in other operating conditions only some of the plurality of dosing modules may be activated.

Each of the dosing modules may be mounted to a structure which defines the turbine outlet passage via a dosing module mount. The dosing module mount may therefore form part of the structure. The structure may be one or more of a turbine housing, connection adapter or downstream conduit. Each of the plurality of the dosing modules may be mounted to the same component (e.g. each of the plurality of dosing modules may be mounted to the turbine housing, connection adapter or downstream conduit where appropriate). Alternatively, the dosing modules may be mounted to different structural components which define the turbine outlet passage.

Each of the dosing modules may be mounted at the same axial position along the flow axis. Described another way, each of the plurality of dosing modules may lie in the same plane. Alternatively, each, or some, of the plurality of dosing modules may be offset from one another such that one or more of the dosing modules lies at a different axial position. Described another way, one or more dosing modules may be located upstream, or downstream, of one or more other dosing modules.

The dosing modules may be circumferentially offset from one another such that they occupy different points around a circumference of the flow axis.

Advantageously, incorporation of a plurality of dosing modules facilitates the improved tuning of aftertreatment fluid injection based upon flow conditions of the exhaust gas for that engine operating point or condition. For example, where a greater amount of aftertreatment fluid is required, each of the plurality of dosing modules may be activated so as to simultaneously inject aftertreatment fluid into exhaust gas in the turbine outlet passage. This provides that a greater amount, or dosage, of aftertreatment is injected into the exhaust gas.

Furthermore, the incorporation of the plurality of dosing modules also means that the dosing modules can be selectively activated, which is of particular interest when they are at different positions along either the flow axis or around the flow axis, depending on the flow conditions. For example, it may be desirable to inject aftertreatment fluid against, or into, a swirl direction of the exhaust gas flow. The swirl direction may differ depending on the engine operating point and, for example, mass flow rate of exhaust gas. The plurality of dosing modules could therefore be located in a generally opposing manner such that, in use, at least one dosing module is always pointed towards a (nominal) swirl direction of the flow, irrespective of whether that swirl direction is clockwise or counter clockwise for that flow axis.

The plurality of dosing modules may be mounted in a series, parallel or hybrid arrangement.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “exducer” refers to the portion of the turbine wheel which discharges exhaust gas. Described another way, the term “exducer” encompasses the part of the turbine wheel which functions as the outlet of the turbine wheel (i.e. the distal end of the turbine wheel from the perspective of the turbine bulk flow travelling therethrough). The exducer diameter refers to a diameter of the turbine wheel at a downstream-most point of the blades. Described another way, the term “exducer diameter” encompasses the diameter of the exducer, at the most distal part of the turbine wheel from the perspective of the turbine bulk flow. The turbine wheel may further comprise an inducer, through which exhaust gas enters the turbine wheel.

The turbine wheel may be a radial turbine wheel comprising an inducer and an exducer. A radial turbine wheel may be configured to receive incident exhaust gas (at the inducer thereof) in a radial direction in relation to the turbine wheel axis. The “exducer” is not intended to refer to features of the turbine wheel which do not act to discharge exhaust gas into the turbine outlet passage (e.g. wheel nuts, aftertreatment dosing cups or the like). The turbine wheel may be a cupless turbine wheel (e.g. where the wheel hub does not having a dosing cup, into which aftertreatment fluid is injected, which atomises the aftertreatment fluid before it is dispersed into the exhaust gas). A turbine wheel incorporating such a cup may be referred to as a radial slinging atomiser, a radial atomiser, a centrifugal atomiser or a rotating atomiser.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with the turbine wheel axis. The flow axis may extend from the turbine wheel axis.

The term “turbine outlet passage” encompasses any flowpath configured to receive exhaust gas that has passed through a turbine wheel at a position downstream, preferably immediately downstream, of the turbine wheel chamber. The purpose of the turbine outlet passage is to handle and/or condition the exhaust gas flow in the region where swirl and flow velocity are highest. The term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of a turbine wheel or wheel chamber. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The turbine outlet passage may be described as being at least partly defined by a structure. The structure may comprise a turbine housing, connection adapter or conduit. A turbine housing may thus comprise a dosing module mount. A connection adapter may comprise a dosing module mount. Alternatively, a conduit may comprise a dosing module mount. The dosing module(s) may thus be mounted to a turbine housing, connection adapter or conduit.

The term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

The dosing modules are preferably located upstream of any aftertreatment components (e.g. SCR, DOC etc.).

The dosing modules may be mounted to respective dosing module mounts. A monoblock turbine housing, turbine housing, connection adapter or conduit may comprise one or more of the dosing module mounts.

One or more of the dosing modules may be located within around 10 exducer diameters, around 7 exducer diameters, around 5 exducer diameters, and around 3 exducer diameters downstream of the downstream end of the turbine wheel. The dosing module may be located at least around 1 exducer diameter downstream of the downstream end of the turbine wheel. One or more of the dosing modules are preferably located between around 1 exducer diameter, and around 3 exducer diameters, downstream of the downstream end of the turbine wheel. One or more of the dosing modules may be located at a diverging portion of the turbine outlet passage. The diverging portion of the turbine outlet passage may define a diffuser of a turbine.

Each of the dosing modules may be described as defining a respective primary impingement zone. The primary impingement zones preferably do not overlap one another. Described another way, the dosing modules may be aligned parallel, or directed away, from each other.

Where a swirl direction changes in operation (e.g. due to engine operating condition), it may be desirable that the plurality of dosing modules be selectively activated, e.g. using a controller, so as to provide greater flexibility of dosing regime (e.g. the dosing modules be activated individually, simultaneously or a hybrid arrangement). For example, a first dosing module (only) may be activated when the swirl direction is a first direction (e.g. so as to inject aftertreatment fluid either with, or against, the swirl direction). A second dosing module (only) may be activated when the swirl direction is a different, second direction (e.g. so as to inject aftertreatment fluid either with, or against, the swirl direction). Selective activation of the first and second dosing modules may thus be used to inject aftertreatment fluid either with, or against, the swirl direction, even when the swirl direction changes in use (e.g. due to engine operating condition). The swirl direction may be detected or ascertained, directly or indirectly, by a sensor, a virtual sensor, or engine operating condition.

Two or more of the plurality of dosing modules may be circumferentially offset from one another about the flow axis.

Two or more of the plurality of dosing modules being circumferentially offset from one another is intended to mean that the dosing modules are provided at different positions around the flow axis.

For example, each of the plurality of the dosing modules may be diametrically opposed to one another such that they share a common dosing module axis. One or more of the dosing modules may have a dosing module axis which is offset from a radius defined by the flow axis.

Advantageously, by circumferentially offsetting the plurality of dosing modules the modules can be activated in unison, or selectively, to provide desirable mixing characteristics of aftertreatment fluid in the exhaust gas flow.

One or more of the plurality of dosing modules may be tangentially mounted about the flow axis.

Tangentially mounted about the flow axis is intended to mean that the dosing module axes are parallel to, and offset from, a radius which is defined by the flow axis. The dosing modules may share a common dosing module axis (they may be mounted separately but pointing towards one another) or alternatively may have dosing module axes which are separate and parallel to one another. The latter arrangement may be more desirable where the dosing modules are to operate in unison, to provide a greater amount of aftertreatment fluid mixing in the exhaust gas flow. All of the plurality of dosing modules may be tangentially mounted about the flow axis.

Two or more of the plurality of dosing modules may be axially offset from one another along the flow axis.

Two or more of the plurality of dosing modules being axially offset from one another is intended to mean that two or more of the dosing modules are provided at different locations downstream of the turbine wheel For example, one dosing module may be provided proximate at the turbine wheel, and another distal the turbine wheel. Like that described above, the modules can be operated in unison (i.e. activated to inject aftertreatment fluid at the same time), selectively (i.e. such that only one operates at any one time), or in a hybrid manner.

It may be desirable to activate the dosing modules selectively depending on the engine operating condition. For example, it may be desirable to activate a proximate dosing module (only) in low exhaust gas output conditions, and to operate a distal dosing module (optionally also the proximate dosing module) during high exhaust output conditions.

According to a twenty-ninth aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage; and
a turbine outlet passage downstream of the turbine wheel chamber and configured to receive exhaust gas from the turbine wheel chamber, the turbine outlet passage being at least partly defined by a structure which comprises a plurality of dosing module mounts, each of the plurality of dosing module mounts being configured to receive a dosing module, the turbine outlet passage defining a flow axis which extends from a downstream end of the turbine wheel chamber.

The turbine wheel chamber may contain a turbine wheel. The turbine wheel may be supported for rotation about a turbine wheel axis. The turbine wheel may comprise an exducer defining an exducer diameter. The flow axis preferably extends from a downstream end of the turbine wheel.

The dosing module mounts are preferably located upstream of any aftertreatment components (e.g. SCR, DOC etc.).

A monoblock turbine housing, turbine housing, connection adapter or conduit may comprise one or more of the dosing module mounts.

One or more of the dosing module mounts may be located within around 10 exducer diameters, around 7 exducer diameters, around 5 exducer diameters, and around 3 exducer diameters downstream of the downstream end of the turbine wheel chamber. The dosing module mounts may be located at least around 1 exducer diameter downstream of the downstream end of the turbine wheel chamber. One or more of the dosing module mounts are preferably located between around 1 exducer diameter, and around 3 exducer diameters, downstream of the downstream end of the turbine wheel chamber. One or more of the dosing module mounts may be located at a diverging portion of the turbine outlet passage. The diverging portion of the turbine outlet passage may define a diffuser of a turbine.

According to a thirtieth aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation about a turbine wheel axis, the turbine wheel comprising an exducer defining an exducer diameter;
receiving exhaust gas from the turbine wheel chamber into a turbine outlet passage downstream of the turbine wheel chamber, the turbine outlet passage defining a flow axis which extends from a downstream end of the turbine wheel; and
injecting aftertreatment fluid into exhaust gas in the turbine outlet passage using a plurality of dosing modules.

Two or more of the plurality of dosing modules may be circumferentially offset from one another about the flow axis. One or more of the plurality of dosing modules may be tangentially mounted about the flow axis. Two or more of the plurality of dosing modules may be axially offset from one another along the flow axis.

According to a thirty-first aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation about a turbine wheel axis, the turbine wheel comprising an exducer defining an exducer diameter;
receiving exhaust gas from the turbine wheel chamber into a turbine outlet passage downstream of the turbine wheel chamber, the turbine outlet passage defining a flow axis which extends from a downstream end of the turbine wheel; and
injecting aftertreatment fluid into exhaust gas in the turbine outlet passage by selective activation of one or more of a plurality of dosing modules.

Selective activation may comprise activating one or more of the dosing modules, preferably individually. Selective activation may occur based upon input data. Selective activation of dosing modules may comprise selectively activating dosing modules based upon a detected, or predicted, direction of swirl of the exhaust gas. Advantageously, aftertreatment fluid can thus be injected with, or against, a swirl direction, even if the swirl direction changes during operation, by selective activation of the dosing modules.

According to a thirty-second aspect of the invention there is provided a method of operating a turbine dosing system for a turbocharger, comprising:
receiving exhaust gas from an internal combustion engine a turbine inlet passage;
receiving exhaust gas from the turbine inlet passage into a turbine wheel chamber; and
receiving exhaust gas from the turbine wheel chamber into a turbine outlet passage downstream of the turbine wheel chamber, the turbine outlet passage being at least partly defined by a structure which comprises a plurality of dosing module mounts, each of the plurality of dosing module mounts being configured to receive a dosing module, the turbine outlet passage defining a flow axis which extends from a downstream end of the turbine wheel chamber.

According to a thirty-third aspect of the invention there is provided a connection adapter for an aftertreatment fluid dosing turbine housing assembly, the connection adapter comprising:
a first connection portion, at a first end of the connection adapter, configured to engage a turbine housing;
a second connection portion, at a second end of the connection adapter, configured to engage a downstream conduit; and
a structure which extends between the first and second ends of the connection adapter and defines a connection adapter passage configured to receive exhaust gas from a turbine housing, the connection adapter passage defining a flow axis;
wherein the structure comprises a dosing module mount configured to receive a dosing module; and
wherein the dosing module mount is angled towards the flow axis such that an opening of the dosing module mount points in an upstream direction.

The term “connection adapter” refers to a component which is provided between a turbine housing and a downstream conduit. The connection adapter may, for example, interpose a turbine housing and an exhaust manifold or pipe. The connection adapter may be referred to as a dosing connection adapter, or a reductant dosing connection adapter, owing to incorporation of the dosing module mount.

The connection adapter may be a generally frustoconical body. In other arrangements, the connection adapter may be a generally tubular body.

The dosing module mount pointing in an upstream direction may otherwise be described as the dosing module mount being angled towards the first end of the connection adapter. Aftertreatment fluid, injected by a dosing module mounted to the dosing module mount, is thus injected in an upstream direction (e.g. towards the turbine wheel, and towards the first end of the connection adapter). Described another way, the dosing module injects aftertreatment fluid in a direction which is at least partly, and optionally entirely, against a direction in which a turbine bulk flow generally moves (e.g. against the turbine bulk flow).

Advantageously, injecting aftertreatment fluid in an upstream direction: 1) increases relative velocities between the aftertreatment fluid droplets and the exhaust gas, thus increasing decomposition of the reductant; and 2) facilitates usage of available volume in the passage in that aftertreatment fluid can be injected upstream of the geometric reductant dosing location, which also increases decomposition because the residence time of the aftertreatment fluid droplets in the exhaust gas flow is increased.

The term “flow axis” refers to an axis about which the exhaust gas in the connection adapter passage generally rotates as it flows through the connection adapter passage (along the flow axis). The flow axis may be at least partly arcuate. The flow axis may be described as an imaginary line drawn along, and through, the connection adapter passage, the line being positioned at the geometric centre of the connection adapter passage. The flow axis may vary depending upon the geometry of the connection adapter. By way of example, if the connection adapter passage comprises a bend, the flow axis may also comprise a bend (e.g. be at least partly arcuate) as the direction of the exhaust gas flow in the connection adapter passage would be forced to change due to the bend in the connection adapter passage. The flow axis may be said to define a fluid flowpath which is generally followed by the turbine bulk flow once it has travelled downstream of the downstream end of the turbine wheel. For at least a portion of an extent of the flow axis, the flow axis may be coincident with a turbine wheel axis. The flow axis may extend from a turbine wheel axis.

The term “dosing module mount” encompasses a structure which is configured to align, and support, a dosing module. Given that the dosing module mount is configured to receive a dosing module, it will be appreciated that the position of the dosing module mount, e.g. an opening thereof, is indicative of the position of the dosing module once received therein. The dosing module mount position therefore defines the location of the dosing module and the aftertreatment fluid injection (e.g. a primary impingement zone as defined by a spray cone of the dosing module) in the assembled dosing system. It will also be appreciated that, by virtue of the dosing module mount being angled towards the flow axis such that an opening of the dosing module mount points in an upstream direction, the dosing module will also be angled in the same direction once mounted to the dosing module mount. Described another way, once assembled, the dosing module is angled towards the flow axis such that an outlet of the dosing module points in an upstream direction.

The term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

According to a thirty-fourth aspect of the invention there is provided a method of operating a connection adapter for an aftertreatment fluid dosing turbine housing assembly, the connection adapter comprising:
a first connection portion, at a first end of the connection adapter, configured to engage a turbine housing;
a second connection portion, at a second end of the connection adapter, configured to engage a downstream conduit; and
a structure which extends between the first and second ends of the connection adapter and defines a connection adapter passage, the connection adapter passage defining a flow axis;
wherein the structure comprises a dosing module mount configured to receive a dosing module; and
wherein the dosing module mount is angled towards the flow axis such that an opening of the dosing module mount points in an upstream direction;
the method comprising receiving exhaust gas from a turbine housing into the connection adapter passage.

According to a thirty-fifth aspect of the invention there is provided a turbocharger comprising:
a compressor, the compressor comprising a compressor housing and a compressor wheel;
a bearing housing, the bearing housing being configured to support a shaft for rotation about the turbine wheel axis; and
the turbine dosing system according to any one of the 2^{nd} to 4^{th}, 9^{th}, 10^{th}, 12^{th}, 14^{th}, 16^{th}, 17^{th}, 22^{nd}, 24^{th}, 26^{th}, 28^{th} or 29^{th} aspects of the invention;
wherein the compressor wheel and turbine wheel are coupled to the shaft in power communication with one another.

The turbocharger may be for an engine arrangement. The turbocharger may be described as an aftertreatment fluid dosing turbocharger.

The compressor and/or turbine being coupled to the shaft in power communication with one another is intended to mean that, as exhaust gas is expanded across the turbine wheel, so as to drivably rotate the turbine wheel, the compressor wheel is also rotated due to the expansion of exhaust gas.

According to a thirty-sixth aspect of the invention there is provided an engine arrangement comprising;
an engine; and
a turbocharger according to the thirty-fifth aspect of the invention;
wherein the turbocharger is configured to receive exhaust gas from the engine.

The engine arrangement may be for a vehicle. The engine arrangement may be for a pump. The engine arrangement may be for a generator.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

Specific embodiments of the present invention will now be described, by way of example only, with reference to the accompanying drawings in which:

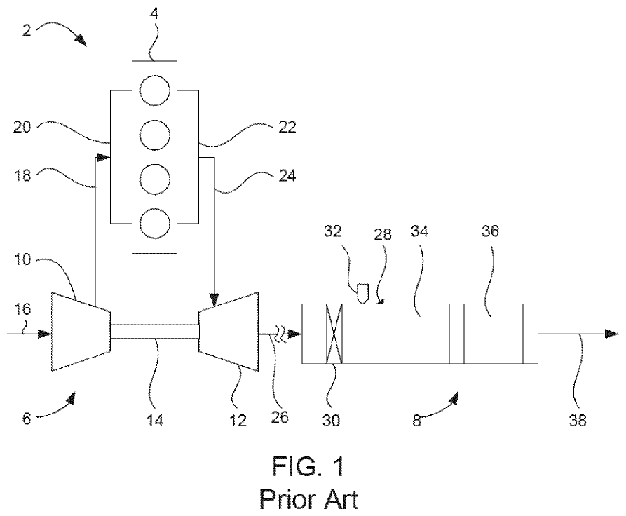

FIG. 1 is a schematic view of a known turbocharged diesel engine system;

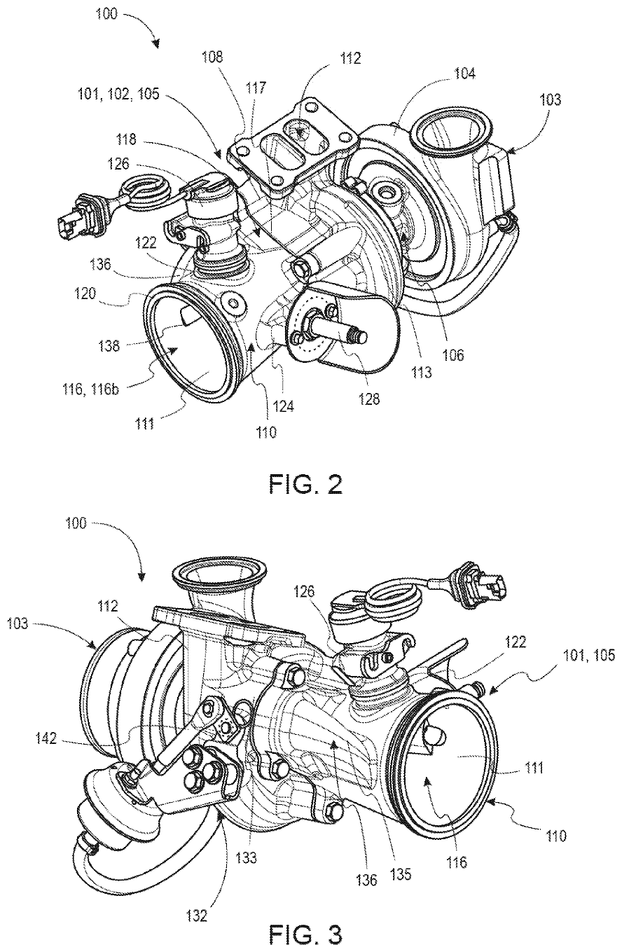

FIG. 2 is a perspective view, generally from above, of a turbocharger comprising a turbine dosing system according to an embodiment of the invention;

FIG. 3 is an alternative perspective view of the turbocharger of FIG. 2;

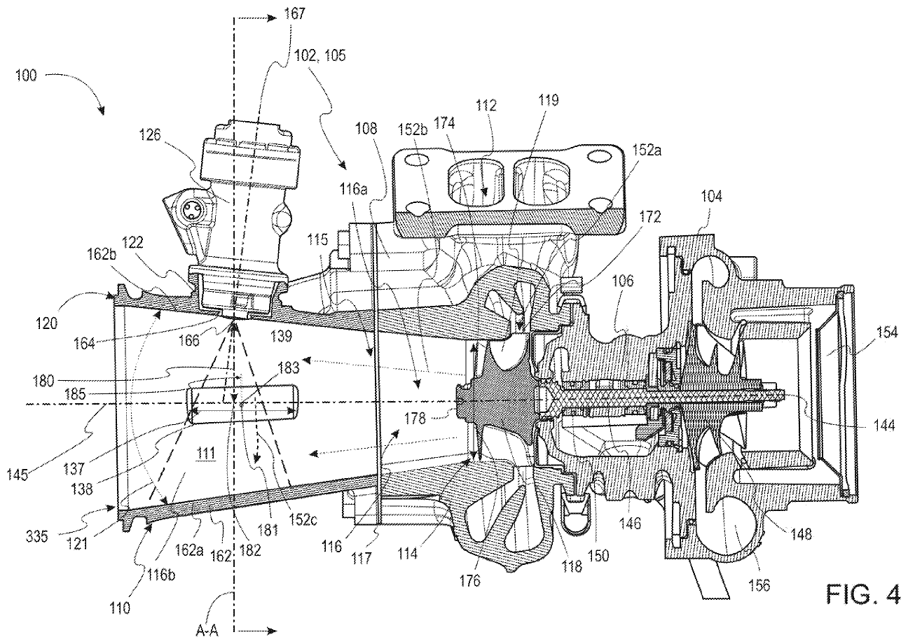

FIG. 4 is a side cross-sectional view of the turbocharger of FIGS. 2 and 3;

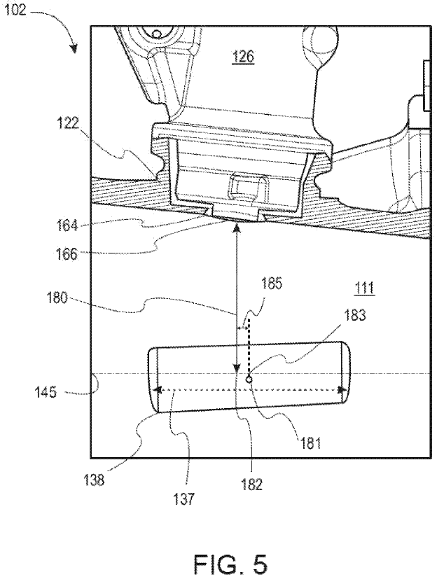

FIG. 5 is an enlarged view of a dosing module, and dosing module mount, of the turbocharger of FIGS. 2 to 4;

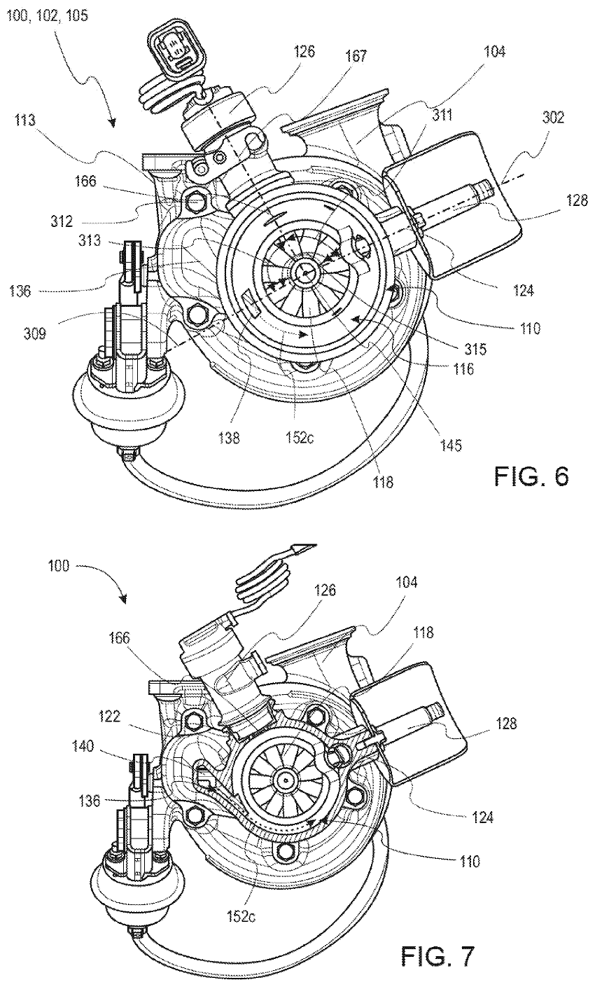

FIG. 6 is an end view of the turbocharger of FIGS. 2 to 5;

FIG. 7 is a cross-sectional end view of the turbocharger of FIGS. 2 to 6, taken through the plane A-A of FIG. 4;

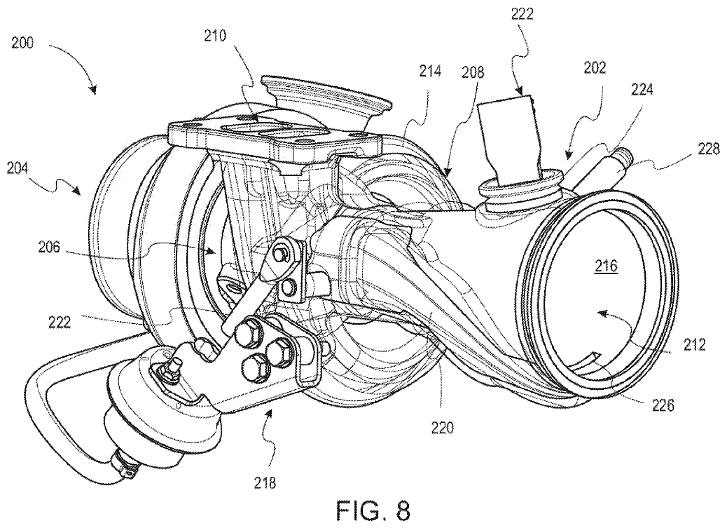

FIG. 8 is a perspective view of a turbocharger incorporating a wastegate turbine dosing system according to another embodiment;

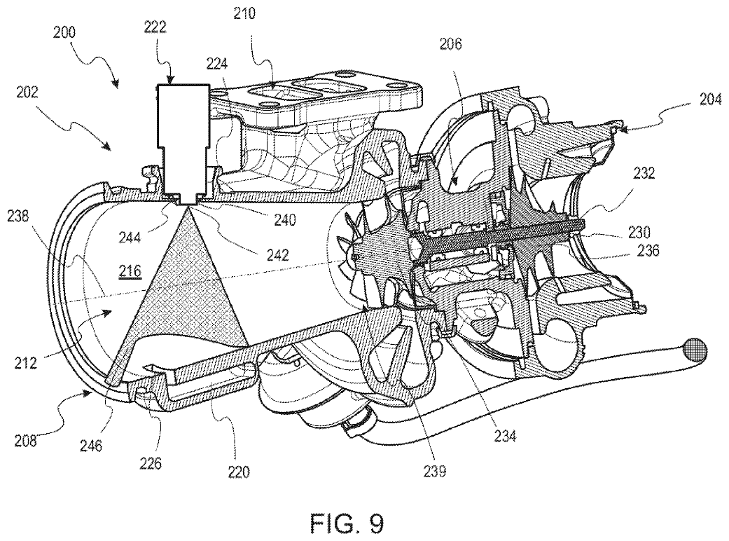

FIG. 9 is a perspective cross section view of the turbocharger of FIG. 8;

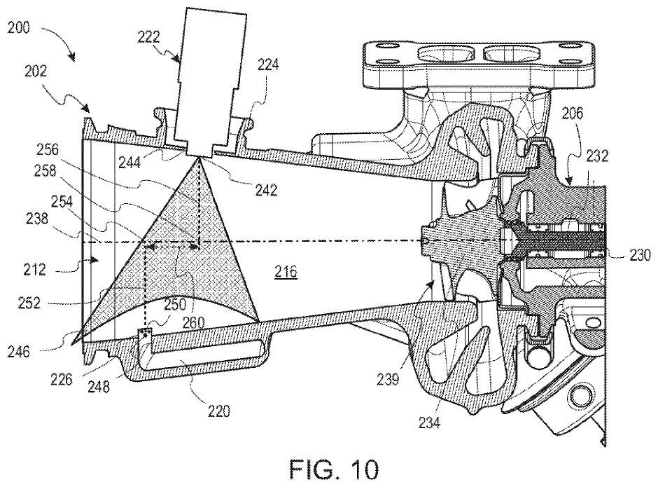

FIG. 10 is a cross section side view of part of the turbocharger of FIGS. 8 and 9;

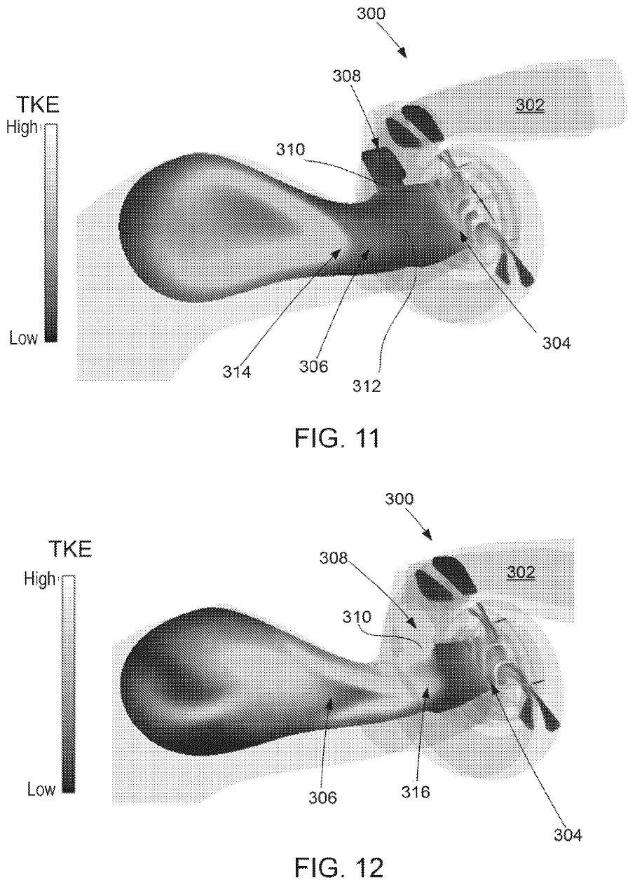

FIGS. 11 and 12 are plots showing turbulent kinetic energy (TKE) results from CFD simulations according to an embodiment;

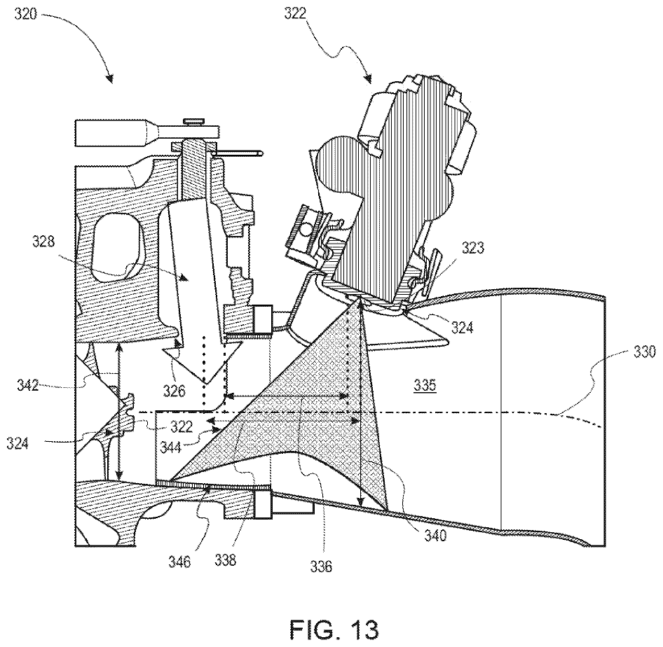

FIG. 13 is a side cross section view of a turbine dosing system according to an embodiment;

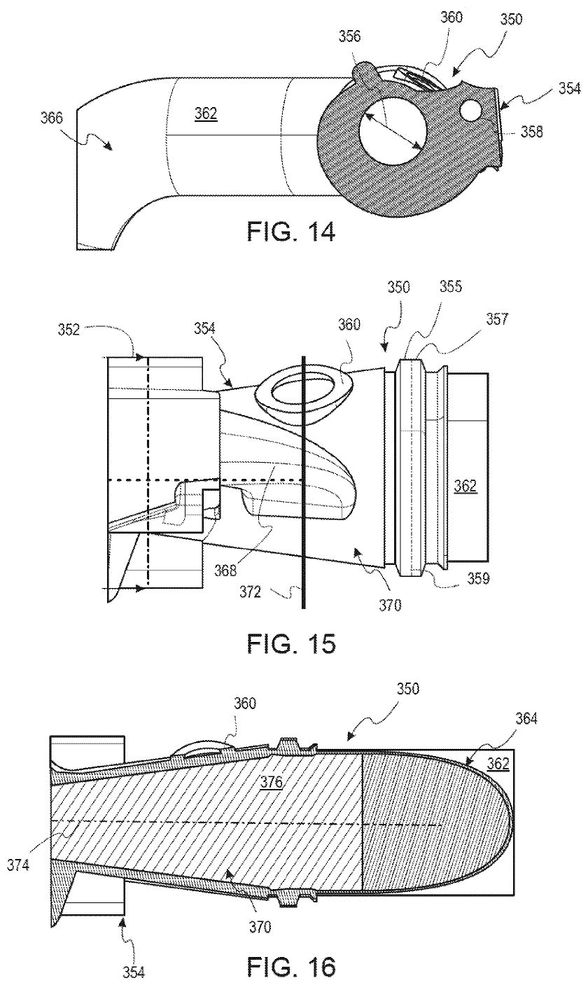

FIG. 14 shows part of a turbine dosing system according to another embodiment;

FIG. 15 is a side view of part of the turbine dosing system of FIG. 14;

FIG. 16 is a cross section side view of part of the turbine dosing system of FIGS. 14 and 15;

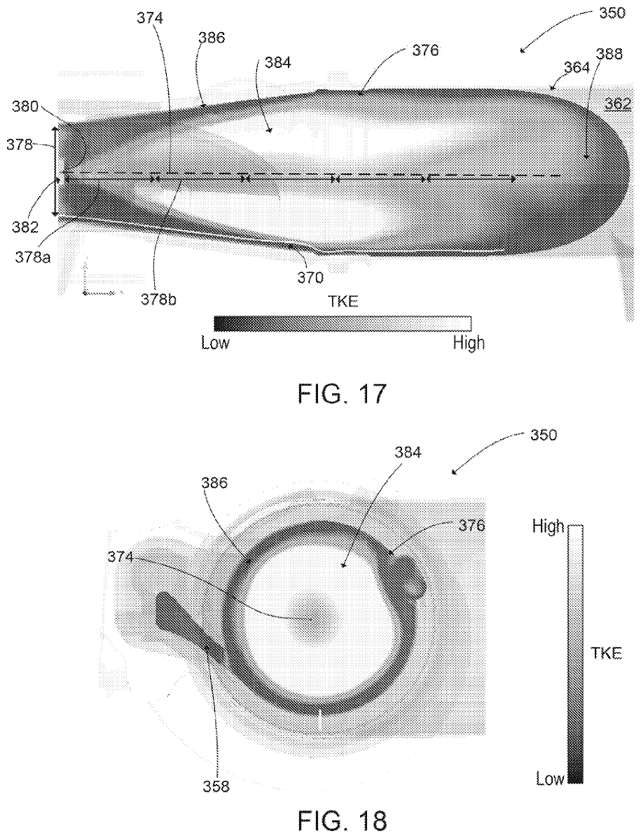

FIGS. 17 and 18 are plots showing the TKE of an exhaust gas flow in the system of FIGS. 14 to 16, obtained using CFD simulation, with the wastegate closed;

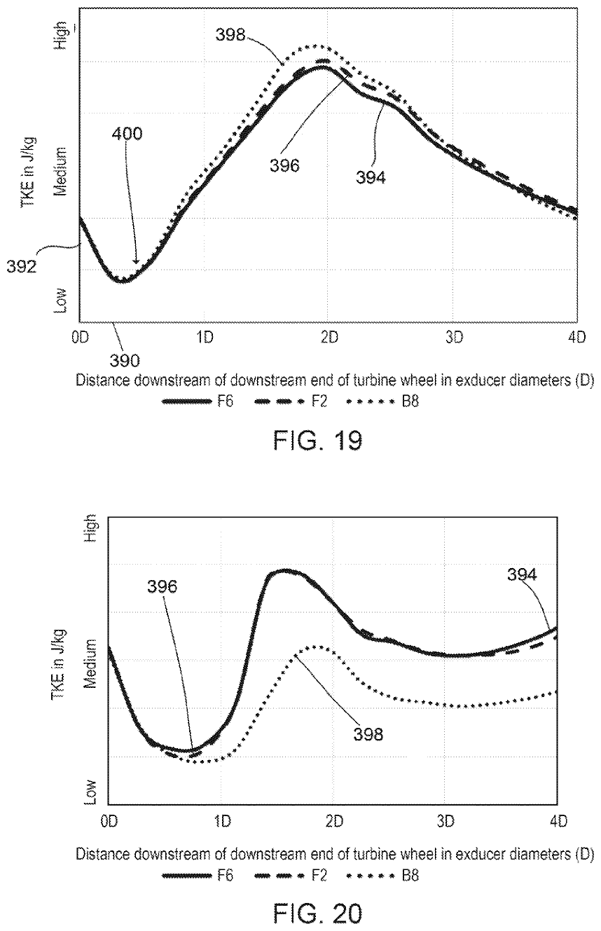

FIGS. 19 and 20 are plots of TKE as a function of the downstream position, in exducer diameters, of a downstream end of the turbine wheel, for three different turbine dosing systems, with wastegate closed and wastegate open conditions respectively; according to embodiments of the invention;

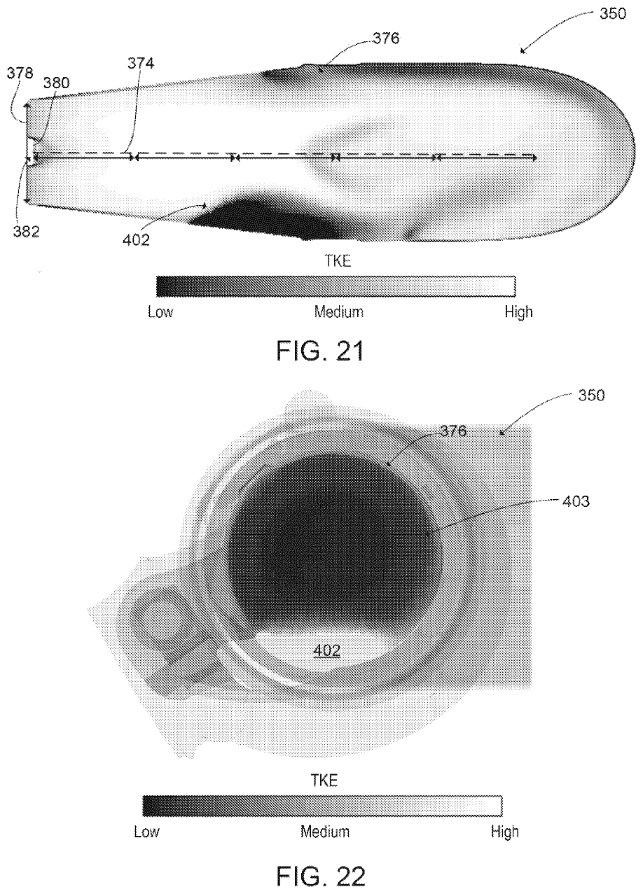

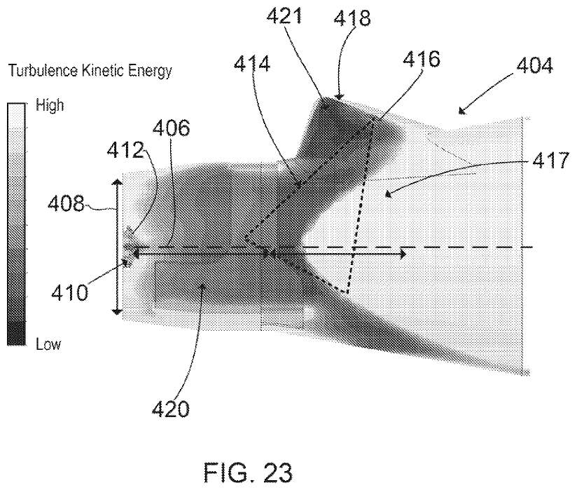

FIGS. 21 and 22 are plots showing the TKE of an exhaust gas flow in the system of FIGS. 14 to 18, obtained using CFD simulation, with the wastegate open; Turning to FIG. 23, a plot showing relative TKE levels downstream of a turbine wheel for another embodiment of turbine dosing system is provided;

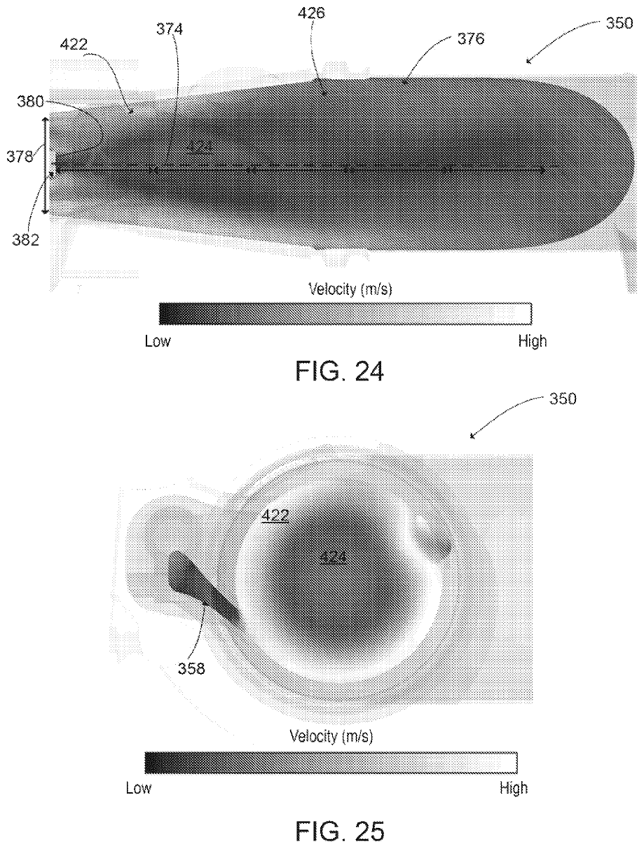

FIGS. 24 and 25 are plots showing the velocity distribution of an exhaust gas flow in the system of FIGS. 14 to 18, obtained using CFD simulation, with the wastegate closed;

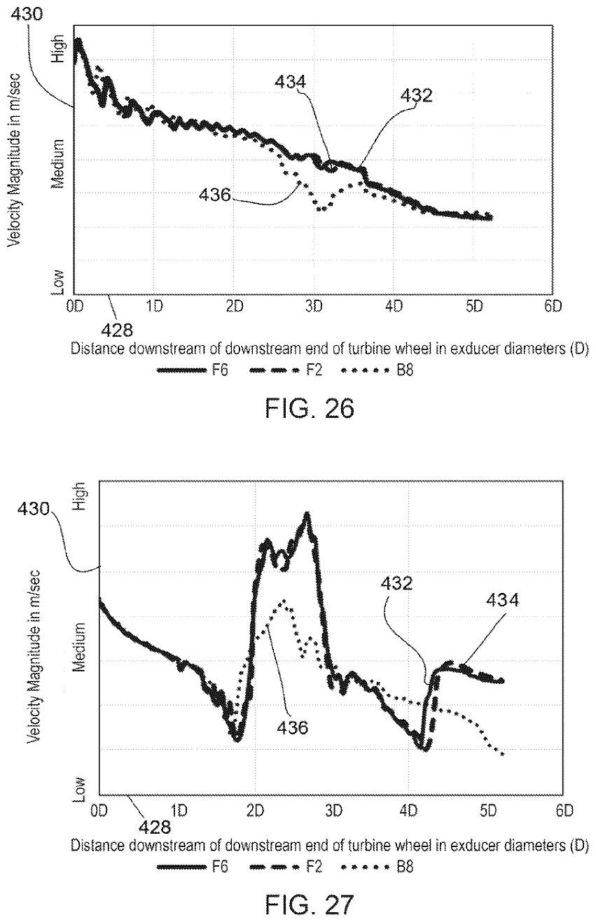

FIGS. 26 and 27 are plots of velocity of an exhaust gas flow as a function of the downstream position, in exducer diameters, of a downstream end of the turbine wheel, for three different turbine dosing systems, with wastegate closed and wastegate open conditions respectively; according to embodiments of the invention;

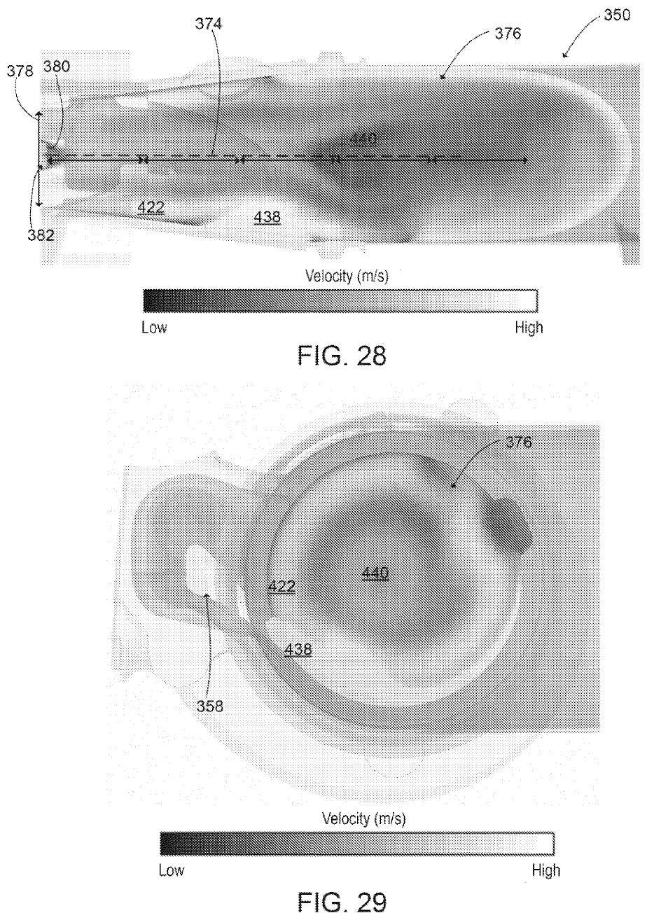

FIGS. 28 and 29 are plots showing the velocity distribution of an exhaust gas flow in the system of FIGS. 14 to 18, and FIGS. 24 and 25, obtained using CFD simulation, with the wastegate closed;

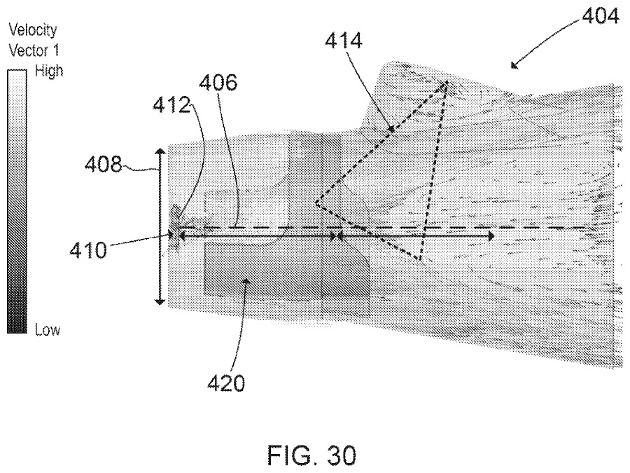

FIG. 30 is a plot indicating the velocity distribution of an exhaust gas flow in the turbine dosing system of FIG. 23;

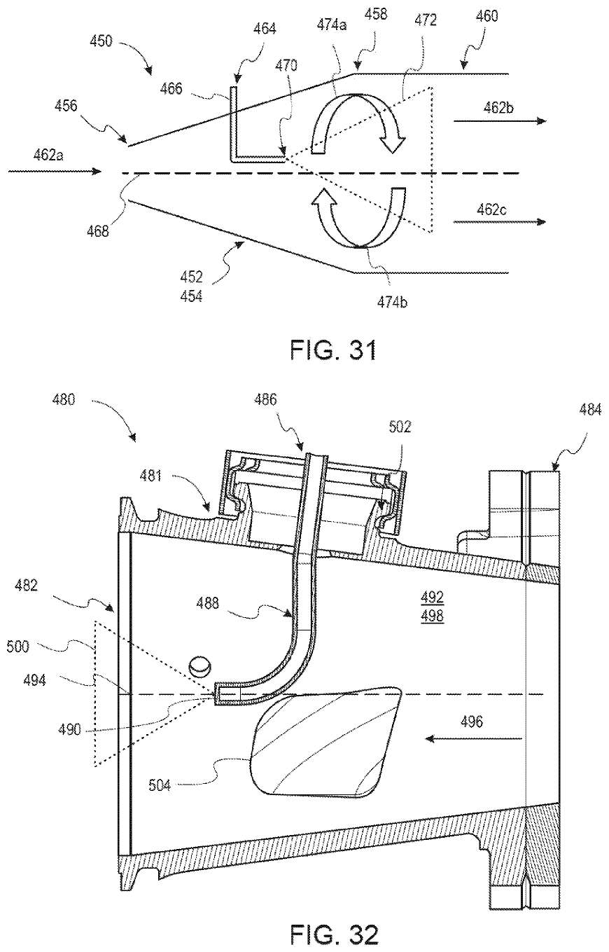

FIG. 31 is a schematic cross section side view of part of a turbine dosing system 450 according to another embodiment;

FIG. 32 is a cross section side view of a part of a turbine dosing system according to another embodiment;

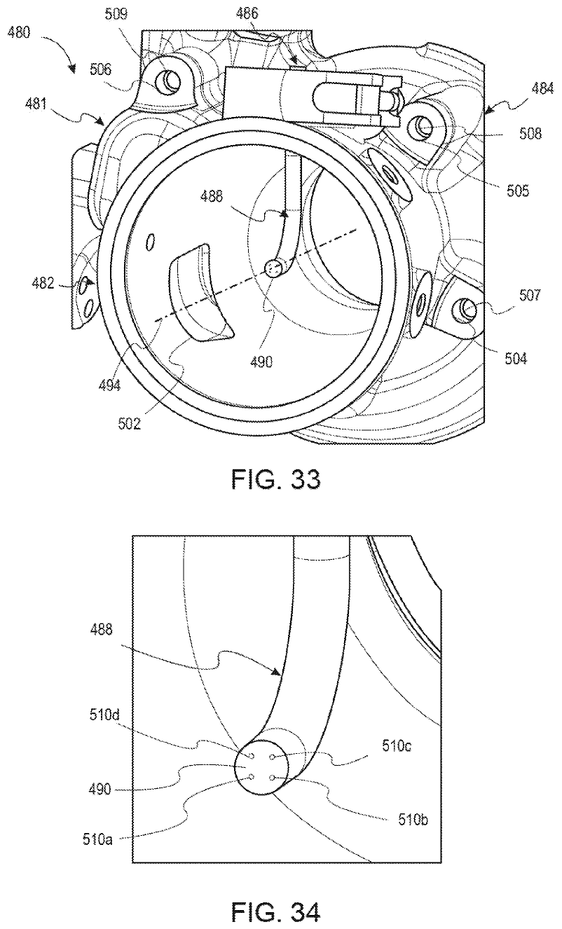

FIG. 33 is a perspective view of the part of the turbine dosing system shown in FIG. 32;

FIG. 34 is a close-up perspective view of an outlet of a conduit of the systems of FIGS. 32 and 33;

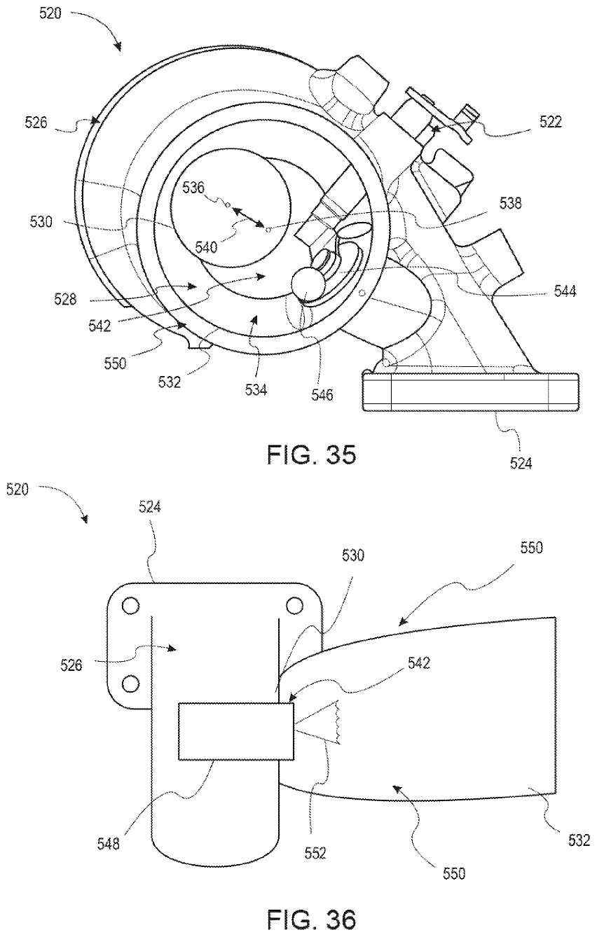

FIG. 35 is an end view of a turbine housing according to another embodiment;

FIG. 36 is a schematic side view of the turbine housing of FIG. 35 with a dosing module mounted thereto;

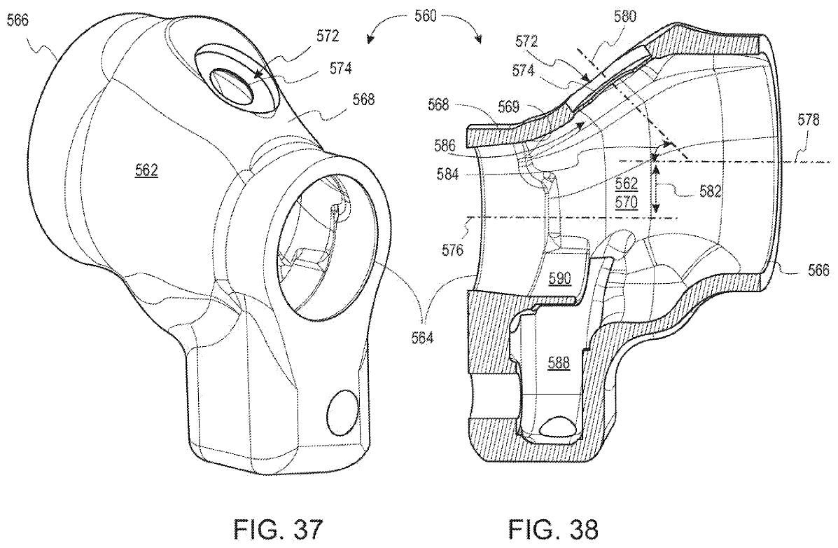

FIG. 37 is a perspective view of a connection adapter, according to an embodiment, from a generally upstream end;

FIG. 38 is a cross sectional side view of the connection adapter of FIG. 37;

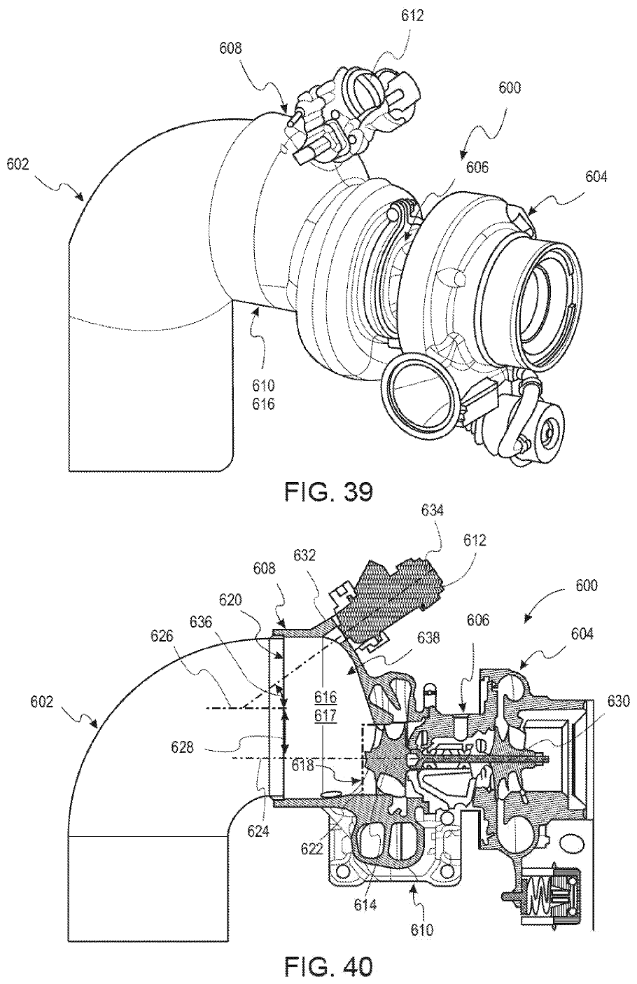

FIG. 39 is a perspective view of a turbocharger and downstream conduit according to another embodiment;

FIG. 40 is a cross section side view of the turbocharger and downstream conduit of FIG. 39;

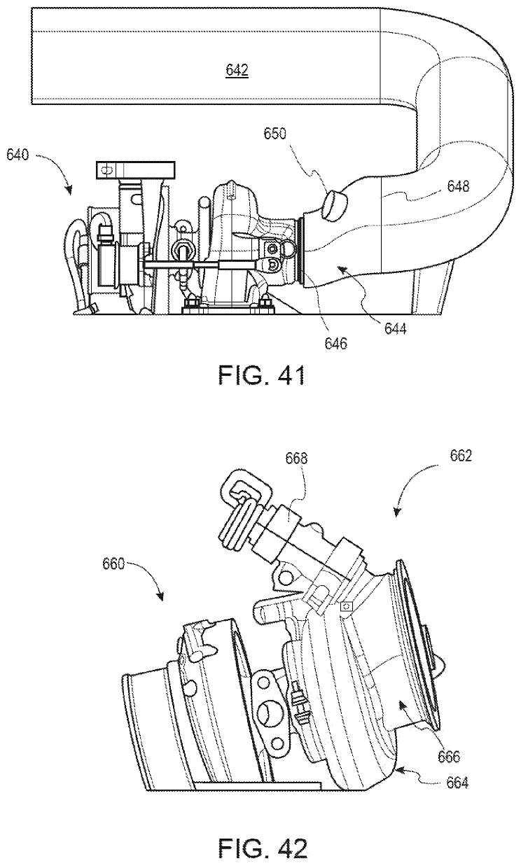

FIG. 41 is a perspective view of a turbocharger and downstream conduit according to another embodiment;

FIG. 42 is a perspective view of a turbocharger according to an embodiment;

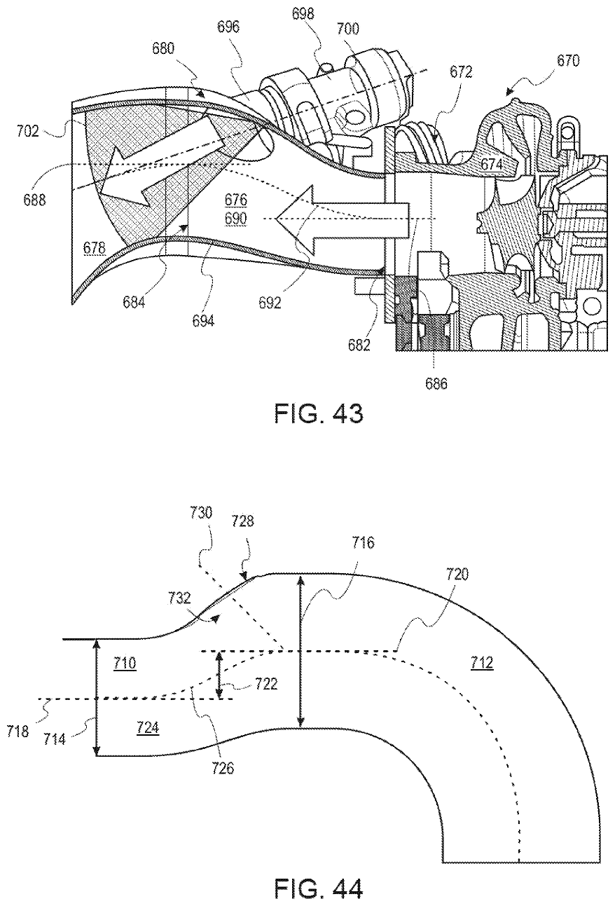

FIG. 43 is a cross section side view of a turbine dosing system according to another embodiment;

FIG. 44 is a schematic cross section of part of a diffuser and downstream conduit according to another embodiment;

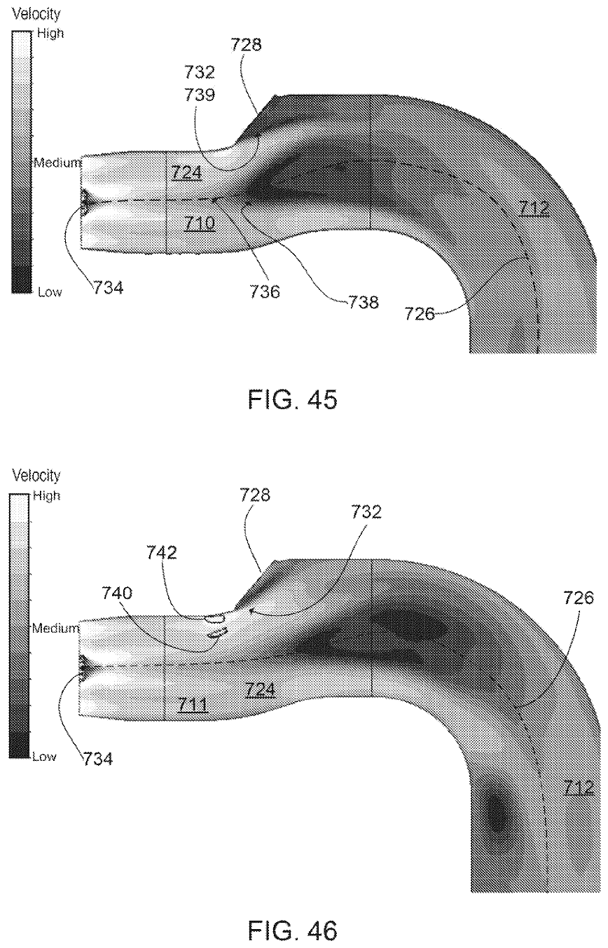

FIG. 45 is a plot showing the velocity distribution of an exhaust gas flow, from a CFD simulation, of the system of FIG. 44;

FIG. 46 is a velocity plot showing the velocity distribution of an exhaust gas flow, from a CFD simulation, on a modified diffuser according to another embodiment;

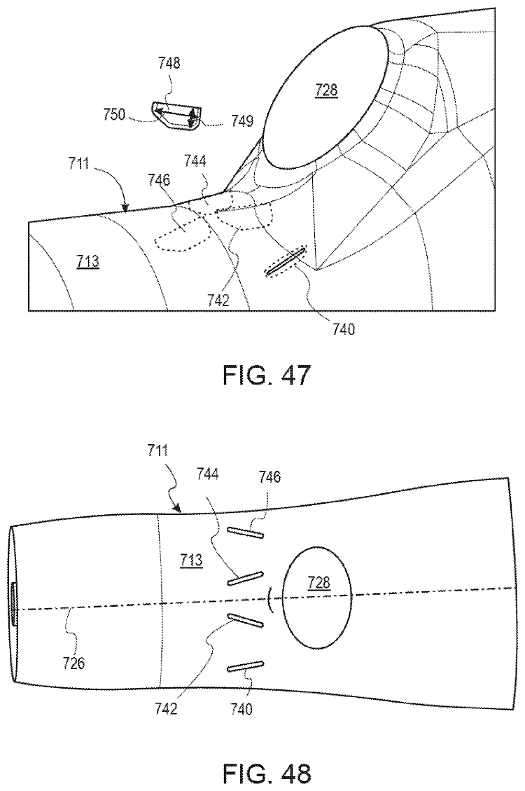

FIG. 47 is a magnified perspective view of an exterior of part of the diffuser of FIG. 46;

FIG. 48 is a plan view of the diffuser of FIGS. 46 and 47;

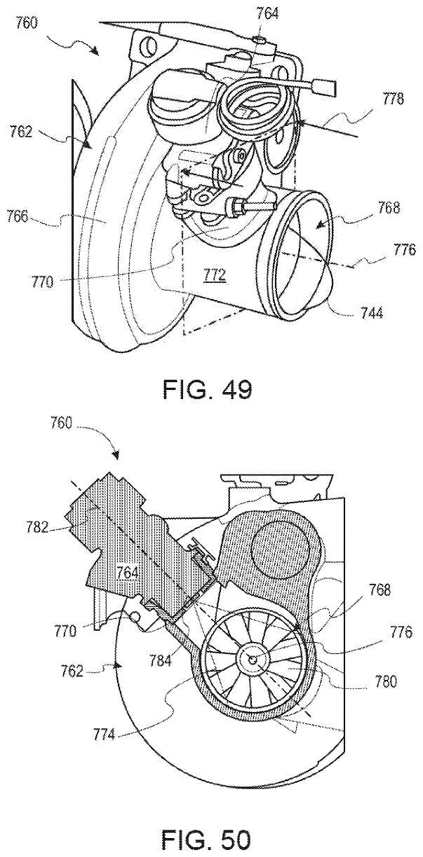

FIG. 49 is a perspective view of an exterior of a turbine dosing system according to another embodiment;

FIG. 50 is a cross section side view of the system of FIG. 49;

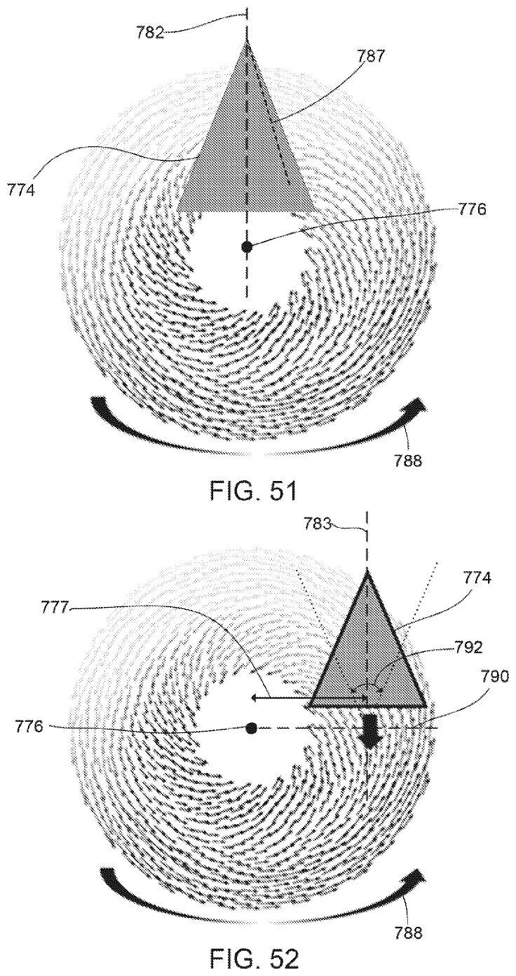

FIG. 51 is a schematic cross section view of a flow field, and spray cone, of the turbine dosing system of FIG. 50;

FIG. 52 shows an alternative alignment of dosing module mount axis according to an embodiment;

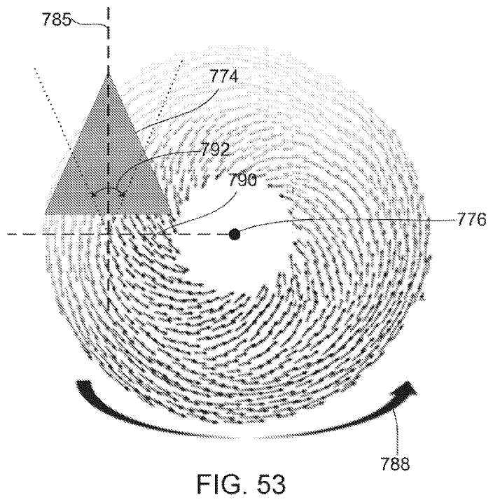

FIG. 53 shows a further alternative alignment of dosing module mount axis according to an embodiment;

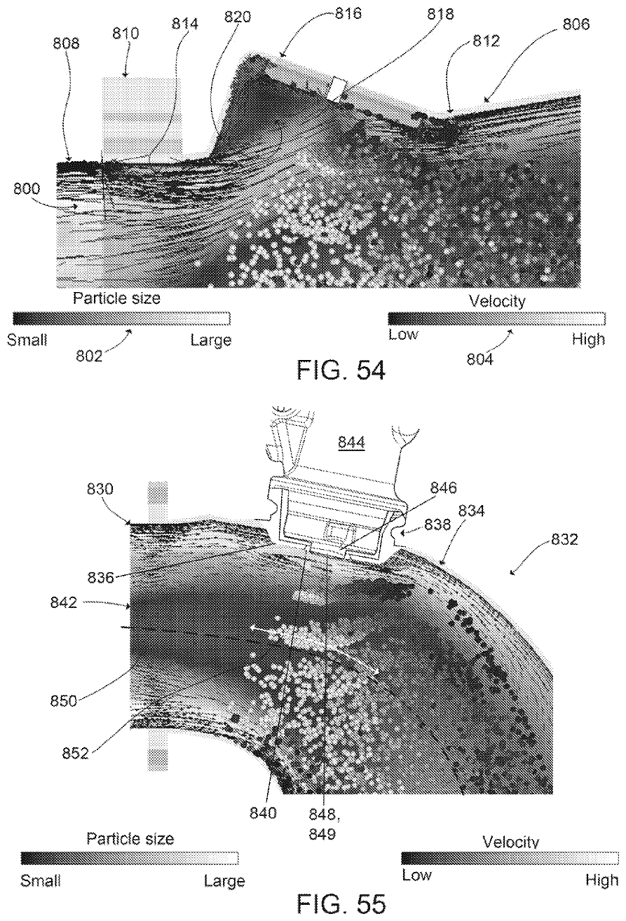

FIG. 54 is a (partial) plot showing results from a CFD simulation conducted on a turbine dosing system according to an embodiment;

FIG. 55 is a plot showing results from a CFD simulation on a turbine dosing system according to another embodiment;

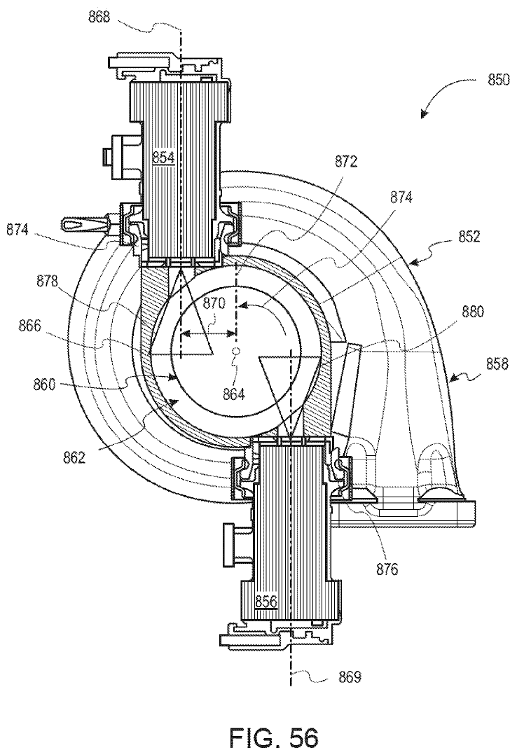

FIG. 56 is a cross section end view of part of a turbine dosing system according to another embodiment;

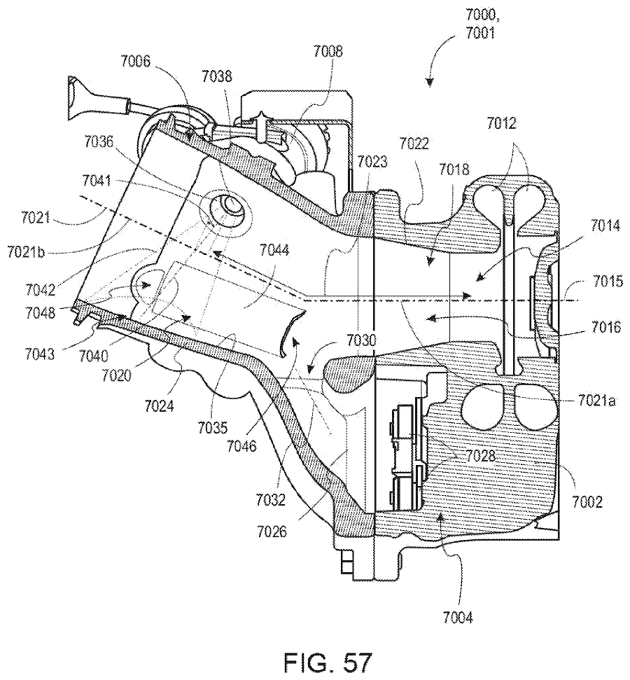

FIG. 57 is a cross-section side view of a turbine dosing system according to another embodiment;

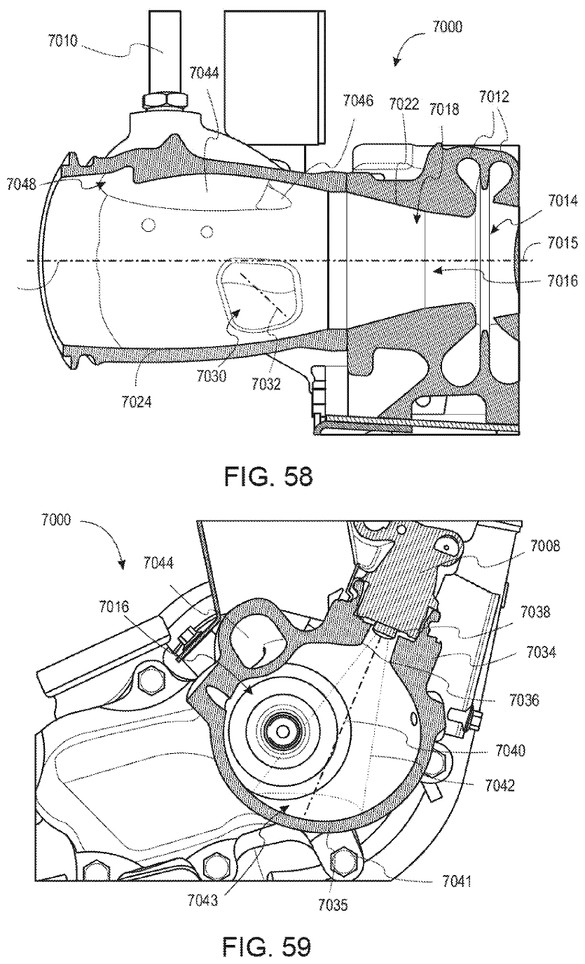

FIG. 58 is a cross-section plan view of the turbine dosing system of FIG. 57;

FIG. 59 is a cross-section end view of the turbine dosing system of FIGS. 57 and 58 taken through the axial position of the dosing module;

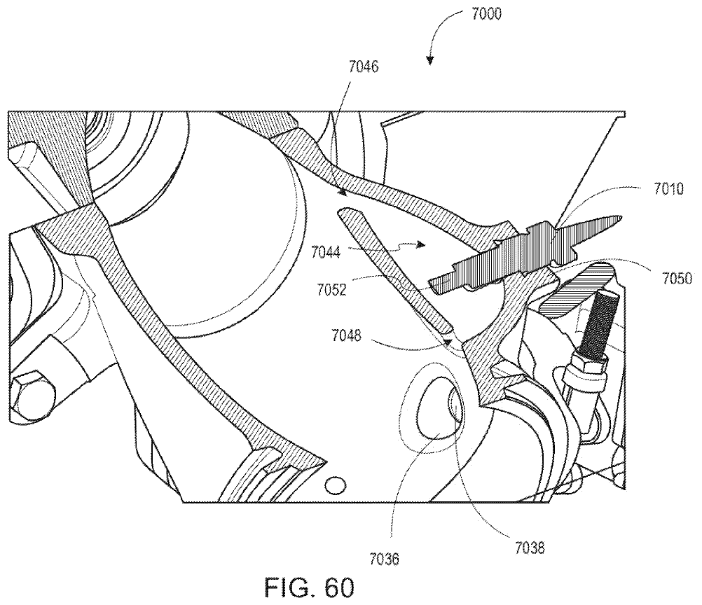

FIG. 60 is a cross-section side view of the turbine dosing system of FIGS. 57 to 59 taken through the sensing passage;

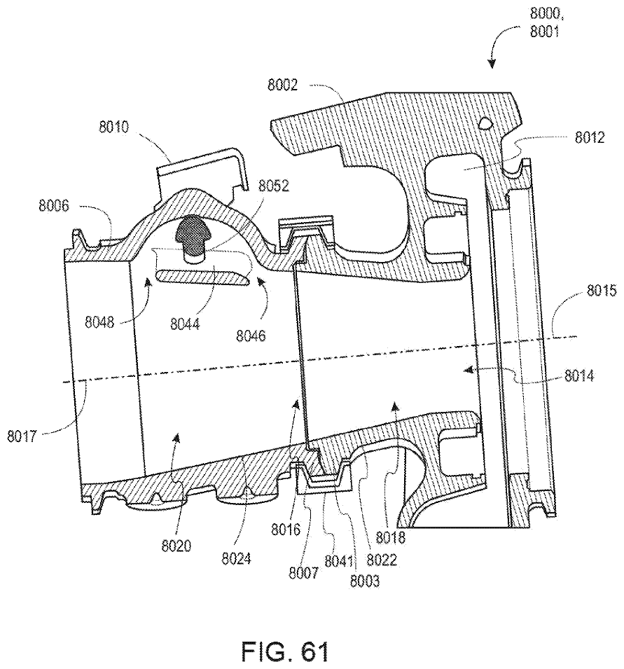

FIG. 61 is a cross-section side view of a turbine dosing system in accordance with another embodiment;

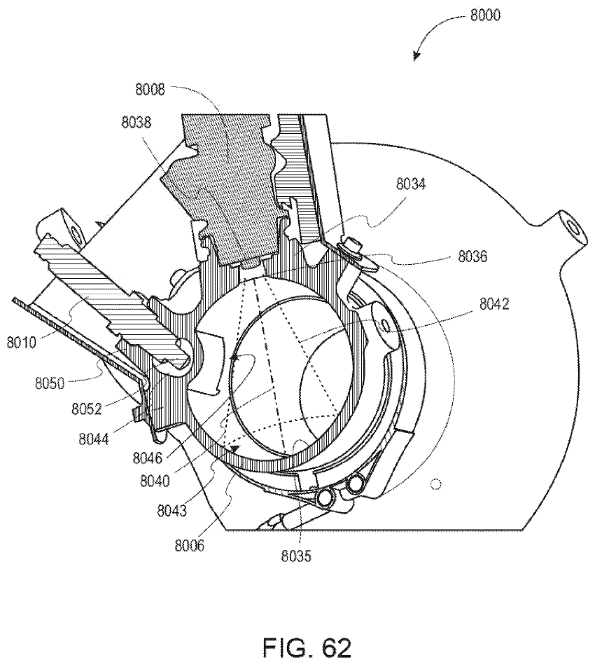

FIG. 62 is a cross-section end view of the turbine dosing system of FIG. 61 taken through the axial position of the dosing module and sensing passage; and

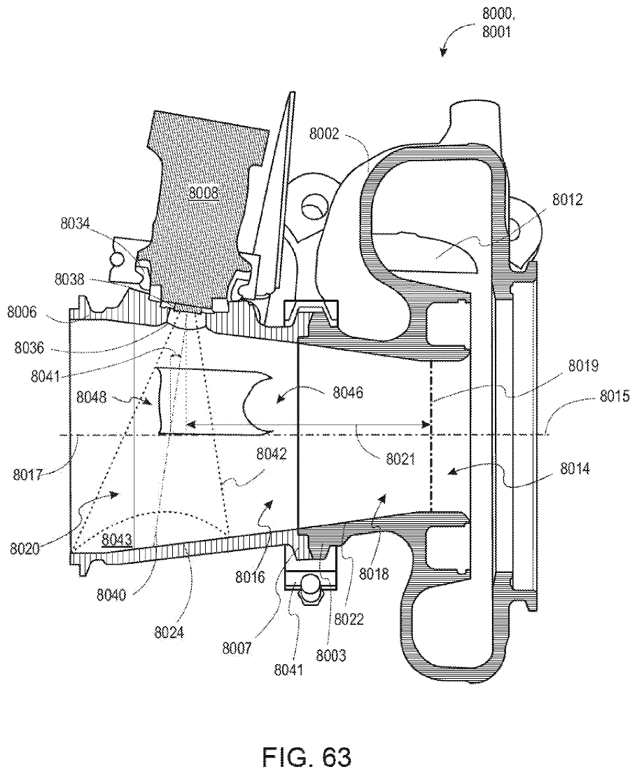

FIG. 63 is an alternative cross-section side view to that shown in FIG. 61.

FIG. 1 is a schematic view of a known turbocharged diesel engine system 2. The system 2 comprises a diesel internal combustion engine 4, a turbocharger 6 and an exhaust gas aftertreatment system 8.

The turbocharger 6 comprises a compressor 10, and a turbine 12, each comprising a respective one of a compressor wheel and turbine wheel. The compressor wheel and turbine wheel are mounted to a common turbocharger shaft 14 such that they rotate in unison.

The compressor 10 receives intake air from a low pressure intake duct 16 connected to atmosphere. The low pressure intake duct 16 may comprise a particulate filter to clean the intake air. The compressor 10 compresses the intake air using power provided by the turbine 12 (via the turbocharger shaft 14) and supplies the compressed intake air to the engine 4 via a high pressure intake duct 18 and an intake manifold 20. Although not shown, the high pressure intake duct 18 may comprise an intercooler configured to cool the intake air before it reaches the engine 4.

Inside the engine 4, an internal combustion process takes place and useful work is produced. As a result of the internal combustion process, exhaust gases are created by the engine 4. The engine 4 is fluidly connected to an exhaust manifold 22 which is, in turn, connected to the turbine 12 via a high pressure exhaust gas duct 24. The turbine 12 (specifically the turbine wheel thereof) extracts energy from the exhaust gas to drive the turbocharger shaft 14 and thereby power the compressor 10. Exhaust gas leaving the turbocharger 12 is supplied to the exhaust gas aftertreatment system 8 via a downpipe 26. The downpipe 26 is relatively long in extent, for example at least 2 metres in length, as indicated by the broken line in FIG. 1.

The exhaust gas aftertreatment system 8 comprises a decomposition chamber 28 having a diameter larger than that of the downpipe 26. The decomposition chamber 28 comprises a mixing element 30 disposed therein. The mixing element 30 typically comprises a number of baffles configured to deflect the flow through the decomposition chamber 28 to cause turbulence within the decomposition chamber 28. The exhaust gas aftertreatment system 8 comprises a dosing module 32 configured to inject an exhaust gas aftertreatment fluid, and specifically Diesel Exhaust Fluid (DEF), into the decomposition chamber 28 downstream of the mixing element 30 in the region where the exhaust gas is most turbulent. Heat exchange between the DEF and the exhaust gas within the decomposition chamber 28 causes the urea contained within the DEF to decompose into the reductants ammonia (NH₃) and Isocyanic Acid (HNCO). The mixture of reductants and exhaust gas is then passed to a selective catalytic reducer (SCR) 34 and a diesel oxidation catalyst (DOC) 36. Finally, the exhaust gas is passed to an outlet duct 38 and onwards to a muffler (not shown) before being discharged to atmosphere.

FIG. 2 is a perspective view of a turbocharger 100, generally from above, comprising a turbine dosing system 105 according to an embodiment of the present invention. The turbocharger 100 comprises a turbine 101 and a compressor 103 interconnected by a bearing housing 106. Owing to the incorporation of a wastegate (as will be described in detail later in this document), the turbocharger 100 may be described as a wastegate turbocharger, and the turbine dosing system may be described as a wastegate turbine dosing system.

In the illustrated embodiment, the turbine 101 forms part of the turbine dosing system 105. This is owing to the incorporation of a dosing module 126. This will be described in detail later in this document.

The turbine 101, and so turbine dosing system 105 more generally, comprises a turbine housing assembly 102. The turbine housing assembly 102 comprises a turbine housing 108 and a connection adapter 110. The turbine housing assembly 102 differs from, for example a monoblock turbine housing, owing to the multi-part assembly of the turbine housing 108 and the connection adapter 110 (in comparison to the single-piece turbine housing construction of a monoblock turbine housing). The turbine housing 108 is the part of the turbine housing assembly 102 proximate the bearing housing 106. The turbine housing 108 is configured to engage the bearing housing 106. The connection adapter 110 is separated from the bearing housing 106 by at least an extent of the turbine housing 108. Described another way, the connection adapter 110 is provided downstream of the turbine housing 108.

In the illustrated embodiment, the turbine housing 108 defines a turbine inlet passage 112, a turbine wheel chamber (not visible in FIG. 2) and part of a turbine outlet passage 116. In particular, the turbine housing 108 defines an upstream portion (not visible in FIG. 2) of the turbine outlet passage 116. The turbine inlet passage 112 is defined by a volute 113 (which may otherwise be referred to as a scroll) and is configured to receive exhaust gas from an internal combustion engine (not shown). The volute 113 is thus the structure that defines the turbine inlet passage 112. The turbine inlet passage 112 encourages swirling of the exhaust gas about a turbine wheel axis (not shown in FIG. 2 but labelled 144 in FIG. 4). Described another way, the turbine inlet passage 112 geometry encourages swirl of the exhaust gas flow upstream of a turbine wheel (not visible in FIG. 2 but labelled 118 in FIG. 4). In some embodiments the turbine inlet passage 112 may also impart an axial component to the exhaust gas flow (e.g. in the case of a mixed flow turbine wheel, but not in the illustrated embodiment). The turbine inlet passage 112 may be described as extending in at least in a circumferential and a radial direction about the turbine wheel axis. The swirl of the exhaust gas is changed as the exhaust gas is expanded across the turbine wheel, and may even be reversed depending upon flow conditions and surrounding geometry.

The connection adapter 110 defines a downstream portion 116b of the turbine outlet passage 116. Said downstream portion 116b may be referred to as a connection adapter passage. A first end 118 of the connection adapter 110 engages the turbine housing 108 (via an interposing gasket 117). The downstream portion 116b of the turbine outlet passage 116, which is defined by the connection adapter 110, is thus in fluid communication with an upstream portion 116a of the turbine outlet passage 116 (defined by the turbine housing 108 and not visible in FIG. 2, but shown in FIG. 4). It will be appreciated that the interposing gasket 117 is an optional feature and an interposing gasket 117 may not be present in other embodiments.

In the illustrated embodiment (and as will be appreciated from FIG. 4) the connection adapter 110 defines a diffuser (e.g. a diverging portion of the turbine outlet passage 116). Exhaust gas thus expands as it passes through the connection adapter 110. The connection adapter 110 may therefore be said to define a diffuser cone, outlet diffuser or turbine stage outlet diffuser. Described another way, the connection adapter 110 defines at least part of a diffuser of the turbine 102, and optionally an entirety of a diffuser of the turbine 102.

Defining part of the turbine outlet passage 116 by the connection adapter 110 is advantageous because different connection adapters can be fixed, or attached, to the same turbine housing 108 design. Different connection adapters may incorporate different features for different applications.

Returning to FIG. 2, the connection adapter 110 comprises an interior surface 111. The connection adapter 110 further comprises a dosing module mount 122 and a NOx sensor mount 124. The dosing module mount 122 is engaged by the dosing module 126. The dosing module mount 122 thus aligns, and supports, the dosing module 126. The dosing module 126 is configured to inject aftertreatment fluid into the exhaust gas in the turbine outlet passage 116. The dosing module mount 122 and the dosing module 124 are described in more detail below. The dosing module 126 is provided in fluid communication with a tank, or reservoir, in which a supply (e.g. volume) of aftertreatment fluid is stored.

The turbine dosing system 105 further comprises an exhaust gas sensor which, in this embodiment, is a NOx sensor 128. The turbine dosing system 105 further comprises a NOx sensor mount 124. The NOx sensor mount 124 is engaged by a NOx sensor 128. The NOx sensor 128 is not a particular focus of the present application.

Finally, FIG. 2 also shows a wastegate passage outlet 138. The wastegate passage outlet 138 is an aperture defined in the interior surface 111 (e.g. wall) of the connection adapter 110. In use, (bypass) exhaust gases can be diverted around the turbine wheel, through a wastegate passage 136 and into the turbine outlet passage 116 via the wastegate passage outlet 138.

Turning to FIG. 3, an alternative perspective view of the turbocharger 100 is provided.

FIG. 3 illustrates that the turbocharger 100 is a wastegate turbocharger comprising a wastegate arrangement 132. The wastegate arrangement 132 forms part of the turbine dosing system 105. The wastegate arrangement 132 comprises a valve assembly (not visible in FIG. 3) and the wastegate passage 136. As mentioned above, the wastegate passage 136 defines a fluid pathway from the turbine inlet passage 112 directly to the turbine outlet passage 116. The wastegate passage 136 is partly defined by the turbine housing 108 and partly defined by the connection adapter 110 in the illustrated embodiment. That is to say, neither the turbine housing 108, nor the connection adapter 110, defines an ‘entire’ wastegate passage. The wastegate passage 136 provides selective fluid communication between the turbine inlet passage 112 and the turbine outlet passage 116, bypassing the turbine wheel chamber and turbine wheel. As such, (bypass) exhaust gas in the turbine inlet passage 112 can flow through the wastegate passage 136, to the turbine outlet passage 116, without passing through, or being expanded across, the turbine wheel 118. This is desirable for at least reasons of being able to control the rotational speed of the turbine wheel.

The wastegate passage 136 comprises a wastegate passage inlet and the wastegate passage outlet (neither of which are visible in FIG. 3). The wastegate passage inlet is defined by an opening in a wall of the turbine housing 108 which defines the turbine inlet passage. As such, exhaust gas flow passes into the wastegate passage 136 via the wastegate passage opening and leaves the wastegate passage 136 via the wastegate passage outlet (not visible in FIG. 3). As the (bypass) exhaust gas leaves the wastegate passage 136 it mixes with the (turbine bulk flow) exhaust gas in the turbine outlet passage 116.

In accordance with the terminology used throughout this document, the wastegate passage 136 refers to a volume through which (bypass) exhaust gas flows. The wastegate passage 136 may be described as being defined by a wastegate channel (the wastegate channel specifically being visible in FIG. 3). In the illustrated embodiment, the wastegate channel is defined by an upstream portion 133 and a downstream portion 135. The upstream portion 133 of the wastegate channel is defined by the turbine housing. The downstream portion 135 of the wastegate channel is defined by the connection adapter 110. The connection adapter 110 may thus be described as comprising at least part of the wastegate channel and/or at least part of the wastegate passage 136. The combination of the upstream portion 133 and downstream portion 135 may the entire wastegate channel/entire wastegate passage.

The bypass exhaust gas flowing through the wastegate passage outlet is a high-energy exhaust gas flow which has not been expanded across the turbine wheel. A zone in which two high velocity gas streams (e.g. a turbine bulk flow and a bypass flow) merge is thus defined proximate the wastegate passage outlet. A high level of mixing can be realised in this zone, the level of mixing being influenced by the momentum exchange of the two gas flows. For reasons described in detail below, the high level of mixing is advantageously utilised by locating the dosing module 126 proximate the wastegate passage outlet.

The wastegate valve assembly comprises a valve member which is rotatable by an actuation rod 142. In use, the actuation rod 142 is configured to cause rotation of the valve member such that the valve member contacts, or does not contact, a corresponding valve seat, which is defined by the turbine housing 108. The valve member acts to selectively sealingly engage the valve seat to selectively open and close the wastegate passage 136 so as to permit, or substantially prevent, exhaust gas flow through the wastegate passage 136. When the valve member sealingly engages the valve seat, the wastegate passage 136 is effectively closed and all exhaust gas which passes through the turbine inlet passage is expanded across the turbine wheel. When the valve member does not sealingly engage the valve seat, the wastegate passage 136 is at least partly open and at least a portion of exhaust gas which passes through the turbine inlet passage is not expanded across the turbine wheel and is instead diverted around the turbine wheel via the wastegate passage 136. The valve seat may therefore be described as defining an inlet of the wastegate passage 136, and specifically a cross-sectional area of the inlet of the wastegate passage 136.

The actuation rod 142 is a pneumatic actuator in the illustrated embodiment. In other embodiments the actuator may be hydraulic or electric. The actuator may be active or passive.

The turbine 101 is a wastegate turbine (as indicated by the actuation rod 142). However, in some embodiments described throughout this document the turbine may not incorporate a wastegate assembly. The turbine may be a variable geometry turbine.

FIG. 4 is a side cross sectional view of the turbocharger 100. FIG. 4 shows further features of the turbine dosing system 105 which forms part of the turbocharger 100.

The connection adapter 110 comprises the generally tapered interior surface 111 (e.g. a conical wall), whereat the cross sectional area of the interior of the connection adapter 110 increases, from the first end 115 to an opposing second end 120, along an axial extent of the connection adapter 110. The cross sectional area of the turbine outlet passage 116 may thus be said to diverge along the connection adapter 110. The second end 120 is the end of the connection adapter 110 which is furthest away from the turbine housing 108. The increasing cross sectional area defines a diffuser. As exhaust gas travels through the connection adapter 110, from the first end 118 to the second end 120, the velocity of the exhaust decreases, and the static pressure of the exhaust gas increases, owing to the cross sectional area of the turbine outlet passage 116 increasing. Increasing the static pressure of the exhaust gas in the connection adapter 110 increases the efficiency of the turbine wheel 101 because pressure recovery which is achieved by the connection adapter 110 allows for a greater pressure ratio across the turbine wheel and therefore an increase in the turbine wheel efficiency.

As shown in FIG. 4, the turbine wheel chamber 114 houses a turbine wheel 118. The turbine wheel 118 is configured to rotate about a turbine wheel axis 144. The turbine inlet passage 112 is in fluid communication with the turbine wheel chamber 114. The turbine wheel chamber 114 is in fluid communication with the turbine outlet passage 116.

In use, exhaust gas passes through the turbine inlet passage 112 and into the turbine wheel chamber 114. The exhaust gas is then expanded across the turbine wheel 118 (i.e. does work on the turbine wheel 118) which, in turn, drives rotation of the turbine wheel 118 about the turbine wheel axis 144. As exhaust gas passes over the turbine wheel 118, the magnitude of swirl and/or swirl direction of the exhaust gas changes. The turbine wheel 118 is a radial turbine wheel in that exhaust gas flow from the turbine inlet passage 112 impinges the turbine wheel 118 in a generally radial direction relative to the turbine wheel axis, and exits the turbine wheel 118 in a generally axial direction relative to the turbine wheel axis 144. As the exhaust gas exits the turbine wheel 118, and leaves the wheel chamber 114, it passes into the upstream portion 116a of the turbine outlet passage 116. In other embodiments, the turbine may be an axial turbine, whereby exhaust gas enters a turbine wheel in a generally axial direction and leaves the turbine wheel in a generally axial direction.

The turbine wheel 118 is supported for rotation about the turbine wheel axis 144 by a shaft 146. The shaft 146 extends from the turbine housing 108 to the compressor housing 104 through the bearing housing 106. The turbine wheel 118 is mounted to one end of the shaft 146 and a compressor wheel 148 is mounted on the other end of the shaft 146. The turbine wheel 118 may be mounted to the end of the shaft 146 by friction welding, laser welding, electron beam welding, or any other suitable method. The turbine wheel 118 and the compressor wheel 150 are therefore in power communication with one another. The shaft 146 rotates about the turbine wheel axis 144 on bearing assemblies 150 located in the bearing housing 106.

The turbine outlet passage 116 is defined by the turbine housing 108 and the connection adapter 110 in the illustrated embodiment. The cross sectional area of the turbine outlet passage 116 increases linearly from the most upstream end of the passage (i.e. proximate the turbine wheel 118) to the most downstream end of the passage (i.e. distal the turbine wheel 118), so as to define a diffuser.

A flow axis 145 is defined by the turbine outlet passage 116. The flow axis 145 is the (nominal) geometric centreline of the turbine outlet passage 116 as defined by the turbine housing 108 and the connection adapter 110. In this embodiment, and as will be appreciated from FIG. 6, the flow axis 145 is coincident with the turbine axis 144. However, in other embodiments, where the turbine outlet passage 116 is not a linear passage, i.e. the turbine outlet passage 116 may comprise a bend, the flow axis 145 will deviate away from the turbine wheel axis 144.

The turbine wheel 118 is visible in FIG. 4, and comprises a plurality of turbine blades 119. The turbine wheel 118 comprises an inducer 172 configured to receive exhaust gas flow 152a from the turbine inlet passage 112. The exhaust gas 152a is received in a radial direction relative to the turbine wheel axis 144. The turbine wheel 118 further comprises an exducer 174 configured to discharge the exhaust gas flow from the turbine wheel 118. The exhaust gas flow is discharged along a flow axis 145. The exducer 174 defines an exducer diameter 176. The exducer diameter 176 is the distance across the turbine wheel 118, in a plane normal to the turbine wheel axis 144, at downstream tips of the blades 119. A downstream end, or tip, of the turbine wheel 118 is labelled 178 in FIG. 4. In some embodiments the downstream end of the turbine wheel 118 may be defined by a wheel nut, the downstream end of the turbine wheel lying in a wheel nut plane. As will be described later in this document, the exducer diameter 176 can be used as a metric for defining the position of the dosing module 126 with respect to the wastegate passage outlet 138. In the illustrated embodiment the exducer diameter 176 is approximately 60 mm (e.g. 58 mm). The exducer diameter is preferably between around 30 mm and around 200 mm.

The cross sectional area of the upstream portion 116a of the turbine outlet passage 116 increases from the downstream end 178 of the turbine wheel 118. The cross sectional area increases linearly (i.e. the inner wall surface diverges at a constant angle). In other embodiments, the turbine outlet passage, or a portion thereof, may have a constant cross sectional area. In further embodiments, the turbine outlet passage may have a constant cross sectional area, and then the cross sectional area increases after a particular point along the flow axis. For example, the upstream portion of the turbine outlet passage, defined by the turbine housing, may be constant, and the downstream portion of the turbine outlet passage, defined by the connection adapter may have a cross sectional area that increases linearly.

In the illustrated embodiment, the interior surface 111 of the connection adapter 110 diverges linearly along the flow axis 145. In other embodiments, the interior surface 111 may diverge in a non-linear fashion. The angle of the divergence may be varied dependent upon the design conditions of each turbocharger. The divergence may be defined by an angle 121 by which inner wall surfaces 162a, 162b of a wall 162 of the connection adapter 110 are inclined relative to one another. The angle 121 may be described as a diffuser angle. The angle 121 is around 7.5° in the illustrated embodiment. The angle 121 is preferably between around 5° and around 20°. The angle 121 is preferably between around 6° and around 15°. The angle 121 is preferably between around 7° and around 10°. The wall 162 is an example of a structure which defines at least part of the turbine outlet passage 116. In other embodiments, the connection adapter 110 may define a constant cross-sectional area before diverging linearly along the flow axis 145.

The angle 121 thus defines a diffuser angle of the turbine outlet passage 116. In the illustrated embodiment, the diverging portion of the turbine outlet passage 116 extends continuously across both the upstream and downstream portions 116a, 116b of the turbine outlet passage 116 (e.g. as defined by the turbine housing 102 and the connection adapter 110). Described another way, the turbine outlet passage 116 diverges, at a constant angle, from an upstream point of the turbine outlet passage 116 (at the downstream end 178 of the turbine wheel 118) to at least a second end 335 of the connection adapter 110. Part of the divergence also extends further upstream of the downstream end 178 of the turbine wheel 118 into the wheel chamber 114. Part of the wheel chamber 114 thus diverges. In other embodiments, the diverging portion may be bound by the connection adapter 110 (e.g. not extend beyond the connection adapter 110).

As previously described, the connection adapter 110 comprises the dosing module mount 122. The dosing module mount 122 is integrally formed with the connection adapter 110 in the illustrated embodiment. In other words, the dosing module mount 122 and the connection adapter 110 are a unitary structure. Accordingly, the dosing module mount 122 and the connection adapter 110 may be manufactured by casting the single, combined structure. The dosing module mount 122 defines an opening 164 in the interior surface 111 of the connection adapter 110. The opening 164 may be described as a dosing aperture. Aftertreatment fluid is injected into exhaust gas through the opening 164. The location of the opening 164, with respect to the wastegate passage outlet 138, is a particular focus of the present invention. For completeness, the dosing module mount 122 may be incorporated as part of a turbine housing (e.g. a monoblock turbine housing), a connection adapter or a conduit.

The dosing module 126 is a self-atomising dosing module that it is configured to inject aftertreatment fluid from an outlet 166 of the dosing module 126 as a fine spray. The dosing module 126 is configured to inject aftertreatment fluid into a bulk exhaust gas flow 152b in the turbine outlet passage 116 downstream of the turbine wheel 118. Because the aftertreatment fluid is injected as a fine spray, there is no need for the aftertreatment fluid to be injected into a structure which promotes atomistaion of the aftertreatment fluid, such as a rotary dosing cup provided in the turbine wheel, before being mixed with the bulk exhaust gas flow 152b. The dosing module 126 injects aftertreatment fluid from the outlet 166 as a fine spray in a generally conical manner. A spray cone (of atomised aftertreatment fluid) is labelled 139.

Where the spray 139 meets the interior surface 111, a primary impingement zone is defined. It is desirable that at least the primary impingement zone of the interior surface 111 have some corrosion-resistant properties, owing to a risk of corrosion from byproducts of the aftertreatment fluid. For example, a sleeve made of corrosion-resistant material may be incorporated. Alternatively, or in combination, the connection adapter 110 may be manufactured from a corrosion-resistant material. Stainless steel is one example of a corrosion-resistant material. An entirety of the interior surface 111 may be covered in, or manufactured from, a corrosion-resistant material such as stainless steel. Other materials which are also resistant to corrosion may be utilised in place of, or in combination with, stainless steel.

In the illustrated embodiment the dosing module 126 is angled towards the flow axis 145 such that the dosing module 126 (specifically the outlet 166 thereof) points in a downstream direction (e.g. towards the second end 120 of the connection adapter 120, and away from the turbine wheel 118). Aftertreatment fluid expelled by the dosing module 126 is thus injected in a direction (slightly) with the flow. Given that the orientation of the dosing module 126 is defined by the dosing module mount 122, it follows that the dosing module mount 122 is also angled towards the flow axis 145 such that the opening 164 of the dosing module mount 122 points in a downstream direction. This orientation is desirable for reasons of a more predictable spray placement at a wider range of engine operating conditions.

It will, nevertheless, be appreciated that, in other embodiments, the dosing module 126 and dosing module mount 122 may be angled so that aftertreatment fluid is injected in a perpendicular direction relative to the flow axis 145 (e.g. in a radial direction). In further embodiments, the dosing module 126 and dosing module mount 122 may be angled so that aftertreatment fluid is injected in an upstream direction (i.e. towards the turbine wheel 118).

A minimum distance 180 between a centroid of the outlet 166 of the dosing module 126 (and, by virtue of concentric alignment, also a centroid of the opening 164 of the dosing module mount 122) and the flow axis 145 defines an outlet intersection point 182 along the flow axis 145. The outlet intersection point 182 marks the axial position of the opening 164, and outlet 166, along the flow axis 145.

Similarly, a minimum distance between a centroid 139 of the wastegate passage outlet 138 defines a wastegate passage intersection point 183 along the flow axis 145. The wastegate passage intersection point 183 marks the axial position of the wastegate passage outlet 138 along the flow axis 145.

An axial distance 185 between the outlet intersection point 182 and the wastegate passage intersection point 183, along the flow axis 145, defines a location of the dosing module 126 with respect to the wastegate passage outlet 138. The inventors have found that disposing the dosing module 126 proximate the wastegate passage outlet 138 gives rise to a number of advantages.

By locating the dosing module 126 within around 3 turbine outlet passage diameters, along the flow axis 145, of the wastegate passage outlet 138, the location at which aftertreatment fluid is injected into the turbine outlet passage 116 is positioned relatively close to the wastegate passage outlet 138. The aftertreatment fluid is thus injected into relatively high-energy exhaust gas flow, which has not been expanded across the turbine wheel 118. The aftertreatment fluid is also injected into a zone in which two high velocity gas streams (e.g. a turbine bulk flow 152b and a bypass flow 152c) merge. A high level of mixing is thus realised, the level of mixing being influenced by the momentum exchange of the two gas flows. By injecting the aftertreatment fluid near the wastegate passage outlet 138, the increased levels of mixing, in the aforementioned zone, facilitate the dispersal of aftertreatment fluid (specifically the reductant thereof) throughout the exhaust gas flow. The aftertreatment fluid is also subjected to high levels of relative velocities (i.e. gas velocity vs reductant droplet velocity), which increases the convective heat transfer to the droplet, in turn increasing decomposition. As a droplet traverses a high-mixing zone, it is exposed to many different local velocities that push, pull, & shear the droplet in different directions. This chaotic flow field (as can be indicated by a turbulent kinetic energy (TKE) metric) facilitates the mixing. The temperature of the bypass flow 152c is also comparatively higher than the turbine bulk flow 152b, owing to that the bypass flow 152c not having been expanded across the turbine wheel 118. The higher exhaust gas temperature promotes decomposition of the injected aftertreatment fluid by facilitating evaporation of the deionised water and the thermal decomposition of urea into constituent reductants.

The removal of harmful gases from the bulk exhaust gas flow 152b is thus promoted.

The inventors have found that the aforementioned advantages can be obtained by locating the dosing module 126 within around 3 turbine outlet passage diameters, of the turbine outlet passage 116 at the outlet intersection point 182, along the flow axis 145, of the wastegate passage outlet 138.

The distance between the downstream end 178 of the turbine wheel 118 and the intersection point 182 is approximately 2.4 exducer diameters (i.e. around 2.4 times the distance indicated by numeral 176) measured along the flow axis 145. The intersection point 182 is preferably up to around 3 exducer diameters downstream of the downstream end 178 of the turbine wheel 118, measured along the flow axis 145. The intersection point 182 may be between around 3 and around 7 exducer diameters, downstream of the downstream end 178 of the turbine wheel 118, measured along the flow axis 145. In other embodiments, the distance between the downstream end 178 of the turbine wheel 118 and the outlet intersection point 182 may be different. However, said distance is preferably no more than around 10 exducer diameters. The intersection point 182 may be at least 1 exducer diameter downstream of the downstream end 178 of the turbine wheel 118.

By locating the dosing module 126, and so dosing module outlet 166, relatively close to the turbine wheel 118, decomposition of the injected aftertreatment fluid, into reductants, for example ammonia (NH₃) and Isocyanic Acid (HNCO), (to support a downstream SCR reaction) is improved. This is because the distance between where aftertreatment fluid is injected and a downstream selective catalytic reduction (SCR) catalyst is increased, and hence the time available for decomposition before reaching the SCR catalyst is also increased, thereby increasing the amount of decomposition of the injected aftertreatment fluid. This is particularly advantageous when operating at relatively low exhaust gas temperatures, for example at engine start-up.

Decomposition is improved, at least in part, because the swirl of the bulk exhaust gas flow 152b, after being discharged from the turbine wheel 118, is greater than, for example, the exhaust gas significantly downstream of the turbine wheel (e.g. in a decomposition chamber). Regions within the exhaust gas flow, having a high turbulent kinetic energy (beneficial for promoting the mixing of aftertreatment fluid with the bulk exhaust gas flow, due to increased momentum exchange between the aftertreatment fluid and the bulk exhaust gas flow) are thus present, and greater in magnitude, owing to the proximity to the turbine wheel 118. The higher turbulent kinetic energy of the bulk exhaust gas flow also promotes droplet break-up of the injected aftertreatment fluid.

Increasing droplet break-up of aftertreatment fluid improves the uniformity of mixing of the aftertreatment fluid with the bulk exhaust gas flow and, in turn, increases decomposition of the aftertreatment fluid.

The temperature of the bulk exhaust gas flow 152b is also comparatively higher in proximity to the turbine wheel 118. The higher exhaust gas temperature promotes decomposition of the injected aftertreatment fluid by facilitating evaporation of the deionised water and the thermal decomposition of urea into constituent reductants. Decomposition is also promoted by way of higher convective heat transfer of the turbine bulk flow to the droplets of aftertreatment fluid.

The velocities of the bulk exhaust gas flow at the walls of the turbine outlet passage 116 are also higher closer to the turbine wheel 118 than at locations further downstream. The higher velocities generate comparatively high shear forces in these regions, and reduce the risk of aftertreatment fluid settling on the interior surface 111 (for example) which defines the turbine outlet passage 116. The risk of undesirable deposit build-up within the turbine outlet passage 116 is therefore also reduced. The comparatively high velocities of the turbine bulk flow also contribute to improved convective heat transfer to the aftertreatment fluid droplets.

The removal of harmful gases from the bulk exhaust gas flow 152b (e.g. the denoxification of exhaust gas) is thus promoted.

The placement of the dosing module 126, in proximity to the downstream end 178 of the turbine wheel 118, is thus advantageous in overcoming problems associated with: i) poor decomposition of the aftertreatment fluid due to low exhaust gas temperatures and/or low turbulent kinetic energy of the exhaust gas flow; ii) packaging considerations/constraints when locating the dosing module significantly downstream of the engine; iii) unwanted system backpressure due to the use of a traditional, downstream decomposition chamber, which can decrease the efficiency of an upstream engine; iv) aftertreatment deposit formation on any proximate interior surfaces; and v) high thermal mass of the downstream aftertreatment components (e.g. decomposition chamber) of a traditional system.

Also of note, in the illustrated embodiment the bypass flow 152c is discharged through the wastegate passage outlet 138 directly into a same region of the turbine outlet passage 116 that the aftertreatment fluid is injected into. The region may be referred to as a mixing zone, which is provided directly downstream of the turbine wheel 118. The mixing zone may extend across an entirety of the turbine outlet passage 116 normal to the flow axis 145. This is in contrast to, for example, an embodiment where a diffuser insert (e.g. an internal diffuser pipe, or secondary wall) may (axially) separate the primary impingement zone of the aftertreatment fluid from the bypass flow 152c (at least initially). For example, in such embodiments the bypass flow may initially flow around the diffuser insert and, only downstream of the diffuser insert, mix with aftertreatment fluid injected into an interior of the diffuser insert. In the illustrated embodiment the bypass flow 152c and aftertreatment fluid are directly introduced into the mixing zone directly downstream of the turbine wheel 118. This may also be described as a single skin (e.g. single wall) arrangement (i.e. no secondary wall, or diffuser insert, is present).

In the illustrated embodiment, the dosing module 126 is positioned such that the outlet 166 overlaps the wastegate passage outlet 138 along the flow axis 145. Furthermore, in the illustrated embodiment a centroid of the outlet 166 lies within the axial extent 137 of the wastegate passage outlet 138. The outlet intersection point 182 (indicating the position of the outlet 166 of the dosing module 126) thus lies within the axial extent 137 of the wastegate passage outlet 138. The centroid of the outlet 166 is also substantially axially aligned with the centroid 181 of the wastegate passage outlet 138 in the illustrated embodiment. It will be appreciated that in other embodiments the axial offset 185 between the dosing module 126 and the centroid of the wastegate passage outlet 138 may be greater, and up to within around 3 turbine outlet passage diameters along the flow axis 145.

Throughout the above description, it will be appreciated that the references to the position of the outlet 166 of the dosing module 126 also apply to the opening 164 of the dosing module mount 122. This is owing to the dosing module 126 being concentrically mounted to the dosing module mount 122. The outlet 166, and opening 164, may be said to share a centroid owing to the concentric alignment between the components.

The wastegate passage outlet 138 is circumferentially spaced from the outlet 166 about the flow axis 145. As also shown in FIG. 6, the wastegate passage outlet 138 is circumferentially spaced, by approximately 90 degrees around the flow axis 145, from the outlet 166 of the dosing module 126. In preferred embodiments the wastegate passage outlet 138 is circumferentially spaced from the outlet 166 of the dosing module 126, around the flow axis 145, by between around 30 degrees and around 110 degrees.

Returning to FIG. 4, the wastegate passage 136 is aligned such that a wastegate passage exhaust gas flow 152c (i.e. a bypass flow) exits the wastegate passage outlet 138, and enters the turbine outlet passage 116 (specifically the downstream portion 116b thereof), with a velocity which is generally tangential to the flow axis 145. This is also indicated in FIG. 6.

Turning to FIG. 5, a close-up view of part of the turbine dosing system 102 of FIG. 4 is shown. A number of annotations have been removed from FIG. 5, in comparison to FIG. 4, to aid understanding of the relative alignments of the dosing module 126 (e.g. the outlet 166 thereof, or the opening 164 of the dosing module mount 122) and wastegate passage outlet 138.

Briefly, FIG. 5 shows the minimum distance 180 between a centroid of the outlet 166 and/or the opening 164 and the flow axis 145. The outlet intersection point 182 is thus defined, and illustrated. A minimum distance between the centroid 181 of the wastegate passage outlet 138 and the flow axis 145 defines the wastegate passage intersection point 183.

The axial distance 185 between the outlet intersection point 182 and the wastegate passage intersection point 183, along the flow axis 145, defines the location of the dosing module 126 (specifically the outlet 166 thereof, and also the opening 164 of the dosing module mount 122) with respect to the wastegate passage outlet 138.

The outlet 166 is shown overlapping the axial extent 137 of the wastegate passage outlet 138. The outlet 166 is also substantially axially aligned with the centroid 181 of the wastegate passage outlet 138 by virtue of the axial distance 185 being less than around a major dimension (e.g. diameter) of the opening 164.

The elongate geometry of the wastegate passage outlet 138 (e.g. the aperture being letterbox-shaped) in the flow axis 145 direction, and the tangential introduction of the wastegate passage exhaust gas flow, advantageously generates comparatively high shearing forces in the wastage passage exhaust gas flow. The shearing forces are generated by virtue of a layer of comparatively high velocity exhaust gases proximate the interior surface 111. Such shearing forces are desirable for reasons of improved mixing of aftertreatment fluid with exhaust gas, and reduced risk of deposit build-up on the interior surface 111, particularly proximate a primary impingement zone (e.g. a surface generally opposite the outlet 166 of the dosing module 126, and bound by spray cone 139 in FIG. 4). The letterbox-shaped wastegate passage outlet 138 also means that the shearing forces are generated over a comparatively larger surface area (e.g. along the flow axis 145).

Although FIG. 5 shows the outlet 166 of the dosing module 126 substantially aligned with the interior surface 111, in other embodiments the outlet 166 (optionally a nozzle of the dosing module 126 in which the outlet 166 is provided) may protrude into the turbine outlet passage 116 (e.g. proud of the opening 164). Substantially aligned (i.e. substantially flush) is intended to mean that the outlet 166 is within around ±2 mm, along the dosing module axis 167, of the opening 164 in the interior surface 111. This advantageously reduces the risk that exhaust gas recirculates proximate the outlet 166 of the dosing module 126.

FIG. 6 is an end view of the turbocharger 100 from the turbine housing assembly 102 end.

An angle 311 between the dosing module axis 167 and the central axis 302 of the NOx sensor 128 (i.e. a circumferential offset between the dosing module 126 and the NOx sensor 128) is approximately 90 degrees in the illustrated embodiment (about the flow axis 145). The angle 311 is preferably between around 30 degrees and around 90 degrees. Similarly, an angle 313 between a wastegate passage outlet axis 309, which passes the through the centroid of the wastegate passage outlet 138, and the dosing module axis 167 (i.e. a circumferential offset between the centroid of the wastegate passage outlet 138 and the dosing module 126), is also approximately 90 degrees about the flow axis 145 in the illustrated embodiment. The angle 313 is preferably between around 45 degrees and around 110 degrees. An angle 315 between the wastegate passage outlet axis 309 and the central axis 302 of the NOx sensor 128 (i.e. a circumferential offset between the centroid of the wastegate passage outlet 138 and the NOx sensor 128) is approximately 180 degrees in the illustrated embodiment. The angle 315 is preferably between around 75 degrees and around 180 degrees. In the illustrated embodiment the dosing module 126 interposes the wastegate passage outlet 138 and the NOx sensor 128 circumferentially.

FIG. 6 also shows the wastegate passage exhaust gas flow 152c entering the turbine outlet passage 116 in a generally tangential direction. As indicated in FIG. 6, wastegate passage exhaust gas flow 152c swirls in a generally counterclockwise direction when viewed from an outer end of the connection adapter 110. This direction of swirl is the same direction as the swirl of the bulk exhaust flow 152b once expanded across the turbine wheel 118. As such, the wastegate passage exhaust gas flow 152c may be said to swirl in the same direction as the bulk exhaust flow 152b. The swirl direction may be described in relation to a direction in which the volute 113 extends, around the turbine wheel axis (which, in the illustrated embodiment, is coincident with the flow axis 145) towards the wheel chamber. Specifically, the exhaust gas flow swirls in the same direction as the volute 113 extends. The swirl direction of the bulk exhaust flow 152b may vary with engine operation condition. For example, in some operating conditions the bulk exhaust flow, or a portion of the bulk exhaust flow, may swirl in the opposite direction to that which the volute 113 extends. For example, at operating conditions whereby the turbine achieves a peak power output, the bulk exhaust flow may swirl in substantially the same direction as the volute 113 extends. Whereas, if the turbine is operating at a lower load condition, then a portion, or all, of the bulk exhaust flow may swirl in a direction which is opposite the direction in which the volute 113 extends. However, for the purposes of this document the swirl direction of the turbine bulk exhaust flow is referred to as a nominal swirl direction. The nominal swirl direction is the same direction in which the volute 113 extends, and the same direction in which the turbine wheel 118 rotates (or is rotatable in use).

FIG. 7 is a cross sectional end view of the turbocharger 100 taken from the plane A-A indicated in FIG. 4.

FIG. 7 illustrates that the NOx sensor 128 is axially upstream (i.e. closer to the turbine wheel 118) of the dosing module 126. This is for reasons of reducing the risk of aftertreatment fluid impinging upon the NOx sensor 128.

FIG. 7 illustrates how the dosing module mount 122 and the NOx sensor mount 124 are both integral with the connection adapter 110. In other words, the dosing module mount 122 and the NOx sensor mount 124 form a unitary structure with the connection adapter 110. In other embodiments, the dosing module mount 122 and/or the NOx sensor mount 124 may be formed from separate components which are subsequently connected to the connection adapter 110.

FIG. 7 also shows part of the wastegate passage 136, the valve member 140, and more of the path taken by the wastegate passage exhaust gas flow 152c. The valve member 140 is mounted within the turbine housing in the illustrated embodiment, but could be mounted within the connection adapter 110 in other embodiments.

FIG. 8 is a perspective view of a turbocharger 200 incorporating a wastegate turbine dosing system 202 according to another embodiment.

The turbocharger 200 comprises a compressor 204, a bearing housing 206 and the turbine dosing system 202. The bearing housing 206 interposes the compressor 204 and the turbine dosing system 202 such that each of the compressor 204 and the turbine dosing system 202 can be described engaging the bearing housing 206.

The turbocharger 200 shares many features in common with the turbocharger 100 described in connection with FIGS. 2-7. As such, only the differences will be described in detail.

The wastegate turbine dosing system 202 comprises a monoblock turbine housing 208. As such, there is no separate connection adapter like that described in connection with the turbocharger 100 of FIG. 2. Instead, the monoblock turbine housing 208 comprises a turbine inlet passage 210, a wheel chamber (not visible in FIG. 8) and a turbine outlet passage 212. Furthermore, each of the inlet passage 210, wheel chamber and turbine outlet passage 212 are defined by the same component (i.e. the monoblock turbine housing 208).

The turbine inlet passage 210 is defined by a volute 214, the volute 214 forming part of the monoblock turbine housing 208. The turbine outlet passage 212 is defined by an interior surface 216 of the monoblock turbine housing 208. As will be appreciated from FIG. 8, and as will be described in detail in connection with FIGS. 9 and 10, the turbine outlet passage 212 diverges so as to define a diffuser.

The wastegate turbine dosing system 202 further comprises a wastegate arrangement 218. The wastegate arrangement 218 comprises a valve assembly (not visible) and a wastegate passage 220. In use, the valve assembly is actuated by an actuation rod 222. The actuation rod 222 may be more appropriately described as an actuator. Of particular relevance in FIG. 8 is the wastegate passage 220.

In accordance with the terminology used throughout this document, the wastegate passage 220 refers to an enclosed volume through which bypassed exhaust gas may flow. As such, the specific component visible in FIG. 8 may be more accurately described as a wastegate channel, the wastegate channel defining the wastegate passage 220. As will be appreciated from FIG. 8, the wastegate passage 220 extends between the turbine inlet passage 210 and the turbine outlet passage 212. As such, the monoblock turbine housing 208 may be described as defining an entire wastegate passage 220. It will be appreciated that exhaust gas may be diverted around the turbine wheel chamber, so as to control the speed of the turbine wheel, by selectively opening the wastegate passage 220 so as to route a bypass flow from the turbine inlet passage 210 directly to the turbine outlet passage 212.

For completeness, the wastegate turbine dosing system 202 further comprises a dosing module 222 which is received in a dosing module mount 224. The dosing module mount 224 forms part of the monoblock turbine housing 208.

A downstream end of the wastegate passage 220 opens out into the turbine outlet passage 216 via a wastegate passage outlet 226. As will be appreciated from FIG. 8, the wastegate passage outlet 226 in the illustrated embodiment is elongate in a circumferential direction (e.g. extending part way around the interior surface 216 of the monoblock turbine housing 208).

The turbine dosing system 202 further comprises a NOx sensor 228, which is not a focus of the present invention.

Turning to FIG. 9, a perspective cross section view of the turbocharger 200 is provided. The bulk of the description in connection with the relative alignments of the dosing module 222 and the wastegate passage outlet 226 will be provided in connection with FIG. 10. However, FIG. 9 is included to show part of the geometry of the wastegate passage outlet 226.

FIG. 9 shows the turbocharger 200 in cross section with the turbine dosing system 202 and compressor 204 engaging the bearing housing 206. A shaft 230 extends through the bearing housing 206, the shaft 230 being supported for rotation about a turbine wheel axis 232. A turbine wheel 234 is mounted to a first end of the shaft 230, and a compressor wheel 236 is mounted to the other end of the shaft 230. In use, exhaust gas is expanded across the turbine wheel 234 to drive rotation of the compressor wheel 236.

A flow axis 238 extends from a downstream end of the turbine wheel 234 and occupies a geometric centreline of the turbine outlet passage 212. FIG. 9 also shows the turbine inlet passage 210 being provided upstream of a wheel chamber 239. The wheel chamber 239 is, in turn, in fluid communication with the turbine outlet passage 212.

FIG. 9 illustrates how the wastegate passage outlet 226 is generally rectangular and extends, in an elongate manner, in a circumferential direction around the flow axis 238.

FIG. 9 also shows the dosing module 222 mounted to the dosing module mount 224. The dosing module 222 comprises a nozzle 240. The nozzle 240 defines an outlet 242 of the dosing module 222. In the illustrated embodiment the nozzle 240 projects through an opening 244 defined in the interior surface 216 which defines the turbine outlet passage 212. As such, the outlet 242 of the dosing module 222 projects into the turbine outlet passage 212. FIG. 9 also schematically indicates a spray cone 246 produced by the dosing module 222. The spray cone 246 shows the geometry of the aftertreatment fluid as it is ejected from the dosing module 222. The region on the interior surface 216 which is bound by the spray cone 246 may be described as a primary impingement zone i.e. a zone which, in use, and in the absence of distortion by exhaust gas, would be contacted by the aftertreatment fluid spray. From FIG. 9 is will be appreciated that the schematically indicated spray cone 246 surrounds at least part of the wastegate passage outlet 226 (and preferably an entirety of the wastegate passage outlet 226).

As described above in connection with FIG. 4, it is desirable that at least the primary impingement zone 246 of the interior surface 216 have some corrosion-resistance properties, owing to a risk of corrosion from byproducts of the aftertreatment fluid. For example, a sleeve made of corrosion-resistant material may be incorporated. Alternatively, or in combination, the turbine housing 208 may be manufactured from a corrosion-resistant material. Stainless steel is one example of a corrosion-resistant material. An entirety of the interior surface 216 may be covered in, or manufactured from, a corrosion-resistant material such as stainless steel. Other materials which are also resistant to corrosion may be utilised in place of, or in combination with, stainless steel. Coatings and/or surface treatments may also be utilised to improve corrosion resistance.

Parameters which define the spray cone 246 include the cone angle, velocity of injected aftertreatment fluid and mass of aftertreatment fluid droplets (controlled, at least in part, by a diameters of the droplets).

Turning to FIG. 10, a cross section side view of part of the turbocharger 200, focusing on the turbine dosing system 202, is provided. The compressor, and parts of the bearing housing 206 and shaft 230, are obscured from view in FIG. 10. The turbine wheel 234, turbine wheel chamber 239 and turbine wheel axis 232 are all visible.

FIG. 10 is provided to illustrate more detail around the respective alignment of the dosing module 222 and the wastegate passage outlet 226. As described earlier in this document, owing to the concentric mounting of the dosing module 222 within the dosing module mount 224, a position of the outlet 242 of the dosing module 222, or specifically a centroid thereof, occupies the same axial position, along the flow axis 238, as the opening 244 (and specifically a centroid thereof). References to the alignment/position of the opening 244 therefore apply equally to the outlet 242 and vice versa.

Firstly, a centroid 248 of the wastegate passage outlet 246 is indicated. As will be appreciated from the combination of FIGS. 9 and 10, the centroid 248 is taken to lie along the interior surface 216 (specifically a portion of the interior surface 216 which is omitted owing to the presence of the wastegate passage outlet 226). Also indicated in FIG. 10 is an axial extent 250 of the wastegate passage outlet 226. An indicated minimum distance 252 between the centroid 248 of the wastegate passage outlet 226 and the flow axis 238 meets the flow axis at a wastegate passage intersection point 254. The wastegate passage intersection point 254 marks the axial position of the wastegate passage outlet 226 along the flow axis 238.

Similarly, a minimum distance 256 between the outlet 242 (optionally a centroid thereof) and the flow axis 238 meets the flow axis 238 at an outlet intersection point 258. The outlet intersection point 258 indicates the axial position of the outlet 242, and so dosing module 222 and/or the opening 244, along the flow axis 238. For reasons previously described it will also be appreciated that the outlet intersection point 258 also indicates the axial position of the opening 244, specifically a centroid thereof, defined by the dosing module mount 224, along the flow axis 238.

An axial distance 260 between the outlet intersection point 258 and the wastegate passage intersection point 254 is indicated in FIG. 10. For the reasons described in detail in connection with FIG. 4, it is advantageous to locate the dosing module 222 within around three turbine outlet passage diameters, taken at the outlet intersection point 258, along the flow axis 238 of the wastegate passage outlet 226. The advantages are described in detail in connection with FIG. 4 and will not be repeated here for brevity. As also described previously, an alternative way of defining the relative distance 260 is to specify that the dosing module 222 is located within around three exducer diameters of the wastegate passage outlet 226.

In the embodiment shown in FIG. 10 it will be appreciated that the axial distance 260 between the intersection points 258, 254 is greater than that shown in FIG. 4. The axial distance 260 is less than around half a diameter of the turbine outlet passage 212 when taken at the intersection point 258. Further, the outlet 242, and so the opening 244, are provided upstream, along the flow axis 238, of the wastegate passage outlet 226. The outlet 242 and/or opening 244 also do not axially overlap the wastegate passage outlet 226. It therefore follows that the outlet 242 and/or opening 244 are not located within the axial extent 250 of the wastegate passage outlet 226.

Although the embodiments shown in FIGS. 4 and 10 show the dosing modules being located in the same components as the wastegate passage outlet (the connection adapter and monoblock turbing housing respectively), it will also be appreciated that the dosing module and wastegate passage outlet may be provided across different (e.g. adjacent) components. Furthermore, one or more of the dosing module and the wastegate passage outlet may be provided as part of a downstream conduit which engages an outer end of the connection adapter or monoblock turbine housing. It will be appreciated that the advantages obtained from the relative axial positions of the wastegate passage outlet and the dosing module can be obtained regardless of which specific component the dosing module (mount) and/or wastegate passage outlet are provided as part of.

Like the embodiment shown in FIG. 4, in FIG. 10 the dosing module 222, and dosing module mount 224, are angled towards the flow axis 238 such that aftertreatment fluid is injected in a downstream direction (e.g. away from the turbine wheel 234). However, in other embodiments the dosing module 222 and dosing module mount 224 may be positioned perpendicular to the flow axis 238 (e.g. radially thereto), or be angled towards the flow axis 238 such that aftertreatment fluid is injected in an upstream direction (e.g. towards the turbine wheel 234).

Turning to FIGS. 11 and 12, two plots showing results from CFD simulations are provided. The plots indicate the variation of turbulent kinetic energy in a turbine system where a wastegate passage is closed (FIG. 11) and open (FIG. 12).

FIGS. 11 and 12 are taken as a cross section side views through a turbine system 300.

The turbine system 300 comprises a turbine inlet passage 302, wheel chamber 304 and an outlet passage 306. A wastegate passage 308 is also shown, the wastegate passage 308 being in fluid communication with the outlet passage 306 via a wastegate passage outlet 310.

In the FIG. 11 plot the wastegate passage 308 is closed. As such, all exhaust gas flow entering the turbine system 300 via the turbine inlet passage 302 exits via the outlet passage 306. FIG. 11 is indicative of an engine system operating at a low speed and low load condition (e.g. a steady state condition). FIG. 11 may otherwise be described as showing a nominal engine system operating condition/point.

FIG. 11 indicates that, downstream of the wheel chamber 304, the turbulent kinetic energy is relatively low (e.g. zone 312) until a region of higher turbulent kinetic energy begins at zone 314. It will be recalled that it is desirable to inject aftertreatment fluid into a region having a relatively high turbulent kinetic energy so as to improve mixing of reductant with the exhaust gas flow, among other advantages.

Turning to FIG. 12, the wastegate passage 308 is open. That is to say, a portion of exhaust gas flowing through the turbine inlet passage 308 is diverted around the wheel chamber 304 and enters the outlet passage 306 via the wastegate passage outlet 310. FIG. 12 is indicative of an engine system operating at a high speed and high load condition.

FIG. 12 indicates that, owing to the wastegate passage 308 being open, the turbulent kinetic energy is much higher in closer proximity to the wheel chamber 304. A region of high turbulent kinetic energy exists beginning from a zone 316, substantially in line with the wastegate passage outlet 310, and continues for a significant distance downstream. By injecting aftertreatment fluid into a zone of high turbulent kinetic energy, the advantages described elsewhere in this document may be readily obtained by virtue of utilising the high turbulent kinetic energy of an existing wastegate exhaust flow. The inventors have found that said zone (of high turbulent kinetic energy) exists within around three outlet passage diameters of the wastegate passage outlet 310. As otherwise mentioned, an alternative metric for use in defining this distance is within three exducer diameters of the wastegate passage outlet 310.

Outside of the aforementioned distances, the exhaust gas flow begins to stabilise and reduce in overall TKE (reducing the effectiveness of mixing of the aftertreatment fluid with exhaust gas, among other effects). Furthermore, any space claim within an engine system becomes more complicated the further away the dosing module is located from the turbine.

FIG. 13 is a side cross section view of a turbine dosing system 320 in accordance with an embodiment of the invention.

The turbine dosing system 320 comprises a dosing module 322 mounted to a dosing module mount 324, and a wastegate passage outlet 326 at a downstream end of a wastegate passage 328. A flow axis 330, which extends from a downstream end 332 of a turbine wheel 334 is also labelled. The flow axis 330 defines a geometric centreline of a turbine outlet passage 335.

A distance 336, along the flow axis 330, by which proximate edges of the wastegate passage outlet 326 and an opening 323 of the dosing module mount 324 are offset from one another is labelled. A distance 338, along the flow axis 330, by which centroids of the wastegate passage outlet 326 and the opening 323 of the dosing module mount 324 are offset from one another is also labelled. It will be appreciated that the position of the dosing module 322 is determined by the position of the dosing module mount 324 and, as such, the aforementioned references to the opening 323 of the dosing module mount 324 also apply to an outlet of the dosing module 322 (e.g. the distance 338 also indicates the separation between a centroid of the wastegate passage outlet 328 and a centroid of an outlet of the dosing module 322).

From FIG. 13 it will be appreciated that the opening 323 of the dosing module mount 324, and so outlet of the dosing module 322, is disposed, along the flow axis 330, within around three turbine outlet passage diameters 340, and around three exducer diameters 342, of the wastegate passage outlet 328. Advantageous effects of injecting aftertreatment fluid proximate the wastegate passage outlet 328 are thus obtained.

FIG. 13 also shows a spray cone 344 defined by aftertreatment fluid expelled from the dosing module 322. The spray cone 344, and so dosing module 322, also defines a primary impingement zone 346 (e.g. where the spray cone 344 meets the generally opposing wall). The primary impingement zone 346 is also advantageously located at least partially within, and preferably entirely within, around three turbine outlet passage diameters 340, and around three exducer diameters 342, of the wastegate passage outlet 328, along the flow axis 330.

FIG. 13 shows that the bypass flow (i.e. exhaust gas passing through the wastegate passage outlet 326) and the aftertreatment fluid (i.e. the spray cone 346) enter the turbine outlet passage 335 in generally the same direction. Described another way, an acute angle is defined therebetween.

It is desirable that at least the primary impingement zone 346 have some corrosion-resistant properties, owing to a risk of corrosion from byproducts of the aftertreatment fluid. For example, a sleeve made of corrosion-resistant material may be incorporated. Said sleeve is preferably incorporated so as to span, or cover, a joint line between the turbine housing and downstream conduit. Alternatively, or in combination, the illustrated turbine housing and/or downstream conduit may be manufactured from a corrosion-resistant material. Stainless steel is one example of a corrosion-resistant material. Other materials which are also resistant to corrosion may be utilised in place of, or in combination with, stainless steel. Coatings and/or surface treatments may also be utilised to improve corrosion resistance.

Turning to FIG. 14, part of a turbine dosing system 350 according to another embodiment is illustrated. The FIG. 14 view is a cross section view taken about the plane labelled 352 in FIG. 15.

FIG. 14 shows part of a monoblock turbine housing 354 with an exducer diameter 356 schematically indicated and part of a wastegate passage 358 also visible. Part of a dosing module mount 316 is also visible in FIG. 14.

The turbine dosing system 300 further comprises a downstream conduit 362 which is connected to the monoblock turbine housing 354. The downstream conduit 362 comprises a plurality of bends including a first bend (not visible in FIG. 14, but labelled 364 in FIG. 16) and a second bend 366. The term ‘bend’ is indicative of the downstream conduit changing direction. Owing to the presence of the wastegate passage 358, the turbine dosing system 300 may be described as a wastegate turbine dosing system. However, it will be appreciated that the advantages described below may also be obtained in a turbine dosing system which does not incorporate a wastegate (e.g. a fixed geometry turbine). It may be desirable to incorporate a corrosion-resistant sleeve (e.g. manufactured from stainless steel) at least at the first bend 364 (and preferably at the second bend 366) to reduce the risk of the downstream conduit 362 corroding due to byproducts of the aftertreatment fluid. Alternatively, or in combination, the turbine housing 354 and/or the downstream conduit 362 may be manufactured from stainless steel. Other materials which are also resistant to corrosion may be utilised in place of, or in combination with, stainless steel. Coatings and/or surface treatments may also be utilised to improve corrosion resistance.

Turing to FIG. 15, a side view of part of the turbine dosing system 350 is provided.

FIG. 15 shows the dosing module amount 360 forming part of the monoblock turbine housing 354. FIG. 15 also shows a wastegate channel 368 which defines the wastegate passage. In the illustrated embodiment the monoblock turbine housing 354 comprises a diverging portion 370. The diverging portion 370 may be described as a diffuser owing to the increase in cross sectional area. From FIG. 15 it will be appreciated that the dosing module mount is defined in the diverging portion 370. Similarly, the wastegate passage 368 has a downstream end disposed at the diverging portion 370. Part of the downstream conduit 362 is also visible in FIG. 15.

For the avoidance of doubt, many of the features of the turbine dosing system 350 correspond with the turbine dosing systems described earlier in this document. As such, only the differences will be described in detail in this section.

The plane labelled 372 in FIG. 15 indicates the position of a centroid of an opening of the dosing module mount 360. For completeness, the dosing module mount 360 is not illustrated as having an opening but, in practice, the dosing module mount 360 does incorporate an opening. The plane 372 therefore also indicates the position of a centroid of an associated outlet of a dosing module when mounted to the dosing module mount 360 (dosing module not shown in FIG. 15). In the illustrated embodiment the position of the plane 372 is around two exducer diameters downstream of a downstream end of the turbine wheel along the flow axis. This will be described in more detail below.

FIG. 16 is a cross section side view of part of the turbine dosing system 350. Although not shown in FIG. 16, a turbine wheel is provided just out of view at the left hand side of the Figure. Described another way, a left hand ledge of FIG. 16 begins at a downstream end of a turbine wheel.

FIG. 16 shows a flow axis 374 which extends from a downstream end of the turbine wheel. The flow axis 374 indicates a geometric centrepoint of a turbine outlet passage 376. The turbine outlet passage 376 is defined, in the illustrated embodiment, by a combination of the monoblock turbine housing 354 and the downstream conduit 362. As described above, a centroid of an opening of the dosing module mount 360 is disposed around two exducer diameters downstream of the downstream end of the turbine wheel. FIG. 16 also shows the first bend 364 as defined by the downstream conduit 362. It will therefore be appreciated that the dosing module mount 316 is disposed upstream of the first bend 364 in this embodiment.

The increase in cross sectional area of the turbine outlet passage 376, in the diverging portion 370, is also shown in FIG. 16. The cross-sectional area of the turbine outlet passage 376 becomes constant downstream of the diverging portion 370.

The monoblock turbine housing 354 may be connected to the downstream conduit 362 by way of, for example, V-band clamps which are secured over corresponding half-marmon flanges 355, 357. A joint line 359, between the monoblock turbine housing 354 and the conduit 362, is also schematically indicated in FIG. 15.

Although FIG. 16 does not show an opening of the dosing module mount 360 in communication with the turbine outlet passage 376, this is only owing to FIG. 16 being a schematic indication of the turbine dosing system 350 geometry. As mentioned above, an opening defined by the dosing module mount 360 would, in practice, extend into the turbine outlet passage 376 (such that aftertreatment fluid can be injected by a dosing module, mounted to the dosing module mount, into the turbine outlet passage 376).

For reasons that will be described in detail in connection with the following figures, a number of advantageous effects are obtained by positioning a dosing module within around 5 exducer diameters of a downstream end of the turbine wheel. Specifically, these advantages relate to the turbulent kinetic energy (TKE) of the exhaust gas flow through the turbine outlet passage 376 and also the presence of a high velocity peripheral layer (HVPL) of exhaust gas.

Turing to FIG. 17, a plot showing the TKE of an exhaust gas flow, obtained using a computational fluid dynamics (CFD) simulation, is provided. The FIG. 17 view corresponds largely with the view shown in FIG. 16, although in FIG. 17 a downstream end of a 380 of a turbine wheel 382 is visible. Also shown in FIG. 17 is the flow axis 374 which extends from the downstream end 380 of the turbine wheel 382.

FIG. 17 shows the relative magnitude of TKE of the exhaust gas flow in a turbine outlet passage 376 when the wastegate is closed. That is to say, all of the exhaust gas flow entering a turbine inlet passage is expanded across the turbine wheel 382, flowing through the associated turbine wheel chamber, and flows through the turbine outlet passage 376.

FIG. 17 is annotated to indicate exducer diameters 378a, 378b etc. extending along the flow axis 374 from the downstream end 380 of the turbine wheel 282. That is to say, the distances labelled 378a, 378b are as ‘long’ as the exducer diameter 378, but extend in the same direction as the flow axis 374. Much of the following description will refer to distances downstream of the downstream end 380 of the turbine wheel 382 in terms of the number of exducer diameters.

FIG. 17 indicates that there is a generally conical shaped region 384 of high TKE which increases, in cross section, moving away from the downstream end 380 of the turbine wheel 382. This is owing, at least in part, to the diverging nature of the turbine outlet passage 376 in a diverging portion 370. As exhaust gas leaves the turbine wheel 382, at an exducer thereof, the exhaust gas expands along the turbine outlet passage 376. This creates a highly dynamic flow field which contributes to the high levels of TKE experienced downstream of the turbine wheel 382.

As mentioned above, a region of high TKE 384 is generally conical shaped (see also FIG. 18). The region of high TKE extends from around 0.5 exducer diameters downstream 380 of the turbine wheel 382. A region of high TKE reduces to a medium level of turbulent kinetic energy at a downstream position of around 5 exducer diameters from the downstream end 380 of the turbine wheel 382. It will be appreciated, from FIGS. 17 and 18, that a region of comparatively low turbulent kinetic energy 386 exists around an outer periphery of the turbine outlet passage 376.

The reason for the TKE level being comparatively lower in the region 386 is because the flow fields of the exhaust gas flowing through the turbine outlet passage 376 are more uniform (and so less dynamic and chaotic) proximate the walls which define the turbine outlet passage 376. Described another way, the exhaust gas proximate the walls is guided by the walls, resulting in lower TKE.

FIG. 17 also indicates a further region 388 of a comparatively low TKE, at a first bend 364 in the turbine outlet passage 376 (as defined by the downstream conduit 362). It has been found that the energy within the exhaust gas flow, with the TKE being indicative of said energy, generally reduces following a change of direction of the flow. As such, the energy in the flow is generally dissipated at, or just after, the first bend 364. It is therefore desirable to locate the dosing module upstream of the first bend 364 (if there is a bend present) so that aftertreatment fluid is injected into a higher energy flow. In some embodiments, a first bend, or elbow, may be located around 200 mm downstream from the downstream end of the turbine wheel.

From FIG. 17 it will be appreciated that it is desirable to locate the dosing module with around 5 exducer diameters downstream of the downstream end 380 of the turbine wheel 382, such that aftertreatment fluid be injected into a zone, of the exhaust gas, which has a comparatively high TKE. This is desirable for reasons of increased convective heat transfer, and improved natural mixing of the exhaust flow with the aftertreatment fluid. It is preferable that the dosing module be located between around 0.5 and around 5 exducer diameters downstream of the downstream end 380 of the turbine wheel 382. This has been found to be a region which has a particularly high TKE. In further embodiments, it is desirable to locate the dosing module between around 1 and around 3 exducer diameters downstream the downstream end 380 of the turbine wheel 382.

Turning to FIG. 18, a cross section view of a TKE plot is provided normal to the flow axis 374. The FIG. 18 cross section is taken about the plane labelled 372 in FIG. 15. That is to say, the FIG. 18 plot is taken about a centroid of an opening of the dosing module mount 360.

As described above, a region of high TKE 384 is indicated proximate the flow axis and extends across a majority of the turbine outlet passage 376. A region of comparatively lower TKE 386 exists around a periphery of the turbine outlet passage 376. FIG. 18 also indicates the relative TKE in the wastegate passage 358. It will be recalled that FIGS. 17 and 18 show the relative TKE of the exhaust gas flow when the wastegate is shut. As such, it follows that the TKE level in the wastegate passage 358, as shown in FIG. 18, is comparatively low. This is owing to the fact that there is no exhaust gas being actively bypassed around the turbine wheel through the wastegate passage 358.

Turning to FIG. 19, a plot of TKE as a function of the downstream position, in exducer diameters, of a downstream end of the turbine wheel is provided for three different turbine dosing system concepts.

On the X axis 390, gridlines indicate how many exducer diameters downstream of a downstream end of the turbine wheel the TKE is taken at. As mentioned, there are three different turbine dosing concepts: F6, F2 and B8. FIGS. 17 and 18 correspond with the B8 concept. On the Y axis 392, a relative level of TKE of the flow, at the given position downstream of the turbine wheel, is indicated. On the plot the F6 concept is labelled 394, the F2 concept is labelled 396 and the B8 concept is labelled 398. The FIG. 19 plot indicates the TKE at the given downstream position when the wastegate is closed.

FIG. 19 indicates that, across the three different dosing concepts, there is an initial drop in the level of turbulent kinetic energy up until around 0.5 exducer diameters from the downstream end of the turbine wheel. This is roughly indicated 400 in FIG. 19. A region of highest TKE falls at around 2 exducer diameters downstream of the downstream end of the turbine wheel for each of the three concepts. Although the plot only shows up to 4 exducer diameters in position, the inventors have found that the region of elevated TKE extends up until around 5 exducer diameters downstream of the downstream end of the turbine wheel.

Turning to FIG. 20, a further plot is provided, which generally corresponds with that shown in FIG. 19, but for a wastegate open condition. As will be appreciated from the plot at FIG. 20, the B8 concept 398 has a generally lower TKE across all points in comparison to the F6 and F2 concepts 394, 396.

The TKE is at a generally highest level between around 1.5 and around 2 exducer diameters for each of the turbine dosing concepts. In particular, a region falling between around 1 exducer diameter and around 3 exducer diameters generally captures the downstream position of the highest levels of TKE.

When FIGS. 19 and 20 are considered in combination, the following conclusions can be drawn. The TKE is at a highest level, for a wastegate open condition (i.e. FIG. 20) between around 1.5 and around 2 exducer diameters downstream of the downstream end of the turbine wheel. For a wastegate closed condition (i.e. FIG. 19) the TKE is at a highest level around 2 exducer diameters downstream of the downstream end of the turbine wheel. For both wastegate open and wastegate closed conditions (i.e. FIGS. 19 and 20) a zone of elevated TKE exists from between around 0.5 exducer diameters to around 5 exducer diameters downstream of a downstream end of the turbine wheel.

Turning to FIG. 21, a plot showing the variation of TKE through a cross section of part of the turbine dosing system 350 is provided. The FIG. 21 plot is shown in a wastegate open condition i.e. not all of the exhaust gas which enters the turbine inlet passage is expanded across the turbine wheel 382.

As is to be expected, when the wastegate is open the TKE across the turbine outlet passage 376 is generally lower. As such, up until around 2.5 exducer diameters from the downstream end 380 of the turbine wheel 382, the TKE remains relatively low, or between low and medium in magnitude. That is, other than for a region 402 of high TKE at a wastegate passage outlet whereby the wastegate passage opens out into the turbine outlet passage 376. There are regions of medium to high TKE between around 1.5 exducer diameters and around 5 exducer diameters from the downstream end 380 of the turbine wheel 382.

Turning to FIG. 22, a cross section view of the FIG. 21 plot is provided about the plane labelled 372 in FIG. 15. FIG. 22 indicates the majority of the turbine outlet passage 376 to contain exhaust gas at a relatively low TKE, but that in the wastegate passage, and proximate the wastegate passage, a region 402 of comparatively higher TKE is present.

Turning to FIG. 23, a plot showing relative TKE levels downstream of a turbine wheel for another embodiment of turbine dosing system 404 is provided. A flow axis 406 is annotated, along with an exducer diameter 408 of a turbine wheel 410. The downstream end 412 of the turbine wheel 410 is visible in FIG. 23.

FIG. 23 indicates that a region of high TKE exists at just over 1 exducer diameter downstream of a downstream end 412 of the turbine wheel 410.

Also labelled in FIG. 23 is a conical spray pattern 414 which, in use, is defined by a dosing module (not shown in FIG. 23). The conical spray pattern indicates part of a trajectory taken by atomised aftertreatment fluid upon expulsion from the dosing module. It will be appreciated that it may be desirable that the spray cone 414 at least partially overlap part of a high TKE zone for reasons of improved mixing and decomposition. Although not labelled, a primary impingement zone (defined by where the spray cone 414 meets the generally opposing wall) may also advantageously at least partially overlap a high TKE zone. For example, it may therefore be preferable that the spray cone 414 and/or primary impingement zone defined by a dosing module is at least partly provided within around 5 exducer diameters downstream of a downstream end 412 of the turbine wheel 410. In preferred embodiments, an entirety of the primary impingement zone may be provided within a high TKE zone (e.g. within around 5 exducer diameters downstream of a downstream end 412 of the turbine wheel 410).

Injecting aftertreatment fluid into a region of comparatively high TKE is desirable for various aforementioned reasons including an improved uniformity index (indicative of the level of mixing of aftertreatment fluid with the exhaust gas flow).

Briefly, FIG. 23 also schematically indicates an opening 416 through which aftertreatment fluid is dispersed. The opening 416 is defined in a projecting ledge 418, which may be referred to as a ‘doghouse’. The presence of the projecting ledge 418, specifically an internal surface thereof (which defines part of a turbine outlet passage 419), creates a localised recirculation zone 421 (e.g. an undercut). This is undesirable for reasons of i) increased turbulence of the exhaust gas flow in this region; and ii) the presence of recirculation zones which reduce the extent to which aftertreatment fluid is dispersed throughout the flow near the expulsion location, potentially leading to aftertreatment fluid adhesion to the nozzle surface, creating nozzle deposits, which interferes with proper atomisation from the nozzle. The projecting ledge 418 may be omitted in some embodiments and exchanged for a dosing module mount like that shown in, for example, FIG. 5.

Finally, FIG. 23 also shows a shield 420 which forms part of the turbine dosing system 404. This shield 420 is preferably manufactured from stainless steel or an alternative corrosion-resistant material. The shield 420 is disposed downstream of the turbine wheel 410 and provides a shielding surface between the spray cone 414 (of aftertreatment fluid) and an inner surface of the turbine housing. The shield 420 is a sacrificial component of sorts, which seeks to protect the surrounding surface from corrosion due to byproducts formed as part of the decomposition process of aftertreatment fluid. In other embodiments the shield 420 may be omitted and instead the primary impingement zone may be defined on an inner surface of the turbine housing. The shield 420 may be described as shoehorn-like in geometry. Advantageously, the shield 420 may be positioned so as to reduce the risk of aftertreatment fluid entering a wastegate passage (e.g. the shield 420 may at least partially, and preferably entirely, cover a wastegate passage outlet [whilst still providing a clearance to allow bypass exhaust gas to exit the wastegate passage outlet]). The shield 420 may be exchanged for an alternative corrosion-resistant liner, or sleeve, (e.g. manufactured from stainless steel) provided at the primary impingement zone. The components (e.g. turbine housing, connection adapter and/or downstream conduit) in which the primary impingement zone is defined may also be manufactured from corrosion-resistant materials (e.g. stainless steel) to reduce the risk of corrosion. Other materials which are also resistant to corrosion may be utilised in place of, or in combination with, stainless steel. Coatings and/or surface treatments may also be utilised to improve corrosion resistance.

Turning to FIG. 24, an alternative plot is provided in connection with the turbine dosing system 350 illustrated in FIGS. 17 and 18. Whereas previous Figures indicated the distribution of TKE in the exhaust gas flow, the following Figures indicate the distribution, and magnitude, of velocity of exhaust gas.

FIG. 24 indicates that there is a region of high velocity exhaust gas flow close to the outer periphery of the turbine outlet passage 376, up to around 3 exducer diameters downstream of the turbine wheel 382. This region of high velocity exhaust gas may otherwise be described as a high velocity peripheral layer HVPL. As well as the HVPL 422, there exists a region of low velocity exhaust gas around the flow axis 374. Said region 424 generally extends from the downstream end 380 of the turbine wheel 382 and is generally conical shaped in that a diameter of the region 424 increases moving in a direction downstream of the turbine wheel 382. The HVPL 422 extends until around 3 exducer diameters downstream of the turbine wheel 382, where the HVPL dissipates in the region 426. In the region 426, there is less of a differential between the velocity of the exhaust gas at the periphery of the turbine outlet passage 376 and a slightly inboard region towards the flow axis 374. Put another way, a velocity gradient between the regions reduces.

For the avoidance of doubt, FIG. 24 shows exhaust gas velocities when a wastegate is in a shut, or closed, condition. FIGS. 28 and 29 show the distribution of velocity when the wastegate is open.

Turning to FIG. 24, injecting aftertreatment fluid into the HVPL is advantageous for reasons of improved decomposition speed and increased convective heat transfer. Further, a shearing effect, owing to the difference in velocities, is also advantageous in reducing droplet sizes (which further improves decomposition speed). As will be appreciated from FIG. 24, the HVPL is at least partly present up until around 5 exducer diameters downstream of the downstream end 380 of the turbine wheel 382. At this approximate region, there is even less contrast between the velocity of exhaust gas at the periphery of the turbine outlet passage 376 and the flow proximate the flow axis 374. Shearing forces generated by the comparatively high moving exhaust gases in this region are also desirable for reasons of reducing the risk of deposit build-up in at least the primary impingement zone.

It will therefore be appreciated that it is desirable to provide a dosing module within around 5 exducer diameters of the downstream end 380 of the turbine wheel 382, so as to obtain the aforementioned advantages in connection with injecting aftertreatment fluid into the HVPL.

Turning briefly to FIG. 25, a plot showing the distribution of velocity of exhaust gas flow at a plane labelled 372 in FIG. 15 is provided. FIG. 25 shows the region of lower velocity exhaust gas 424 and the surrounding HVPL 422. It will also be appreciated that the velocity of exhaust gas flow is very low in a wastegate passage 358 (as is to be expected when the wastegate is shut).

Turning to FIG. 26, a plot showing the variation of velocity magnitude of exhaust gas flow as a function of the downstream distance from a downstream end of the turbine wheel (in exducer diameters) is provided for three different turbine dosing systems. FIGS. 24 and 25 correspond with the F6 concept. An F6 concept is labelled 432, F2 434 and B8 436. FIG. 26 shows the variation of velocity magnitude as a function of the downstream distance when the wastegate is closed. As will be appreciated from FIG. 26, the velocity magnitude generally decreases moving downstream from the turbine wheel. Beyond a downstream distance of around 5 exducer diameters from the turbine wheel, the variation of velocity magnitude (indicated by a gradient of the plot) reduces to a near-constant level.

FIG. 27 is a plot showing the variation of velocity magnitude with respect to the downstream position of the turbine wheel for each of the three turbine dosing systems shown in FIG. 26. The FIG. 27 plot corresponds to a wastegate open condition.

FIG. 27 indicates there is a spike in velocity magnitude between around 2 and around 3 exducer diameters downstream of the downstream end of the turbine wheel. This is attributable, at least in part, to the wastegate passage outlet being located between around 2 and around 3 exducer diameters downstream of the downstream end of the turbine wheel (e.g. the re-entry point of the bypass exhaust gas flow is in the same region as the spike). Furthermore, there is a further increase just beyond around 4 diameters downstream of the turbine wheel.

The following conclusions may be drawn from FIGS. 26 and 27:
Where the wastegate is open (FIG. 27) the velocity is greatest between around 2 and around 3 exducer diameters downstream of the downstream end of the turbine wheel;
Where the wastegate is closed (FIG. 26), the velocity magnitude reduces in a generally linear manner from the downstream end of the turbine wheel (where the velocity magnitude is greatest); and
The HVPL dissipates at around 2.5 exducer diameters downstream of the turbine wheel when the wastegate is closed, and around 5 exducer diameters downstream of the turbine wheel when the wastegate is open.

By injecting aftertreatment fluid within around 5 exducer diameters of the downstream end of the turbine wheel, the advantageous effects associated with the HVPL can thus be obtained. It is therefore desirable to locate the dosing module such that it lies within a region, downstream of the turbine wheel, where the HVPL is present.

Turning to FIG. 28, a plot showing the variation of velocity of exhaust gas in the turbine dosing system 350 illustrated in FIGS. 24 and 25 is provided. The FIG. 28 plot differs from the aforementioned plots in that, in FIG. 28, the wastegate is open.

The HVPL 422 is also visible in FIG. 28, and is generally greater in magnitude than in the earlier Figures. Furthermore, a concentrated region 438 of high velocity exhaust gas is present proximate a wastegate passage opening where the wastegate passage opens out into the turbine outlet passage 376. The HVPL extends a comparatively greater distance downstream of the turbine wheel 382 owing to the re-entry of bypassed exhaust gas. Like in the earlier embodiments, the HVPL extends for at least around 5 exducer diameters downstream of the downstream end 380 of the turbine wheel 382. A region 440 of comparatively lower velocity exhaust gas is also present proximate the flow axis 374 and downstream of the wastegate passage opening.

Turning to FIG. 29, the view of the plot of FIG. 28 about a plane labelled 372 in FIG. 15 is provided. FIG. 29 indicates the region 438 of high velocity exhaust gas proximate the wastegate passage 358. Also visible is the HVPL 422 extending around the turbine outlet passage 376. Finally, the lower velocity zone 440, proximate the flow axis, is also shown.

Turning to FIG. 30, a plot indicating the variation of velocity magnitude in the turbine dosing system 404 (as previously described in connection with FIG. 23) is provided.

FIG. 30 illustrates how the velocity magnitude remains relatively high for around 1 exducer diameter downstream of the downstream end 412 of the turbine wheel 410. Furthermore, FIG. 30 indicates that there is a medium to high velocity level for around 1.5 exducer diameters downstream of the turbine wheel 410. Again, and as described in connection with FIG. 23, as well as locating the dosing module within around 5 exducer diameters of the downstream end 412 of the turbine wheel 410, so as to obtain the advantages associated with a HVPL, it is also desirable that a primary impingement zone, as defined by the spray cone 414 of a dosing module, at least partly overlap the HVPL (e.g. be provided within around 5 exducer diameters downstream of the downstream end 412 of the turbine wheel 410).

As described in connection with FIG. 23, the shield 420 is also shown in FIG. 30.

For the reasons described above, locating a dosing module (and so dosing module mount) within around 5 exducer diameters downstream of a downstream end of a turbine wheel means that advantageous effects, associated with a high TKE zone and a HVPL, are obtained. In some embodiments, the dosing module may be located between around 0.5 and around 5 exducer diameters, between around 1 and around 3 exducer diameters, and within around 3 exducer diameters downstream of the downstream end of the turbine wheel. It will be appreciated that a primary impingement zone, defined by the dosing module, may also be located at least partly within, and optionally entirely within, the aforementioned distances downstream of the downstream end of the turbine wheel.

Turning to FIG. 31, a schematic cross section side view of part of a turbine dosing system 450 according to another embodiment as illustrated.

The turbine dosing system 450 shares many features in common with the turbine dosing systems described earlier in this document, and only the differences will be described in detail here.

FIG. 31 shows a diverging portion 452 of a turbine outlet passage 454. Diverging portion 452 may otherwise be described as a diffuser owing to the increase in cross sectional area from a first, upstream end 456 to a second, downstream end 458. In the illustrated embodiment the diverging portion 452 diverges at a constant angle (e.g. at least around) 10° between the first and second ends 456, 458. However, in other embodiments the divergence may not be a constant angle (i.e. it may be nonlinear) and may be less than around 10°. Also shown extending downstream of the second end 458 of the diverging portion 452 is a downpipe 460. The downpipe 460 has a constant cross sectional area in the illustrated embodiment. The diverging portion 452 may be said to create a high recirculation zone of exhaust gas passing therethrough.

Arrows 462a, 462b, 462c indicate the direction of a turbine bulk flow from an upstream turbine (not shown in FIG. 31) through the illustrated part of the turbine dosing system 450.

Of particular relevance in connection with the present embodiment is the incorporation of a lance dosing module 464. The lance dosing module 464 differs from the dosing modules previously described and illustrated, earlier in this document, because, instead of being peripherally mounted and injecting across the turbine outlet passage 454, the lance dosing module 464 instead projects into the turbine outlet passage 454. Only part of the lance dosing module 464 is shown in FIG. 31. Specifically, a conduit 466, which forms part of the lance dosing module 464, is shown. However, it will be appreciated that there may be further constituent components, which form part of the lance dosing module 464, which are not shown (e.g. a reductant tank, pumping/metering means etc.).

The conduit 466 projects into the turbine outlet passage 454 and extends towards a flow axis 468 of the turbine outlet passage 454. However, in the illustrated embodiment the conduit 466 does not extend to the flow axis 468. Instead, the conduit 466 only extends part way towards the flow axis 458. However, in other embodiments the conduit 466 may extend to the flow axis 468 and at least part of the conduit 466 may be coaxial with the flow axis 468.

The conduit 466 comprises an outlet 470. It is the outlet 470 through which aftertreatment fluid is expelled. The outlet 470 may be described as an outlet of both the conduit 466 and also the lance dosing module 464 generally. As indicated schematically by the triangular geometry 472, the conduit 466, and lance dosing module 464 generally, defines a spray cone 472 of aftertreatment fluid. Accordingly, the aftertreatment fluid 472 is mixed with exhaust gases (e.g. 462a) passing through the diverging portion 452 of the turbine outlet passage 454.

Arrows 474a, 474b generally indicate a swirling of the exhaust gas flow 462a as it is expanded across the diverging portion 452. Advantageously, by having the conduit 466 project into the turbine outlet passage 454, specifically the diverging portion 452 thereof, the aftertreatment fluid 472 is injected into a zone of exhaust gas which has a high level of recirculation (as indicated by the arrows 474a, 474b). As such, there is an inherent turbulence of the exhaust gas flow which provides a number of advantages associated with the injection of aftertreatment fluid. Firstly, the aftertreatment fluid is more thoroughly mixed with the exhaust gas 462a, which gives rise to a high decomposition rate of the aftertreatment fluid (which is beneficial for reasons of reduced harmful emissions from the exhaust). This is at least in part due to increased heat transfer to the aftertreatment fluid whilst ‘trapped’ in this zone. Secondly, the risk of deposit build-up (e.g. chalky deposits resulting from the stagnation of aftertreatment fluid) is also reduced owing to the turbulence of the flow. The risk of deposits is further reduced because of the nature of the injection of the aftertreatment fluid. Specifically, because the aftertreatment fluid 472 is generally injected along the flow axis 468, as opposed to across the flow axis 468, a primary impingement zone defined by the spray cone 472 generally does not overlap an internal wall of the turbine outlet passage 454. Put another way, the aftertreatment fluid injected by the outlet 470 is more likely to mix thoroughly with the exhaust gas 462a and thus be carried downstream (e.g. towards arrows 462b, 462c) rather than building up within the turbine outlet passage 454 (which may risk the build-up of deposits). This is further assisted by the downstream direction in which the outlet 470 injects the aftertreatment fluid 472 within the diverging portion 452 of the turbine outlet passage 454.

The residence time of the aftertreatment fluid within the turbine outlet passage 454 is also increased owing to the recirculation of exhaust gas in the diverging portion 452. As the aftertreatment fluid droplets are ‘trapped’ in the recirculation zone (e.g. the diverging portion 452) for longer, comparatively more heat is transferred to the droplets (in comparison to scenarios where there is less recirculation). The urea in the aftertreatment fluid is therefore decomposed more thoroughly, and as the gaseous NH₃ and HNCO is produced (by virtue of the decomposition of urea) this gas is mixed with exhaust gases passing through the turbine outlet passage 454. The gaseous NH₃ and HNCO products are therefore more thoroughly mixed with the exhaust flow.

As previously mentioned, FIG. 31 shows only part of the turbine dosing system 450 in a schematic illustration. The diverging portion 452 may, for example, form part of a connection adapter, a monoblock turbine housing (e.g. as shown in FIG. 9), or a downstream conduit (i.e. a conduit which engages a connection adapter or a monoblock turbine housing).

The first end 456 of the diverging portion 452 may be provided directly downstream of a wheel chamber which contains a turbine wheel. The downpipe 460 may be connected to the second end 458 of the diverging portion 452 by, for example, engagement of respective flanges which are secured using a V-band clamp. Alternatively, the diverging portion 452 and downpipe 460 may be integral with one another (i.e. a single component).

The outlet 470 of the lance dosing module 464 is preferably located within around 5 exducer diameters, along the flow axis 468, of a downstream end of the turbine wheel. Such a position has been found to provide desirable flow characteristics which are advantageous for reasons of decomposition of the aftertreatment fluid in the exhaust gas flow and a reduced risk of deposit formation. Deposits may include crystallised aftertreatment fluid which has not evaporated as intended (e.g. due to temperatures and/or heat transfer being too low). Deposits are undesirable for reasons of causing problems for fluid flow generally and material damage in the aftertreatment system, as well as performance degradation of the aftertreatment system.

Turning to FIG. 32, a cross section side view of a part of a turbine dosing system 480 according to another embodiment is illustrated. The turbine dosing system 480 comprises a turbine housing assembly 481 which comprises a connection adapter 482 and a turbine housing 484 (only part of which is shown in FIG. 32). The turbine dosing system 480, like the turbine dosing system 450 shown in FIG. 31, comprises a lance dosing module 486 which comprises a conduit 488. The conduit 488, and so the lance dosing module 486 generally, inject aftertreatment fluid into exhaust gas via an outlet 490.

The conduit 488 projects into a turbine outlet passage 492 defined by the connection adapter 482. The conduit 488 projects towards, and extends along, a flow axis 494 which is defined by the turbine outlet passage 492. In the illustrated embodiment, the outlet 490 of the conduit 488 is coaxial with the flow axis 494. The conduit 488, specifically the outlet 490 thereof, therefore points in a directly downstream direction with respect to the flow axis 494. This is owing to the fact the exhaust gas flows through the turbine housing assembly 481 in a direction indicated by the arrow 496.

Like the system 450 shown in FIG. 31, in the turbine dosing system 480 the outlet 490 is located within a diverging portion 498 (i.e. a diffuser) of the turbine outlet passage 492. The aftertreatment fluid is therefore injected by the lance dosing module 486 into exhaust gas in the diverging portion 492. A spray cone 500 as defined by the outlet 490 of the conduit 488 is also schematically indicated in FIG. 32. Also shown is a dosing module mount 502 which forms part of the connection adapter 482, and a wastegate passage outlet 504 which opens out into the turbine outlet passage 492. Like the embodiment described in connection with FIG. 31, the outlet 490 of the lance dosing module 486 is preferably located within around 5 exducer diameters, along the flow axis 494, of a downstream end of a turbine wheel (not shown in FIG. 32).

The advantages described in connection with FIG. 31 apply equally to the turbine dosing system 480 shown in FIG. 32. Namely, by having the conduit 488 project into the turbine outlet passage 492, aftertreatment fluid 500 is injected into a recirculation zone due to the presence of the diverging portion 498 of the turbine outlet passage 492. This provides desirable decomposition rates of the aftertreatment fluid in the exhaust gas flow 496, and reduces the risk of deposit build-up occurring within the turbine outlet passage 492 (and downstream thereof).

Of note, like the embodiment shown in FIG. 4, a diverging portion 498 of the turbine outlet passage 492 extends across both a connection adapter 482 and the turbine housing 484 (again, only part of which is shown in FIG. 32. However, it will be appreciated that the lance dosing module 486 advantages may otherwise be obtained if the module were incorporated in a monoblock turbine housing (e.g. as shown in FIGS. 9 and 10). Furthermore, the lance dosing module 486 may be incorporated in a downstream conduit which engages a turbine housing or connection adapter.

One or both of the connection adapter 482 and turbine housing 484 may be manufactured from corrosion-resistant materials, such as stainless steel. Alternatively, or in combination, a corrosion-resistant sleeve, or lining, (e.g. manufactured from stainless steel) may be provided at any interior surface locations in which aftertreatment fluid impinges (and which may thus be liable to corrode over time). Other materials which are also resistant to corrosion may be utilised in place of, or in combination with, stainless steel. Coatings and/or surface treatments may also be utilised to improve corrosion resistance.

Turning to FIG. 33, a perspective view of the part of the turbine dosing system 480 shown in FIG. 32 is provided. The FIG. 33 view is taken generally from a downstream end of the turbine housing assembly 481. FIG. 33 shows the conduit 488, forming part of the lance dosing module 486, and the outlet 490 thereof. Also visible is the wastegate passage outlet 502, the connection adapter 482 and the turbine housing 484.

FIG. 33 also indicates how the connection adapter 482 is attached to the turbine housing 484. A plurality of bores 504, 505, 506 are provided in the connection adapter 482, and are configured to receive fasteners therethrough. Corresponding bores 507, 508, 509, provided in the turbine housing 484, are configured to receive threaded ends of the fasteners so as to secure the connection adapter 482 in engagement with the turbine housing 484. In other embodiments, a V-band clamp, for example, may be used to secure the two components together.

For completeness, the flow axis 494 is also indicated in FIG. 33, and the outlet 490 (of the conduit 488) is shown coaxial with the flow axis 494.

Turning to FIG. 34, a close-up view of the outlet 490 of the conduit 488 is shown. In the illustrated embodiment the outlet 490 comprises a plurality of orifices 510a to 510d through which the aftertreatment fluid is expelled. By providing a plurality of relatively small orifices 510a to 510d, the aftertreatment fluid is readily atomised as it is expelled from the outlet 490. In the illustrated embodiment the orifices 510a-510d are less than around 1 mm in diameter, but this may vary in other embodiments. Also in other embodiments, the plurality of orifices 510a-510d may be exchanged for a single orifice (e.g. the outlet 490 may comprise a single orifice).

In the illustrated embodiment the orifices 510a-510d are circular. However, in other embodiments the orifices may have another geometry (e.g. triangular, rectangular, or some variant or combination).

The plurality of orifices 510a-510d are defined in an end face of the conduit 488 in the illustrated embodiment. In other embodiments, one or more orifices may be provided circumferentially around an exterior of the conduit 488.

Turning to FIG. 35, an end view of a turbine housing 520 according to another embodiment is provided. The end view of FIG. 35 is taken generally from a downstream end of the turbine housing 520.

The turbine housing 520 forms part of a wastegate turbine and, as such, incorporates a wastegate arrangement 522. In use, a turbine bulk flow of exhaust gas enters the turbine housing 520 via a turbine inlet passage which begins at an inlet flange 524. The turbine bulk flow, in normal operation (i.e. when the wastegate arrangement 522 is closed) flows through, and around, a volute 526 and is then expanded across a turbine wheel (not illustrated in FIG. 35) before being exhausted through a turbine outlet passage 528.

From the FIG. 35 view, two circular apertures are visible. A first is labelled 530 and defines an inlet of a diffuser 550 (e.g. diverging portion) of the turbine housing 520. A second of the apertures is labelled 532 and defines an outlet of both the diffuser 550 and the overall turbine housing 520. It will be appreciated from FIG. 35 that the outlet 532 has a larger cross sectional area than the inlet 530. Furthermore, a structure, in the form of a wall 534, extends between the inlet 530 and the outlet 534 and defines at least part of the turbine outlet passage 528.

Each of the inlet 530 and outlet 532 define a respective axis 536, 538 (referred to herein as an inlet axis 536 and outlet axis 538 respectively). Each of the inlet and outlet axes 536, 538 extend normal to a respective centre of the inlet 530 and outlet 532.

As will be appreciated from FIG. 35, in the illustrated embodiment the outlet axis 538 is offset from the inlet axis 536. Put another way, the outlet 532 is concentrically offset from the inlet 530. An offset 540 between the inlet axis 536 and the outlet axis 538 is indicated in FIG. 35.

Owing to the offset between the inlet and outlet axes 536, 538, the diffuser 550 (extending between the inlet 530 and the outlet 532 of the turbine housing 520) may be said to change direction along its extent. The diffuser 550 may therefore be described as an offset diffuser. The offset nature of the diffuser 550 defines a pocket 542. The pocket 542 may otherwise be described as a recessed portion. The pocket 542 defines a geometry which may be described as undercut relative to the inlet 530. In use, exhaust gas will pass into, and through, the pocket 542 as a result of the expanding exhaust gas due to the diffuser 550 increasing in cross sectional area from the inlet 530 to the outlet 532. The pocket 542 provides a convenient region in which further components can be located. For example, in the illustrated embodiment a valve assembly 544 and wastegate passage outlet (not visible in FIG. 35 but covered by the valve assembly 544) are located partly within the pocket 542. Also located in the pocket 542 is a dosing module mount schematically indicated and labelled 546 in FIG. 35. As described in connection with previous embodiments, the dosing module mount 546 is configured to receive a dosing module which injects aftertreatment fluid into a turbine bulk flow of exhaust gas which passes through the turbine housing 520. Although the dosing module (not shown in FIG. 35) can point in a downstream direction (i.e. towards the outlet 532), an upstream direction (i.e. towards the inlet 530) or across the diffuser (i.e. spraying across the turbine outlet passage 528), in the illustrated embodiment the dosing module would point in a downstream direction in use (owing to the position, and angle, of the dosing module mount 546).

Described broadly, an offset diffuser may be said to exist when the outlet axis 538 is offset from the inlet axis 536. Typically, it is expected that the inlet axis 536 be coaxial with a turbine wheel axis (about which a turbine wheel rotates), although no turbine wheel axis is shown in FIG. 35.

Irrespective of the direction in which the dosing module mount 546 points, locating the dosing module mount 546 within the pocket 542 means that a turbine bulk flow of exhaust gas passes the dosing module as the area increases and the flow is diffused (e.g. speed and pressure increase, in accordance with gas law PV=nRT [where temperature T is constant]) by the diffuser 550. As such, the turbine bulk flow of exhaust gas naturally flows close to, and past, the outlet of the dosing module (without the influence of further components or features). This reduces an overall backpressure associated with the turbine housing 520 (in contrast to where further components are incorporated to direct the flow past the dosing module outlet), which is desirable for reasons of improved efficiency. Furthermore, the outlet of the dosing module is cleaned in use by the fast moving turbine bulk flow which passes thereacross. This reduces the risk of blockages occurring in the dosing module, desirable for reasons of improved longevity of the dosing module.

By having the dosing module mount 546, and so dosing module when assembled/installed, point in a downstream direction, a number of further advantages are realised. In particular, a desirable natural dispersion of the aftertreatment fluid injected by the dosing module occurs as a result. Furthermore, impingement of the aftertreatment fluid on the wall 534 (specifically internal surfaces thereof) is reduced (in comparison to, for example, where the dosing module points across the diffuser). This reduces the risk of deposit build-up, and mitigates the need for further features to deal with any wall wetting (i.e. features to reduce any damage which occurs as a result of aftertreatment fluid impinging upon the wall 534). The aftertreatment fluid spray placement is also more predictable at a wider range of engine operating conditions.

Although not the case in the illustrated embodiment, in particularly desirable arrangements the dosing module (and so dosing module mount) may be coaxial with the outlet axis 538. This advantageously means that the dosing module points in exactly the same direction as the turbine bulk flow, and greatly reduces the risk of any deposit build-up on the wall 534.

Overall, the illustrated offset diffuser design provides a number of desirable advantages including ready customisation of the diffuser angle (i.e. the angle of divergence through the diffuser), extent of the offset (i.e. the length of the dimension 540), dosing module placement (and associated dosing module mount 546 placement) and diffuser clocking. Diffuser clocking effectively refers to the rotational position of the offset 540 between the inlet axis 536 and the outlet axis 538 as indicated in FIG. 35. Described another way, clocking refers to the rotational position of the outlet axis 538 with respect to the inlet axis 536 (and so the rotational position of the outlet 532 relative to the inlet 530). The clock position of the offset 540 in FIG. 35 is around 3:30. In other embodiments the clock position could be around 6:00 (e.g. the outlet axis 538 directly below the inlet axis 536) or 12:00 (e.g. the outlet axis 538 directly above the inlet axis 536). The flexibility of being able to modify these various parameters provides a compact packaging size whilst maintaining a high efficiency diffuser.

The turbine housing 520 may be manufactured from a corrosion-resistant material, such as stainless steel, and/or incorporate a corrosion-resistant sleeve, or liner, (e.g. made of stainless steel) at any primary impingement locations as determined by a spray cone of a dosing module. Other materials which are also resistant to corrosion may be utilised in place of, or in combination with, stainless steel. Coatings and/or surface treatments may also be utilised to improve corrosion resistance.

Turning to FIG. 36, a schematic side view of the turbine housing 520 of FIG. 35 is shown with a dosing module 548 mounted thereto.

FIG. 36 shows the inlet flange 524, the volute 526 and schematically indicates the inlet and outlet 530, 532 of the diffuser 550. Although not shown in FIG. 36, the dosing module 548 is secured to the turbine housing 520 by a dosing module mount. As described in connection with FIG. 35, the dosing module mount is located in the pocket 542 defined by the offset nature of the diffuser 550.

The dosing module 548 is configured to inject aftertreatment fluid into a turbine bulk flow of exhaust gas that passes through the turbine housing 520. The dosing module 548 defines a spray cone 552 of aftertreatment fluid as the aftertreatment fluid is expelled. FIG. 36 indicates that the dosing module 548 points in a downstream direction (i.e. towards the outlet 532).

Turning to FIGS. 37 and 38, a connection adapter 560 according to another embodiment is illustrated. FIG. 37 is a perspective view of the connection adapter 560 from a generally upstream end, and FIG. 38 is a cross sectional side view of the connection adapter 560.

Like the turbine housing 520 shown in FIGS. 35 and 36, the connection adapter 560 shown in FIGS. 37 and 38 comprises a diffuser 562. Diffuser 562 extends across an entire extent of the connection adapter 560 itself. That is to say, an inlet 564 of the connection adapter 560 also constitutes the inlet 564 of the diffuser 562. Similarly, an outlet 566 of the connection adapter 560 also constitutes the outlet 566 of the diffuser 562.

A structure, in the form of a wall 568, extends between the inlet 564 and the outlet 566 to define as least part of a turbine outlet passage 570. The wall 568 comprises a dosing module mount 572. The dosing module mount 572 comprises an opening 574 which is in fluid communication with the turbine outlet passage 570. It is through the opening 574 which aftertreatment fluid is injected into a turbine bulk flow which passes through the turbine outlet passage 570.

As indicated in FIG. 38, each of the inlet 564, outlet 566, and dosing module mount 572 define a respective axis 576, 578, 580. An offset 582 between the inlet and outlet axes 576, 578 is shown in FIG. 38. In the illustrated embodiment the inlet and outlet 564, 566 are concentrically offset from one another such that the inlet and outlet axes 576, 578 are parallel to one another, but are offset. In preferred embodiments the indicated offset 582 is between around 10 mm and around 50 mm, and specifically between around 15 mm and around 25 mm. Defined another way, the offset 582 preferably lies between around ⅓ and around ⅔ of a diameter of the inlet 564.

As will be appreciated from FIG. 38, the dosing module axis 580 makes an angle 584 with the outlet axis 578. The angle 584 is preferably at least around 35°, and more preferably around 40°. The angle 584 is also preferably an acute angle such that the dosing module, when installed, points in a generally downstream direction (i.e. towards the outlet 566). Angling the dosing module in this way gives rise to a number of advantages including more predictable spray placement, and reduced risk of deposit build-up on the internal surface of the wall 568. In some embodiments the dosing module mount axis 580 may be coaxial with the outlet axis 578 (e.g. the dosing module mount axis 580 may point directly downstream). Where the angle 584 is at least around 35°, and more preferably around 40°, flow detachment from surface 569 (upstream of the dosing module mount 572 and leading into the pocket 582) is advantageously reduced.

Like that described in connection with FIGS. 35 and 36, the diffuser 562 incorporates a change of direction as part of the turbine outlet passage 570, such that pocket 586 is defined. The pocket 586 may otherwise be described as a recessed portion. The dosing module mount 572 is located in the pocket 586 so as to facilitate the injection of aftertreatment fluid in a direction towards the outlet axis 578 without the dosing module projecting into the turbine outlet passage 572.

Finally, also shown in FIG. 38 is part of a wastegate passage 588. Wastegate passage 588 extends between a volute and the turbine outlet passage 570 when the connection adapter 560 is connected to a turbine housing. The wastegate passage 588 is not of particular importance for the present invention.

The wastegate passage 588 is defined at least in part by a lip 590 which extends downstream of the inlet 564. The lip 590 is a projection which partly separates the turbine outlet passage 570 from the wastegate passage 588. This reduces undesirable flow effects which may result from the mixing of these two flow streams in operation. In embodiments where the dosing module mount 572, and the dosing module when installed, point across the turbine outlet passage 570 or point towards the inlet 564 (i.e. in an upstream direction), the lip 590 may also provide a shielding functionality to reduce the risk of aftertreatment fluid impinging upon part of a wastegate arrangement. For example, the lip 590 may reduce the risk that aftertreatment fluid build-up around a wastegate valve. Such build-up could risk the functionality of the valve if not for the lip 590.

The lip 590 also provides a further functionality in directing bypass exhaust gas flow, which passes through the wastegate passage 588, in a downstream direction towards the outlet 566. The presence of the lip 590 therefore reduces momentum exchange between the bypass exhaust gas flow (through the wastegate passage 588) and the turbine bulk flow (through the inlet 564). Although momentum exchange increases TKE, it can negatively impact turbine efficiency by impeding bulk flow as well as increasing the backpressure experienced by the turbine wheel. The lip 590 therefore improves/maintains turbine efficiency by guiding the bypass exhaust gas flow.

The connection adapter 560 may be manufactured from a corrosion-resistant material, such as stainless steel, or incorporate a corrosion-resistant sleeve, or linear, (e.g. manufactured from stainless steel) to reduce the risk of corrosion from byproducts of the aftertreatment fluid. Other materials which are also resistant to corrosion may be utilised in place of, or in combination with, stainless steel. Coatings and/or surface treatments may also be utilised to improve corrosion resistance.

Turning now to FIG. 39, a perspective view of a turbocharger 600 and downstream conduit 602 according to another embodiment is illustrated.

The turbocharger 600 comprises a compressor 604, a bearing housing 606 and a turbine dosing system 608. The turbine dosing system 608 comprises a monoblock turbine housing 610 and a dosing module 612, and a turbine wheel (not visible in FIG. 39). Also shown in FIG. 39 is the downstream conduit 602 which is connected to the turbine housing 610.

Turning to FIG. 40, a cross section side view of the turbocharger 600 and downstream conduit 602 is provided. FIG. 40 shows the compressor 604 connected to the bearing housing 606 and, in turn, the turbine dosing system 608 being connected to the bearing housing 606 (specifically the turbine housing 610). FIG. 40 also shows a turbine wheel which forms part of the turbine dosing system 608.

The turbine housing 610 comprises a diffuser 616. The diffuser 616 may be referred to as a diverging portion of a turbine outlet passage 617 defined by the turbine housing 610. In the illustrated embodiment the diffuser 616 extends between an inlet 618 and an outlet 620. In the illustrated embodiment, a turbine wheel chamber 622 is considered to extend around the turbine wheel 614 as indicated by the dashed line, with the diffuser inlet 618 being located directly downstream of the turbine wheel chamber 622.

The inlet 618 defines an inlet axis 624 which extends normal to the geometric centre of the inlet 618. The outlet 620 similarly defines an outlet axis 626 which extends normal to a geometric centre of the outlet 620. An offset 628 between the inlet access 624 and outlet access 626 is labelled in FIG. 40. The inlet axis and outlet axis 624, 626 are parallel to one another, and offset, in the illustrated embodiment. It will also be appreciated that the inlet axis 618 is coincident with a turbine wheel axis 630 about which the turbine wheel 614 rotates.

The turbine housing 610 comprises a dosing module mount 632 which, in turn, defines a dosing module mount axis 634. A dosing module 612 is mounted to the dosing module mount 632. It follows that the dosing module mount axis 634 also indicates a dosing module axis.

As will be appreciated from FIG. 40, the dosing module 612 is angled towards the outlet 620 of the turbine housing 610. Dosing module 612 therefore points in a downstream direction. Furthermore, the dosing module mount axis 634 makes an angle of less than around 70° to the outlet axis 626. Said angle is indicated 636.

The illustrated embodiment is particularly advantageous because, owing to the orientation of the dosing module 612, aftertreatment fluid is effectively injected partway around a bend defined by the downstream conduit 602. Furthermore, it will be appreciated that a pocket 638, or recessed portion, is defined by the turbine housing 610. The pocket 638 provides a convenient location for the dosing module mount 632. It is desirable that the downstream conduit 602 be manufactured from a corrosion-resistant material, such as stainless steel. Alternatively, or in combination, a corrosion-resistant sleeve, or linear, may be provided at least at a primary impingement zone of the aftertreatment fluid. Corrosion-resistant materials are preferably present at least at any bend where aftertreatment fluid is liable to collect, and where resulting deposits may form. Other materials which are also resistant to corrosion may be utilised in place of, or in combination with, stainless steel. Coatings and/or surface treatments may also be utilised to improve corrosion resistance.

Turning to FIG. 41, a turbocharger 640 and downstream conduit 642 according to another embodiment are illustrated.

In FIG. 41, a diffuser 644 forms part of the downstream conduit 642. This is in contrast to the previous embodiments where the diffuser formed part of a connection adapter or turbine housing. Like the previous embodiments, the diffuser 644 extends between an inlet 646 and an outlet 648. However, unlike the previous embodiments, the outlet 648 of the diffuser 644 is not the outlet of the component of which it forms part. That is to say, as will be appreciated from FIG. 41, the downstream conduit 642 extends beyond the outlet 648 of the diffuser 644.

Each of the inlet 646 and outlet 648 of the diffuser 644 define a respective axis, the axes being offset from one another so as to define an offset diffuser. The downstream conduit 642 further comprises a dosing module mount 650 to which a dosing module is mountable. It will be appreciated that the advantages previously described in connection with the earlier embodiments, regarding an offset diffuser, apply equally in to the present embodiment.

Turning to FIG. 42, a perspective view of a turbocharger 660 according to a further embodiment is illustrated.

The turbocharger 660 comprises a turbine dosing system 662 which comprises a monoblock turbine housing 664. The monoblock turbine housing 664 shares many features in common with the turbine housing 520 described in connection with FIG. 35. The extent of the diffuser 666 of FIG. 42 is less than an extent of the diffuser 550 shown in FIG. 35. Put another way, the diffuser 666 in FIG. 42 is more compact.

Like the earlier embodiments, a dosing module 668 is provided and injects aftertreatment fluid into a turbine bulk flow of exhaust gas which flows through the turbine outlet passage in use.

FIG. 43 is a cross section side view of a turbine dosing system 670 according to another embodiment. The turbine dosing system 670 comprises a turbine housing assembly 672 which comprises a turbine housing 674 and connection adapter 676. A downstream end of the connection adapter 676 is connected to a downstream conduit 678.

The connection adapter 676 comprises a diffuser 680. The diffuser 680 extends between an inlet 682 and an outlet 684. The inlet and outlet 682, 684 of the diffuser 680 are also the inlet and outlet of the connection adapter 676 itself. The inlet 682 defines an inlet axis 686 which extends from a geometric centre of the inlet 682. The outlet 684 similarly defines an outlet axis 688 which extends from a geometric centre of the outlet 684.

The diffuser 680 defines part of a turbine outlet passage 690, the turbine outlet passage 690 defining a flow axis 692.

Like the previous embodiments, the inlet axis 686 and outlet axis 688 are offset from one another, such that the inlet 682 and outlet 684 are concentrically offset. This is indicated by a change of direction of the flow axis 692. The diffuser 680 further comprises a wall 694, which may be broadly described as a structure, which extends between the inlet 682 and the outlet 684. The wall 694 comprises a dosing module mount 696 which is configured to receive a dosing module 698. The dosing module mount 696 defines a dosing module mount axis 700.

As will be appreciated from FIG. 43, the dosing module mount axis 700 may also be considered to be a dosing module axis, given that the dosing module 698 is mounted to the dosing module mount 700. Dosing module mount 696, and so dosing module 698, point towards the outlet 684 of the diffuser 680. As such, the dosing module 698 points in a downstream direction. Furthermore, in the illustrated embodiment the dosing module mount axis 700 is coincident with the flow axis 692 downstream of the outlet 684. This arrangement may therefore be described as a pseudo-centreline dosing arrangement in which the dosing module 698 is able to inject aftertreatment fluid along the flow axis 692 which runs through a centre of the turbine outlet passage 690. This advantageously reduces the risk of deposit build up on internal surfaces of the surrounding structures (e.g. the wall 694), and provides advantageous dispersal of the aftertreatment fluid throughout the turbine bulk flow of exhaust gas.

For completeness, a spray cone 702 of aftertreatment fluid, as injected by the dosing module 698, is also schematically indicated in FIG. 43. The placement of the spray cone 702 is more predictable across a range of engine operating conditions owing to the dosing module mount 696, and so dosing module 698, pointing in a downstream direction. Predictable, and desirable, spray behaviour is therefore obtained by providing the dosing module 698 in a downstream direction.

Turning to FIG. 44, a schematic cross section of part of a diffuser 710 and downstream conduit 712 according to another embodiment is provided.

The diffuser 710 has an inlet 714 and an outlet 716, diametric extents being indicated by arrows in FIG. 44. Each of the inlet and outlet 714,716 define a respective axis 718, 720. An offset 722 between the inlet and outlet axes 718, 720 is also indicated. Accordingly, the inlet 714 and outlet 716 are concentrically offset from one another.

The diffuser 710 defines part of a turbine outlet passage 724. The turbine outlet passage 724 defines a flow axis 726 which extends through a centre of the turbine outlet passage 724.

Although not indicated in FIG. 44 due to the schematic nature of the Figure, a structure extends between the inlet 714 and the outlet 716 of the diffuser 710 to define at least part of the turbine outlet passage 724. The structure comprises a dosing module mount 728, which defines a dosing module mount axis 730. Owing to the offset nature of the outlet 716 to the inlet 714 (as indicated by offset 722), the structure defines a pocket 732, or recessed portion, in which the dosing module mount 728 is located. FIG. 44 also indicates that the dosing module mount 728 is positioned downstream of a change of direction of the flow axis 728, 726 (i.e. downstream of a point where the flow access 726 begins to deviate from the inlet axis 718).

Turning to FIG. 45, a plot showing results from a CFD simulation conducted on the arrangement shown in FIG. 44 is provided. FIG. 45 is a velocity plot indicating the relative levels of flow velocity as flow passes into the diffuser 710 and the downstream conduit 712. As will be appreciated from the indicated key, the flow generally decreases in velocity from an initially high level just downstream of turbine wheel 734 as the flow moves downstream. At a point 736 where the flow axis 726 begins to change direction, a region of comparatively slow moving exhaust gas 738 is present. Also, FIG. 45 indicates that further region 739 of slow moving exhaust gas exists proximate the pocket 732 defined by the diffuser 710. The slow moving region 739 is provided proximate an opening (not shown in FIG. 45) which is defined by the dosing module mount 728 and which extends into the turbine outlet passage.

The slow moving region 739 of exhaust gas is indicative of separation of the turbine bulk flow occurring due to the offset diffuser 710. Furthermore, the slow moving exhaust gas risks the onset of flow recirculation. This is particularly undesirable around an outlet of the dosing module (not shown in FIG. 45) which is positioned close to the dosing module mount 728. Recirculation of the flow in this region, and so in the pocket 732, risks the build-up of aftertreatment fluid-related deposits at the outlet of the dosing module. This is undesirable for reasons of risking the dosing module becoming blocked. It is therefore desirable to reduce the risk of flow recirculation occurring proximate the pocket 732, or reducing or eliminating the region 739 of slow moving exhaust gas. Described another way, it is desirable to reduce the risk of a boundary layer of the exhaust gas becoming detached from the diffuser 710 (e.g. the onset of stall occurring). Deposits at the outlet of the dosing module are also undesirable for the reason that the deposits can grow outwards, away from the outlet, to such an extent that they interfere with the turbine bulk flow. This can be by way of increasing backpressure across the turbine wheel 734, decreasing overall turbine/system performance and efficiency.

Turning to FIG. 46, a further velocity plot is shown. FIG. 46 is a plot showing results from CFD simulations on a modified diffuser 711 in accordance with an embodiment of the invention. Save for the differences about to be described, the diffuser 711 is identical to the diffuser 710 shown in FIG. 45. A downstream conduit 712 is identical to that as shown in FIG. 45, along with a turbine wheel 734 and region of the system between the turbine wheel 734 and the diffuser 710.

The inventors have identified that, in order to reduce the extent of the region 739 (FIG. 45) of slow moving exhaust gas proximate the dosing module mount 728, incorporation of a plurality of vortex generator fins 742, 744 (only two of which are shown in FIG. 46) is advantageous. As suggested by the name, the vortex generator fins 742, 744 are features which facilitate, or create, vortices in the turbine bulk flow of exhaust gas as it passes through the diffuser 711. Advantageously, the formation of the vortices creates turbulence and maintains adhesion of the turbine bulk flow to internal surfaces of the structure which defines the diffuser 711 in regions which may otherwise be prone to flow separation. As mentioned above, flow separation is undesirable because it may lead to regions of flow recirculation, which may result in the blockage of an outlet of a dosing module and/or obstruction of the turbine outlet passage 724.

The vortex generator fins 742, 744 are located upstream of the pocket 732 in which the dosing module mount 728 is provided. The vortex generator fins 740, 742 are projections which extend from an internal surface of the structure (e.g. wall) which defines the diffuser 711. The vortex generator fins 740, 742 extend into the turbine outlet passage at least partly defined by the diffuser 711. The vortex generator fins 740, 742 may be manufactured using an additive manufacture method (e.g. 3D printing) in preferred embodiments. The vortex generator fins 740, 742 may otherwise be integrally cast with the structure that defines the diffuser 711, or welded to the structure.

As indicated by FIG. 46, owing to the presence of the vortex generator fins 740, 742, the relative velocity of exhaust gas flow proximate the dosing module mount 728 (i.e. proximate the pocket 732) is generally increased. This effectively means that the risk of separation, and so flow recirculation, in this zone is reduced, with an associated reduction of the risk that an outlet of the dosing module would become blocked. Described another way, the presence of the vortex generator fins 742, 744 improves adhesion of the exhaust gas flow to internal surfaces (of the diffuser 711) after an abrupt change of direction. The vortex generator fins 740, 742 are therefore preferably placed just upstream of the pocket 732 (otherwise referred to as a recessed portion).

Turning to FIG. 47, a magnified perspective view of an exterior of part of the diffuser 711 of FIG. 46 is provided. FIG. 47 also shows the dosing module mount 728, indicated only schematically because an opening (of the dosing module mount 728) is omitted.

FIG. 47 shows that in the illustrated embodiment there are actually four vortex generator fins 740, 742, 744, 746 (the outlines of which are indicated). A single fin 748 is also illustrated, in isolation of the diffuser 711, and is provided to aid in the explanation and understanding of the concept. It is expected that at least two generator fins be incorporated in other embodiments.

FIG. 47 indicates that the vortex generator fins 740, 742, 744, 746 define an array of fins which extend partway around a wall 713 which defines the diffuser 711. The inventors have found it is particularly desirable that vortex generator fins 740, 742, 744, 746 extend at least as far around, circumferentially, as is occupied by the dosing module mount 728. Described another way, it is preferable that the vortex generator fins 740, 742, 744, 746, in combination, extend around a circumferential extent of the wall 713 so as to contain, or bound, the dosing module mount 728. In the illustrated embodiment the fins 740, 742, 744, 746 only extend partway around a flow axis.

A height 749 (as indicated on isolated fin 748 in FIG. 47) of the fins is preferably between around 0.02 and around 0.1 times the diameter of the turbine outlet passage 713 at that axial position. A length 750 (as also indicated on isolated fin 748 in FIG. 47) of the fins is preferably between around 0.05 and around 0.15 times the diameter of the turbine outlet passage 713 at that axial position. The vortex generator fins 740, 742, 744, 746 are elongate in the illustrated embodiment. That is to say, the vortex generator fins 740, 742, 744, 746 have a length 750, generally along a corresponding flow axis, which is greater than the height 749 (generally normal to the corresponding flow axis).

Turning to FIG. 48, a view of the diffuser 711 from above (with the vortex generator fins 740, 742, 744, 746 location indicated thereon) is provided. Of note, in FIG. 48 the dosing module mount 728 is shown only as an opening into the diffuser 711. FIG. 48 also indicates that the vortex generator fins 740, 742, 744, 746 are preferably provided at an angle relative to a flow axis 726 which runs through the diffuser 711. Put another way, the vortex generator fins 740, 742, 744, 746 extend inwardly from an internal surface of the wall 713, but are angled along their length. The angle is preferably between around 5° and around 30° to the flow axis 726. A minimum circumferential gap of between around 0.05 and around 0.15 times the diameter of the turbine outlet passage 713, at that axial position, is preferably provided between each of the vortex generator fins 740, 742, 744, 746.

For completeness, the structure shown in FIG. 48 includes both a diffuser 711 and a region upstream of the diffuser 711 (i.e. between the diffuser 711 and the turbine wheel).

Although the vortex generator fins 740, 742, 744, 746 have been described in combination with the diffuser 711 of a turbine dosing system, it will be appreciated that the vortex generator fins 740, 742, 744, 746 could be used to reduce, or eliminate, flow separation in a conduit for any engine system, the conduit having a recessed portion of a fluid passage (e.g. a pocket of a turbine outlet passage). The concept can therefore be applied to a wide range of different conduits for various different applications. In particular, the vortex generator fins 740, 742, 744, 746 could be used to reduce, or eliminate, flow separation in a conduit incorporating, for example, a bend (e.g. a zone where flow may be liable to separate from an internal surface of the conduit).

Turning to FIG. 49, a turbine dosing system 760 according to another embodiment is illustrated. FIG. 49 is a perspective view of an exterior of the turbine dosing system 760.

The turbine dosing system 760 comprises a turbine housing 762 and a dosing module 764. The turbine housing 762 is a monoblock turbine housing owing to the fact that there is no separate connection adapter and that the turbine housing 762 itself defines each of a turbine inlet passage (by virtue of a volute 766), a wheel chamber (not visible in FIG. 49) and a turbine outlet passage 768.

FIG. 49 illustrates how the dosing module 764, which is configured to inject aftertreatment fluid into the exhaust gas in the turbine outlet passage 768, is mounted to the turbine housing 762 via a dosing module mount 770. The dosing module mount 770 forms part of a structure 772 which defines the turbine outlet passage 768.

Partly visible in FIG. 49 is a spray cone 774 of aftertreatment fluid as injected by the dosing module 764. A flow axis 776 is also schematically indicated on FIG. 49. Finally, a plane 778 indicates the plane through which the FIG. 50 view is taken.

Turning to FIG. 50, the turbine dosing system 760 is shown in a cross section view as taken through the plane 778. Also visible in FIG. 50 is a turbine wheel 780, which forms part of the turbine dosing system 760. Also indicated is a dosing module axis 782 which extends normal to an outlet 784 of the dosing module 764.

As will be appreciated from FIG. 50, the dosing module axis 782 indicates the centre point of the spray cone 774 of aftertreatment fluid which is injected by the dosing module 764. The dosing module axis 782 is therefore indicative of a direction of injection. The dosing module axis 782 extends through the flow axis 776 (and so a turbine wheel axis which is coaxial with the flow axis 776 in the illustrated embodiment). The dosing module 764 is located orthogonally (i.e. perpendicular to) with respect to the flow axis 776. In other embodiments the dosing module axis 782 may be offset by up to around 5° relative to a precisely orthogonal relationship to the flow axis 776 (e.g. it may be inclined in an upstream or downstream direction). Put another way, the dosing module axis 782 may be offset by up to around 5° in any direction.

Providing the dosing module axis 782 substantially orthogonal to the flow axis 776 is advantageous because the aftertreatment fluid 774 is injected across a wider range of the turbine outlet passage 768. Furthermore, this can facilitate the use of high turbulent kinetic energy (TKE) zones, as well as high wall shear/high velocity zones (i.e. aftertreatment fluid can be advantageously injected into these zones). Furthermore, it has been found that incorporation of the dosing module mount 770 can be readily carried out (i.e. the dosing module mount 770 incorporated as part of the structure 772) with this orientation.

Turning to FIG. 51, a schematic cross section view of a flow field, and spray cone 774, of the turbine dosing system 760 are shown in isolation.

The flow field indicates that the exhaust gas generally swirls in a first direction 788. Swirl refers to an at least partly, an optionally entirely, circumferential velocity component. Swirl is imparted to the exhaust gas as it is expanded across, and exhausted by, the turbine wheel (not shown in FIG. 51, but provided just upstream of the illustrated flow field). The first direction 788 in which the exhaust gas swirls is the same direction as the direction of rotation of the turbine wheel (at least in the present embodiment, for this flow condition). In other flow conditions, the exhaust gas may swirl in the opposite direction to the direction of rotation of the turbine wheel (a condition known as ‘overturned’ flow, whereby flow is overturned back on itself by blades of the turbine wheel). However, for simplicity, the direction 788 may be described as a nominal swirl direction (e.g. the same direction in which the volute extends, and in which the turbine wheel rotates). Also shown in FIG. 51 is the spray cone 774 of aftertreatment fluid as injected by a dosing module (not shown in FIG. 51). The dosing module axis 782, indicative of the direction of the spray 774, is also shown. The flow axis 776 is also schematically indicated.

From FIG. 51 it will be appreciated that, like FIG. 50, the dosing module axis 782 is orthogonal to the flow axis 776. As such, the aftertreatment fluid is injected directly across the turbine outlet passage.

Turning to FIG. 52, an alternative alignment of dosing module mount axis 783 is illustrated. Save for the difference in dosing module axis 783 alignment, the FIG. 52 flow field is identical to the FIG. 51 flow field.

For the FIG. 52 flow field, the dosing module is offset from the flow axis 776 (as indicated by offset 777). As such, the dosing module axis 783 is not coincident with the flow axis 776. Instead, the dosing module axis 783 is substantially perpendicular to a radius 790 of the turbine outlet passage. The radius 790 extends from the flow axis 776 in a purely radial direction. In the FIG. 52 embodiment the dosing module axis 783 lies entirely in a single plane which is normal to the flow axis 776. Put another way, the dosing module does not point in either an upstream or a downstream direction. However, in other embodiments it will be appreciated that the dosing module axis 783, and so dosing module, may be angled slightly off a purely orthogonal orientation. For example, the dosing module axis 783 is preferably substantially perpendicular to the radius 790, within 30° of a precisely perpendicular, orthogonal, direction (e.g. within the angular range indicated 792).

In other embodiments, the dosing module axis 782 (with reference to FIG. 51) may be rotated such that the aftertreatment fluid is expelled from the same position (e.g. a ‘top’ end of the dosing module axis is in the same position), but is angled in a different direction to a purely orthogonal orientation (e.g. as indicated by axis 782). See, for example, the orientation indicated by inclined dosing module axis 787.

Returning to FIG. 52, because of the alignment of the dosing module axis 783 with respect to the flow axis 776, and so the flow field more generally, the dosing module is positioned to inject aftertreatment fluid against the nominal swirl direction 788 of the exhaust gas. This gives rise to a number of advantages including, but not limited to, increased relative velocity between the aftertreatment fluid and the exhaust gas, which provides increased convective heat transfer to droplets (increase in decomposition), and increasing the drag on the droplets (which counteracts the momentum from the spray). Uniformity of the aftertreatment fluid in the exhaust gas is also improved as a result, and the overall package size of the turbine dosing system can be reduced.

In preferred embodiments of both orthogonal arrangements (as shown in FIG. 51) and offset arrangements (e.g. FIGS. 52 and 53) it is preferable that the dosing module be positioned within around 10 exducer diameters downstream of a downstream end of the turbine wheel. Within this range the exhaust gas has been found to have a high swirling magnitude and thus have desirable properties for the dispersal of aftertreatment fluid therein. Where the turbine outlet passage incorporates a change of direction, it is also desirable that the dosing module be located upstream of a first bend, again for reasons of maintaining a high swirl magnitude in the exhaust gas.

Turning to FIG. 53, a flow field for an alternative embodiment to that shown in FIGS. 51 and 52 is provided.

In the FIG. 53 embodiment, the dosing module is positioned to inject aftertreatment fluid into (e.g. with) the nominal swirl direction 788 of the exhaust gas. The previous description regarding the option of a slight angular offset 792 (of the dosing module axis 785) applies equally to the FIG. 53 embodiment.

Advantageously, by having the dosing module positioned to inject aftertreatment fluid into the nominal swirl direction 788, the majority of the aftertreatment fluid spray 744 is imparted into a high flow region at an outer portion of the turbine outlet passage. The amount of aftertreatment fluid suspended in a possible recirculation zone within the turbine outlet passage is therefore reduced.

Turning to FIG. 54, a (partial) plot showing results from a CFD simulation conducted on a turbine dosing system like that shown in FIGS. 23 and 30 is provided.

FIG. 54 is a close-up side view showing only part of the turbine dosing system. FIG. 54 indicates both the velocity of exhaust gas as it moves through a turbine outlet passage 800, and also shows the sizes of particles of aftertreatment fluid injected into the turbine outlet passage 800. Keys 802, 804 indicate the relative particle sizes and velocities, respectively, as mentioned above.

FIG. 54 shows two components which form part of the turbine dosing system. A first part is labelled 806 and is a connection adapter. A second part 808 is a downstream end of a turbine housing. A combination of the connection adapter 806 and turbine housing 808 define the part of the turbine outlet passage 800 visible in FIG. 54. A flange 810 is also shown forming part of one or both of the turbine housing 808 and connection adapter 806 to facilitate the connection therebetween.

The connection adapter 806 comprises a structure 812, which may be referred to as a wall, and it is the structure 812 which at least partly defines the turbine outlet passage 800. The structure 812 also defines an interior surface 814, the interior surface 814 being a surface which bounds the turbine outlet passage 800.

The structure 812 further comprises a projecting ledge 816 to which a dosing module is mounted in use. The dosing module is not shown in FIG. 54. The projecting ledge 816 comprises an opening 818 through which aftertreatment fluid is injected by the dosing module into the turbine outlet passage 800 in use.

As will be appreciated by the flow fields of FIG. 54, the projecting ledge 816 defines a recirculation zone 820 (i.e. an undercut) in which the exhaust gas has a comparatively low velocity and is prone to recirculation. Described another way, the boundary layer of exhaust gas in the turbine outlet passage 800 detaches from the internal surface 814 in/proximate the recirculation zone 820.

The presence of the recirculation zone 820 is undesirable for reasons of aftertreatment fluid becoming suspended in the recirculating exhaust gas and risking blockage of an outlet of the dosing module and/or growing deposits from the outlet, which can obstruct the turbine outlet passage 800.

Turning to FIG. 55, a plot showing results from a CFD simulation on a turbine dosing system according to another embodiment are provided.

In the FIG. 55 arrangement, it will be appreciated that the projecting ledge (of FIG. 54) has effectively been removed such that in the FIG. 55 arrangement a substantially uninterrupted passage surface is instead defined.

FIG. 55 shows a downstream end of the turbine housing 830 and a connection adapter 832 connected thereto. Like that described in connection with FIG. 54, the connection adapter 832 comprises a structure 834. The structure 834 defines an interior surface 836. Unlike the FIG. 54 arrangement, the structure 834 does not comprise a projecting ledge (i.e. 816 in FIG. 54). Instead, the projecting ledge is effectively removed. A dosing module mount 838 forms part of the structure 834 and defines an opening 840 which opens out into the turbine outlet passage 842.

Also shown in FIG. 55 is a dosing module 844 which is configured to inject aftertreatment fluid into the turbine outlet passage 842. The dosing module 844 comprises a nozzle 846 which defines an outlet 848 of the dosing module 844. The outlet 848 of the dosing module 844 may be described as being defined in an outer end 849 of the dosing module 844.

As will be appreciated from FIG. 55, the outer end 849 of the dosing module 844 is substantially flush with the surrounding interior surface 836 defined by the structure 834. Substantially flush in this instance is intended to mean that the outer end 849 of the dosing module 844 is within 2 mm of flush of the surrounding interior surface 836. The outer end 849 may therefore project beyond, or be recessed relative to, the surrounding interior surface 836 by up to around 2 mm.

FIG. 55 also shows that a combination of the interior surface 836 of the structure 834 and the outer end of the dosing module 844 define a substantially uninterrupted passage surface. Substantially uninterrupted passage surface is intended to mean that there are no significant recirculation zones, which may occur by virtue of features such as projecting ledges (i.e. undercuts). The substantially uninterrupted passage surface continues, or extends, along at least an extent of the flow axis 850 which is occupied by the dosing module mount 838. Said extent is labelled 852 in FIG. 55.

The dosing module mount 838 is defined in a diffuser owing to the fact that the turbine outlet passage 842 is increasing in cross section in this area. The structure 834 which comprises the dosing module mount 838 is therefore a diffuser.

Advantageously, the FIG. 55 embodiment is free of recirculation zones proximate the dosing module 844 in which aftertreatment fluid may otherwise be suspended, risking a blockage at the outlet 848 of the dosing module 844 and/or in the turbine outlet passage 842. Furthermore, the aftertreatment fluid can be injected into high velocity zones at an outer radial portion of the turbine outlet passage 842. Described another way, in the FIG. 55 embodiment a boundary layer of exhaust gas passing through the turbine outlet passage 842 remains attached to the interior surface 836, and the substantially uninterrupted passage surface defined by a combination of the interior surface 836 and the outer end 849 of the dosing module 844, at least along the extent 852 of the flow axis 850 occupied by the dosing module 838.

It is noted that in FIG. 55 the structure 834 comprises a bend, although it will be appreciated that the concepts taught in FIG. 55 could otherwise be incorporated in a linear portion of structure 834 (e.g. a straight section where the flow axis 850 is linear).

Turning to FIG. 56, a cross section end view of part of a turbine dosing system 850 is illustrated.

A number of components of the turbine dosing system 850 are not shown in FIG. 56, including the turbine wheel.

The turbine dosing system 850 comprises a monoblock turbine housing 852, a plurality of dosing modules: a first dosing module 851 and a second dosing module 856.

The monoblock turbine housing 852 comprises a volute 858 which defines a turbine inlet passage. The turbine housing 852 further comprises a turbine wheel chamber 860 which is configured to receive a turbine wheel. Downstream of the turbine wheel chamber 860, the turbine housing 852 defines a turbine outlet passage 862 which is configured to receive exhaust gas from the turbine wheel chamber 860. The turbine outlet passage 862 defines a flow axis 864 which extends along the turbine outlet passage 862 and is defined by a geometric centreline of the turbine outlet passage 862. The turbine outlet passage 862 is specifically defined by a diffuser 866 of the turbine housing 852. The diffuser 866 may be said to define a diverging portion of the turbine outlet passage 862 owing to the increase in cross sectional area of the turbine outlet passage 862 along the flow axis 864.

Each of the dosing modules 854, 856 defines a respective dosing module axis 868, 869. The dosing module axes 868, 869 are indicative of a direction in which aftertreatment fluid is injected by the dosing modules 854, 856 into the turbine outlet passage 862. Each of the dosing modules 854, 856 is mounted to the turbine housing 852 via a respective dosing module mount 874, 876. Conical sprays of aftertreatment fluid, as injected by each of the first and second dosing modules 854, 856 along the dosing module axes 868, 869, are indicated schematically in FIG. 56 and labelled 878 and 880 respectively.

In the illustrated embodiment, the two dosing modules 854, 856 are not axially offset from one another. That is to say, they occupy the same plane, or position, along the flow axis 864. However, in other embodiments there may be an axial offset such that, for example, one dosing module be closer to a turbine wheel than the other.

The two dosing modules 854, 856 are circumferentially offset from one another about the flow axis 864. Specifically, the dosing modules 854, 856 are tangentially mounted about the flow axis 864 such that an offset 870 exists between the first dosing module axis 868 and a radius 872 extending from the flow axis 864 parallel to the first dosing module axis 868. The same applies for the second dosing module 856 and second dosing module axis 869.

In other embodiments, the dosing modules may be located diametrically opposite one another so as to effectively share a common dosing module axis. Described another way, the dosing modules may be provided in facing relations with one other. This may be advantageous in arrangements where a swirl direction of exhaust gas, as determined by the turbine wheel and engine operating condition, may vary depending upon the engine operating condition. As described earlier in this document, for ease of understanding a nominal swirl direction 874 is used to indicate the direction in which the exhaust gas swirls. The nominal swirl direction 874 extends in the same direction as the volute 858 extends and the same direction in which a turbine wheel (not shown) rotates in use (e.g. counterclockwise in the illustrated embodiment). It may be desirable that the aftertreatment fluid be injected either into, or against, the nominal swirl direction 874. Whereas in the illustrated embodiment both dosing modules 854, 856 are aligned to inject aftertreatment fluid with the nominal swirl direction 874 of exhaust gas (e.g. into the swirling exhaust gas), it may be desirable that one or both of the dosing modules instead be configured to inject aftertreatment fluid against the swirl direction 874. Where the swirl direction changes in operation (e.g. due to engine operating condition), it may be desirable that the dosing modules be selectively activated, e.g. using a controller, so as to provide greater flexibility of dosing regime (e.g. the dosing modules be activated individually, simultaneously or a hybrid arrangement). For example, a first dosing module (only) may be activated when the swirl direction is a first direction (e.g. so as to inject aftertreatment fluid either with, or against, the swirl direction). A second dosing module (only) may be activated when the swirl direction is a different, second direction (e.g. so as to inject aftertreatment fluid either with, or against, the swirl direction). Selective activation of the first and second dosing modules may thus be used to inject aftertreatment fluid either with, or against, the swirl direction, even when the swirl direction changes in use (e.g. due to engine operating condition). The swirl direction may be detected or ascertained, directly or indirectly, by a sensor, a virtual sensor, or engine operating condition.

In any arrangement incorporating a plurality of dosing modules 854, 856, the dosing or injection regime may be adjusted depending on the engine operating condition and associated swirl direction of exhaust gas.

Whilst in the illustrated embodiment the two dosing modules 854, 856 are mounted to the same component (i.e. the turbine housing 852), it will be appreciated that in other embodiments the dosing modules may be mounted to different components. For example, one or more of the plurality of dosing modules may be mounted to a turbine housing, a connection adaptor or a downstream conduit. This may be desirable where there is an axial offset, along the flow axis 864, between the dosing modules.

FIGS. 57 to 60 show a further embodiment of a turbine dosing system 7000. The turbine dosing system 7000 comprises a turbine housing 7002, a turbine wheel (not shown), a wastegate arrangement 7004, a connection adapter 7006, a dosing module 7008, and a NOx sensor 7010 (see FIGS. 58 and 60). The combination of the turbine housing 7002 and connection adapter 7006 define a turbine housing assembly 7001.

The turbine housing 7002 defines a pair of inlet volutes 7012 (which may be referred to as a turbine inlet passage) and a turbine wheel chamber 7014. In other embodiments, the turbine housing 7002 may define a single inlet volute (which may be referred to as a turbine inlet passage). Although the turbine wheel is not shown, it will be appreciated that during use the turbine wheel sits within the turbine wheel chamber 7014 where it is supported for rotation relative to the turbine housing 7002 by a shaft (not shown) about a turbine axis 7015. Exhaust gas received from an internal combustion engine (not shown) is delivered via the inlet volutes 7012 to the turbine wheel chamber 7014 whereupon the momentum of the exhaust gas impacts the blades of the turbine wheel to generate rotation of the turbine wheel and shaft.

The connection adapter 7006 is connected to the turbine housing 7002 such that the turbine housing 7002 and connection adapter 7006 in combination define part of a turbine outlet passage 7016. The connection adapter 7006 is coupled to the turbine housing 7002 by a plurality of fasteners (one of which is labelled 7041 in FIG. 59), but could otherwise be coupled by way of a clamp or other connection mechanism. The first and/or second connection portions (where appropriate) may therefore comprise a flange with one or more bores. The turbine outlet passage 7016 receives exhaust gas that has passed through the turbine wheel from the turbine wheel chamber 7014. The turbine outlet passage 7016 comprises a first, upstream portion 7018 that extends axially, in relation to the turbine axis 7015, along a first portion 7021a of a flow axis 7021. The turbine outlet passage further comprises a second, downstream portion 7020, extending along a second portion 7021b of the flow axis 7021. The second portion 7020 may be referred to as a connection adapter passage. The second portion 7020 is generally angled relative to the first portion 7018 along the flow axis 7021. The angular difference between the first and second portions 7018, 7020 (i.e. between the first and second portions 7021a, 7021b of the flow axis 7021) is approximately 30°, however this may be varied to suit any particular packaging requirements. In some embodiments, the second portion 7020 of the turbine outlet passage 7016 may be completely axial relative to first portion 7018 (and optionally the turbine axis 7015) such that it does not comprise any relatively angled portions. This may be described as a linearly extending turbine outlet passage or connection adapter (e.g. see FIG. 4).

The first portion 7018 of the turbine outlet passage 7016 is defined by the turbine housing 7002 and the second portion 7020 of the turbine outlet passage 7016 is defined by the connection adapter 7006. The second portion 7020 of the turbine outlet passage 7016 receives exhaust gas from the first portion 7018. The first portion 7018 comprises a first diffuser section 7022 and the second portion 7020 comprises a second diffuser section 7024. The first and second diffuser sections 7022, 7024 are regions of the turbine housing 7002 and connection adapter 7006 respectively in which the flow area of the turbine outlet passage 7016 (i.e. the cross-sectional area relative to the direction of flow) increases with distance from the turbine wheel. Both the turbine housing 7002 and connection adapter 2006 may therefore be described as defining at least part of, or an entirety of, a diffuser of a turbine housing assembly (e.g. a turbine comprising a turbine housing and a connection adapter).

The wastegate arrangement 7004 comprises a wastegate passage 7026 that extends between the turbine inlet volutes 7012 and the turbine outlet passage 7016. The wastegate arrangement 7004 further comprises a pair of wastegate valves 7028 which cover respective valve openings (not shown) so as to selectively permit or prevent the flow of exhaust gas through the wastegate passage 7026. The valve openings connect separately to each of the 7012 inlet volutes (e.g. the turbine inlet passage). The wastegate valves 7028 are mounted to a common actuator (not shown) and are controlled in unison. However, in alternative embodiments, the valves may be controlled separately. The valve openings are generally the same size, however in alternative embodiments the valve opening may be asymmetric. Moreover, the valve openings may be operated using a single valve head rather than a pair of valves 7028. During use, when the wastegate valves 7028 are open, exhaust gas from the inlet volutes 7012 is bypassed to the turbine outlet passage 7016, via the wastegate passage 7026, without passing through the turbine wheel chamber 7014 and across the turbine wheel.

The wastegate passage 7026 is partially defined by the connection adapter 7006. In particular, the wastegate passage 7026 joins the turbine outlet passage 7016 at a wastegate passage outlet 7030. The wastegate passage outlet 7030 is defined in a side wall 7035 of the connection adapter 7006 and is positioned approximately at the apex of the angular bend defined between the first and second portions 7018, 7020 of the turbine outlet passage 7016 (i.e. approximately at the point where the first and second portions 7021a, 7021b of the flow axis 7021 meet). The wastegate passage 7026 defines a wastegate flow axis 7032 at the wastegate passage outlet 7030. The wastegate flow axis 7032 defines the direction of flow of exhaust gas from the wastegate passage 7026 as it joins the turbine outlet passage 7016. In the present embodiment, the wastegate flow axis 7032 is angled relative to the first portion 7021a of the flow axis 7021 (or the turbine wheel axis 7015) by approximately 45°. However, in alternative embodiments substantially any angle may be used. In the illustrated embodiment the wastegate flow axis 7032 is angled in a downstream direction. As shown in FIG. 58, in this embodiment the wastegate passage outlet 7030 has a more square geometry than the rectangular wastegate passage outlet 138 shown in FIG. 4.

The connection adapter 7006 comprises a mount 7034 (see FIG. 59) for the dosing module 7008. The mount 7034 defines an opening 7036 with which a nozzle 7038 of the dosing module 7008 is concentrically aligned (albeit recessed relative thereto). The nozzle 7038 is positioned so that it is radially outwards of the side wall 7035 of the connection adapter 7006. However, in other embodiments the nozzle 7038 may be substantially aligned (e.g. flush) with the side wall of the connection adapter 7006. The opening 7036 is positioned within the second diffuser section 7024. The nozzle 7038 is configured to generate a spray of aftertreatment fluid which is directed into the turbine outlet passage 7016 along a spray axis 7040 (which may otherwise be referred to as a dosing module axis). The spray axis 7040 is angled in a downstream direction with respect to the second portion 7021b of the flow axis 7021. The angle 7041 is around 7° with respect to orthogonal to the second portion 7021b of the flow axis 7021 in the illustrated embodiment. However, in other embodiments the spray axis 7040 may be angled at a different angle to the axis 7021 (e.g. orthogonal, or be angled in an upstream direction). The spray of aftertreatment fluid defines a spray region (e.g. spray cone) 7042, the presence of which is shown schematically by dotted lines in FIGS. 57 and 59. A primary impingement zone 7043 is defined on the opposing surface of the side wall 7035 to that of the dosing module mount 7034 (e.g. bound by the spray region 7042).

Returning to FIG. 57, the mount 7034 (not labelled in FIG. 57, but labelled in FIG. 59) and opening 7036 for the dosing module 7008 are positioned on substantially the opposite side of the turbine outlet passage 7016 to the wastegate passage outlet 7030. Moreover, the mount 7034 and opening 7036 for the dosing module 7008 are positioned downstream of the wastegate passage outlet 7030. The position of the wastegate passage outlet 7030 relative to the spray region 7042 and the angle of the wastegate flow axis 7032 relative to the spray region 7042 are such that, during use, when the wastegate valves 7028 are open, exhaust gas that has passed through the wastegate passage 7026 is directed into the spray region 7042 so that it fluidically exchanges momentum with the injected aftertreatment fluid.

The mount 7034 and opening 7036 for the dosing module 7008 are positioned within and/or form part of the connection adapter 7006. However, in alternative embodiments the mount 7034 and opening 7036 for the dosing module 7008 may be positioned within and/or form part of the turbine housing 7002. Because the mount 7034 and opening 7036 for the dosing module 7008 are positioned within the connection adapter 7006 or the turbine housing 7002, this means that the dosing module 7008 is positioned close to the turbine wheel. Accordingly this means that the injected aftertreatment fluid may take advantage of high exhaust gas temperatures which aid evaporation and decomposition. In this regard, the mount 7034, opening 7036 and dosing module 7008 are preferably positioned within a distance of no more than around 10 turbine wheel exducer diameters downstream of the turbine wheel (preferably no more than around 5 exducer diameters, and more preferably no more than around 3 exducer diameters). In this context, a turbine wheel exducer diameter is the diameter of the exducer portion of the turbine wheel, which is approximately equal to the diameter of the narrowest portion of the first diffuser section 7022. The exducer diameter 176 is also schematically indicated in FIG. 4, for completeness. In the illustrated embodiment the mount 7034, opening 7036 and dosing module 7008 are positioned at a distance of around 3.3 exducer diameters downstream of the downstream end of the turbine wheel chamber (and wheel). This distance is schematically indicated by construction line 7023.

The connection adapter 7006 comprises a sensor conduit 7044 (which may be referred to as an exhaust gas channel). The sensor conduit 7044 comprises a sensor conduit inlet 7046, configured to receive an aliquot of exhaust gas from the turbine outlet passage 7016, and a sensor conduit outlet 7048, configured to re-introduce exhaust gas from the sensor conduit 7044 to the turbine outlet passage 7016. The sensor conduit 7044 defines a flow area that is larger than the size of the sensor conduit inlet 7046. Accordingly, the sensor conduit 7044 acts to decelerate the exhaust gas passing therethrough. The sensor conduit 7044 comprises a mount 7050 (see FIG. 60) configured to receive the NOx sensor 7010. The NOx sensor 7010 comprises a sensing tip 7052 which protrudes into the interior of the sensor conduit 7044. Because the geometry of the sensing conduit 7044 decelerates the exhaust gas passing therethrough, the sensing tip 7052 is exposed to lower velocity exhaust gas, thus reducing the risk of damage to the sensing tip 7052 and improving the accuracy of sensor readings.

With reference to FIGS. 57 and 58, the sensor conduit inlet 7046 is positioned upstream of the opening 7036 for the dosing module 7008. Put another way, the primary impingement zone 7043 does not overlap the sensor conduit inlet 7046. Accordingly, the risk of aftertreatment entering the sensor conduit 7044 and adversely affecting readings taken by the NOx sensor 7010 is eliminated. The sensor conduit 7044 is part of the second diffuser section 7024. However, in alternative embodiments the sensor conduit 7044 may be part of the first diffuser section 7022.

Various aspects described and illustrated in connection with the embodiment shown in FIGS. 57 to 60, such as the first and second portions 7018, 7020 of the turbine outlet passage 7016 being angled relative to one another, may be incorporated in any other embodiments described herein.

The turbine dosing system 7000 embodies various aspects of the invention including, but not limited to:
The first, third to fifth, and seventh to thirteenth aspects of the invention;
The sixteenth and seventeenth aspect of the invention;
The nineteenth and twentieth aspects of the invention; and
The thirty-fourth and thirty-fifth aspects of the invention.

FIG. 61 shows a further embodiment of a turbine dosing system 8000. The turbine dosing system 8000 comprises a turbine housing 8002, a turbine wheel (not shown), a variable geometry mechanism (not shown), a connection adapter 8006, a dosing module 8008 (shown in FIGS. 62 and 63), and a NOx sensor 8010.

In contrast to many of the earlier embodiments, the turbine dosing system 8000 does not comprise a wastegate arrangement. Instead, the variable geometry mechanism (which, as mentioned above, is not shown) is used to control the RPM of the turbine wheel.

The turbine housing 8002 defines an inlet volute 8012 (which may be referred to as a turbine inlet passage) and a turbine wheel chamber 8014. In other embodiments, the turbine housing 8002 may define more than one inlet volute 8012. Although the turbine wheel is not shown, it will be appreciated that during use the turbine wheel sits within the turbine wheel chamber 8014 where it is supported for rotation relative to the turbine housing 8002 by a shaft (not shown) about a turbine axis 8015. Exhaust gas received from an internal combustion engine (not shown) is delivered via the inlet volute 8012 to the turbine wheel chamber 8014 whereupon the momentum of the exhaust gas impacts the blades of the turbine wheel to generate rotation of the turbine wheel and shaft.

The connection adapter 8006 is connected to the turbine housing 8002 such that the turbine housing 8002 and connection adapter 8006 in combination define part of a turbine outlet passage 8016. The connection adapter 8006 is coupled to the turbine housing 8002 by a clamp 8041, but could otherwise be coupled by way of a plurality of fasteners or other connection mechanism. The clamp 8041 draws a first connection portion (e.g. flange) 8007 of the connection adapter 8006 into engagement with a first connection portion (e.g. flange) 8003 of the turbine housing 8002. The turbine outlet passage 8016 defines a flow axis 8017, the flow axis 8017 extending from a downstream end of the turbine wheel chamber 8014. The turbine outlet passage 8016 receives exhaust gas that has passed through the turbine wheel from the turbine wheel chamber 8014. The turbine outlet passage 8016 comprises a first portion 8018 defined by the turbine housing 8002, and a second portion 8020 that is defined by the connection adapter 8006 (which may be referred to as a connection adapter passage). The second portion 8020 of the turbine outlet passage 8016 receives exhaust gas from the first portion 8018. Put another way, the second portion 8020 is downstream of the first portion 8018. The first portion 8018 comprises a first diffuser section 8022 and the second portion 8020 comprises a second diffuser section 8024. The first and second diffuser sections 8022, 8024 are regions of the turbine housing 8002 and connection adapter 8006 respectively in which the flow area of the turbine outlet passage 8016 (i.e. the cross-sectional area relative to the direction of flow) increases with distance from the turbine wheel. The first and second diffuser sections 8022, 8024 are substantially continuous with one another so as to define a single continuous diffuser (of the overall turbine housing assembly 8001 defined by the combination of the turbine housing 8002 and the connection adapter 8006).

With reference to FIGS. 62 and 63, the connection adapter 8006 comprises a mount 8034 (which may be referred to as a dosing module mount) for the dosing module 8008. The mount 8034 defines an opening 8036 with which a nozzle 8038 of the dosing module 8008 is concentrically aligned (albeit recessed relative thereto). The nozzle 8038 is positioned so that it is radially outwards of the side wall 8035 of the connection adapter 8006. However in other embodiments the nozzle 8038 may be substantially aligned (e.g. flush) with the side wall 8035 of the connection adapter 8006. The opening 8036 is positioned within the second diffuser section 8024. The nozzle 8038 is configured to generate a spray of aftertreatment fluid which is directed into the turbine outlet passage 8016 along a spray axis 8040 (which may be referred to as a dosing module axis). The spray axis 8040 is angled in a downstream direction with respect to the flow axis 8017 in the illustrated embodiment. The angle 8041 is around 7° with respect to orthogonal to the flow axis 8017 in the illustrated embodiment. However, in other embodiments the spray axis 8040 may be angled at a different angle to the flow axis 8017 (e.g. orthogonal, or be angled in an upstream direction). The spray of aftertreatment fluid defines a spray region (e.g. spray cone) 8042, the presence of which is shown schematically by dotted lines in FIGS. 62 and 63. The mount 8034 and opening 8036 for the dosing module 8008 are positioned within the connection adapter 8006. However, in alternative embodiments the mount 8034 and opening 8036 for the dosing module 8008 may be positioned within the turbine housing 8002 (or could form part of a monoblock turbine housing). A primary impingement zone 8043 is defined on the opposing surface of the side wall 8035 to that of the dosing module mount 8034 (e.g. bound by the spray region 8042).

Because the mount 8034 and opening 8036 for the dosing module 8008 are positioned within the connection adapter 8006 or the turbine housing 8002, this means that the dosing module 8008 is positioned close to the turbine wheel. Accordingly this means that the injected aftertreatment fluid may take advantage of high exhaust gas temperatures which aid evaporation and decomposition. In this regard, the mount 8034, opening 8036 and dosing module 8008 are preferably positioned within a distance of no more than around 10 turbine wheel exducer diameters downstream of the turbine wheel (preferably no more than around 5 exducer diameters, and more preferably no more than around 3 exducer diameters). In this context, a turbine wheel exducer diameter is the diameter of the exducer portion of the turbine wheel, which is approximately equal to the diameter of the narrowest portion of the first diffuser section 8022. The exducer diameter 176 is also schematically indicated in FIG. 4, for completeness. In the illustrated embodiment, the mount 8034, opening 8036 and dosing module 8008 are positioned within around 1.7 exducer diameters of the downstream end of the turbine wheel and turbine wheel chamber 8014. In other embodiments, the mount 8034, opening 8036 and dosing module 8008 may be positioned anywhere up to around 2 exducer diameters of the downstream end of the turbine wheel and turbine wheel chamber 8014, and are preferably located at least 1 exducer diameter downstream of the downstream end of the turbine wheel and turbine wheel chamber 8014. For completeness, the downstream end of the turbine wheel and turbine wheel chamber 8014 are schematically indicated by construction line 8019 in FIG. 63. The around 1.7 exducer diameters length, along the flow axis 8017, is indicated by construction line 8021.

The connection adapter 8006 comprises a sensor conduit 8044 (which may be referred to as an exhaust gas channel) having a sensor conduit inlet 8046 (see FIG. 61) configured to receive an aliquot of exhaust gas from the turbine outlet passage 8016 and sensor conduit outlet 8048 configured to re-introduce exhaust gas from the sensor conduit 8044 to the turbine outlet passage 8016. The sensor conduit 8044 defines a flow area that is larger than the size of the sensor conduit inlet 8046. Accordingly, the sensor conduit 8044 acts to decelerate the exhaust gas passing therethrough. The sensor conduit comprises a mount 8050 configured to receive the NOx sensor 8010. The NOx sensor 8010 comprises a sensing tip 8052 which protrudes into the interior of the sensor conduit 8044. Because the geometry of the sensing conduit 8044 decelerates the exhaust gas passing therethrough, the sensing tip 8052 is exposed to lower velocity exhaust gas, thus reducing the risk of damage to the sensing tip 8052 and improving the accuracy of sensor readings.

With reference to FIGS. 62 and 63, the sensor conduit inlet 8046 is positioned upstream of the opening 8036 for the dosing module 8008. Put another way, the primary impingement zone 8043 does not overlap the sensor conduit inlet 8046. Accordingly, the risk of aftertreatment entering the sensor conduit 8044 and adversely affecting readings taken by the NOx sensor 8010 is eliminated. The sensor conduit 8044 is part of the second diffuser section 8024. However, in alternative embodiments the sensor conduit 8044 may be part of the first diffuser section 8022. For completeness, FIG. 63 is a cross-section side view taken through the dosing module 8008.

Various aspects described and illustrated in connection with the embodiment shown in FIGS. 61 to 63, such as the use of the variable geometry mechanism, and omission of a wastegate, may be incorporated in any other embodiments described herein (where appropriate).

The turbine dosing system 8000 embodies various aspects of the invention including, but not limited to:
The ninth to thirteenth aspects of the invention; and
The thirty-fourth and thirty-fifth aspects of the invention.

Embodiments described in this application provide a number of advantages including: 1) improved mixing of aftertreatment fluid with an exhaust gas stream; 2) a reduction of deposits/build-ups at a surface generally opposite an outlet of the dosing module (owing to poor mixing of aftertreatment fluid with the exhaust gas); 3) improved packaging of the dosing module/mount; and 4) reducing unwanted system back pressure.

Any of the conduits described above may have a generally uniform wall thickness along its extent. The conduit(s) may be described as generally elongate. The conduit(s) may have a constant cross-section downstream of a particular axial point along its extent. Described another way, the conduit(s) may increase in cross-sectional area (e.g. diverge), and then have a constant cross-section beyond that point.

Any of the connection adapters described above may be described as structurally integrated with a turbine housing (e.g. connected to the turbine housing using one or more fasteners).

The turbines described throughout this document may be variable geometry turbines. The turbines described throughout this document may be fixed geometry turbines. Unless otherwise indicated, the turbines described throughout this document may, or may not, incorporate a wastegate.

Throughout this document, unless stated otherwise the turbine outlet passage may be defined by one or more of a turbine housing (e.g. a monoblock turbine housing), a connection adapter and a conduit. Unless stated otherwise, any features associated with a structure which at least partly defines any passage (examples of such features including a dosing module mount, diverging portion etc.) may therefore form part of one or more of a turbine housing (e.g. a monoblock turbine housing), a connection adapter and a conduit. Where appropriate, any structure which at least partly defines a passage may define a majority or, or entirety of, the passage.

Unless stated otherwise, the turbine outlet passage may extend from a downstream end of the turbine wheel by a distance of, for example, up to around 10 exducer diameters, up to around 5 exducer diameters, or up to around 3 exducer diameters. Unless stated otherwise, any dosing module and/or dosing module mount (e.g. centroids of an outlet or opening thereof) may be positioned within up to around 10 exducer diameters, up to around 5 exducer diameters, or up to around 3 exducer diameters downstream of a downstream end of the turbine wheel.

Throughout this document, unless stated otherwise a primary impingement zone defined by the dosing module is preferably located at least partially within, and more preferably entirely within, a diverging portion of the turbine outlet passage. Described another way, the primary impingement zone is preferably at least partly disposed within, more preferably entirely disposed within, a diffuser portion (e.g. of the turbine). Unless stated otherwise the primary impingement zone is preferably located at least partially within, and more preferably entirely within, up to around 10 exducer diameters, up to around 5 exducer diameters, or up to around 3 exducer diameters downstream of a downstream end of the turbine wheel. The primary impingement zone is preferably entirely downstream of the turbine wheel chamber (e.g. there is no overlap with the turbine wheel). The primary impingement zone is preferably located entirely within the turbine outlet passage.

Any turbine dosing system, or other component, described above may form part of an exhaust system. The exhaust system may further comprise a Selective Catalytic Reduction (SCR) catalyst, disposed downstream of the dosing module. For any turbine dosing system described above, any dosing module and/or dosing module mount is preferably located upstream of any aftertreatment components (e.g. SCR, DOC catalysts).

A turbine dosing system may be referred to as a turbine (e.g. a turbine for a turbine dosing system) in the absence of a dosing module.

Any features described in connection with the embodiments shown in FIG. 8 onwards may be incorporated in the embodiment shown in FIGS. 2 to 7, where appropriate. Similarly, any features of the embodiment of FIGS. 2 to 7 may be incorporated in the embodiments shown in FIG. 8 onwards, where appropriate.

The described and illustrated embodiments are to be considered as illustrative and not restrictive in character, it being understood that only preferred embodiments have been shown and described and that all changes and modifications that come within the scope of the inventions as defined in the claims are desired to be protected.

In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

1.-39. (canceled)

40. A turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 5 exducer diameters, along the flow axis, downstream of the downstream end of the turbine wheel.

41. The turbine dosing system according to claim 40, further comprising a dosing module configured to inject aftertreatment fluid into exhaust gas in the turbine outlet passage.

42. The turbine dosing system according to claim 40, wherein the dosing module mount is located between around 0.5 and around 5 exducer diameters, along the flow axis, downstream of the downstream end of the turbine wheel.

43. The turbine dosing system according to claim 42, wherein the dosing module mount is located between around 1 and around 3 exducer diameters, along the flow axis, downstream of the downstream end of the turbine wheel.

44. The turbine dosing system according to claim 42, wherein the dosing module mount is located within around 3 exducer diameters, along the flow axis, downstream of the downstream end of the turbine wheel.

45. The turbine dosing system according to claim 40, wherein the dosing module mount is located upstream of a first bend of the turbine outlet passage.

46. The turbine dosing system according to claim 41, wherein the dosing module is configured to inject aftertreatment fluid into exhaust gas in a diverging portion of the turbine outlet passage.

47. A method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation about a turbine wheel axis, the turbine wheel comprising an exducer defining an exducer diameter;
receive exhaust gas from the turbine wheel chamber into a turbine outlet passage downstream of the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 5 exducer diameters, along the flow axis, downstream of the downstream end of the turbine wheel.

48. The method according to claim 47, further comprising injecting aftertreatment fluid into exhaust gas in the turbine outlet passage using a dosing module.

49. The method according to claim 47, wherein the dosing module mount is located between around 0.5 and around 5 exducer diameters, along the flow axis, downstream of the downstream end of the turbine wheel.

50. The method according to claim 49, wherein the dosing module mount is located between around 1 and around 3 exducer diameters, along the flow axis, downstream of the downstream end of the turbine wheel.

51. The method according to claim 49, wherein the dosing module mount is located within around 3 exducer diameters, along the flow axis, downstream of the downstream end of the turbine wheel.

52. The method according to claim 47, wherein the dosing module mount is located upstream of a first bend of the turbine outlet passage.

53. The method according to claim 48, wherein the dosing module injects aftertreatment fluid into exhaust gas in a diverging portion of the turbine outlet passage.

54. The turbine dosing system according to claim 40, wherein the dosing module mount is located at a diverging portion of the turbine outlet passage.

55. The turbine dosing system according to claim 40, wherein the dosing module is a self-atomising dosing module.

56. The turbine dosing system according to claim 40, wherein the structure comprises a connection adapter, wherein the connection adapter comprises the dosing module mount.

57. The turbine dosing system according to claim 40, wherein the structure comprises a single wall.

58.-97. (canceled)

98. A turbocharger comprising:
a compressor, the compressor comprising a compressor housing and a compressor wheel;
a bearing housing, the bearing housing being configured to support a shaft for rotation about the turbine wheel axis; and
the turbine dosing system according to claim 40;
wherein the compressor wheel and turbine wheel are coupled to the shaft in power communication with one another.

99. An engine arrangement comprising;
an engine; and
a turbocharger according to claim 98;
wherein the turbocharger is configured to receive exhaust gas from the engine.
